(19) United States
(12) Patent Application Publication
(10) Pub. No.: US 2006/0231413 A1
(43) Pub. Date: Oct. 19, 2006

(54) Method of manufacturing a support for a lithographic printing plate

(75) Inventors: Atsuo Nishino, Shizuoka (JP); Yoshinori Hotta, Aichi (JP); Akio Uesugi, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/402,814

(22) Filed: Apr. 13, 2006

(30) Foreign Application Priority Data
Apr. 13, 2005 (JP) 2005-115746
Apr. 13, 2005 (JP) 2005-115747
Jul. 25, 2005 (JP) 2005-214788

(51) Int. Cl. B23H 5/06

(52) U.S. Cl. 205/662

(57) ABSTRACT

Disclosed is a method of manufacturing a lithographic printing plate support wherein an aluminum plate is subjected at least to, in order, a mechanical graining treatment in which the aluminum plate is grained to a mean surface roughness Rₐ of 0.25 to 0.40 μm using a brush and a slurry containing an abrasive, an electrochemical graining treatment in which the aluminum plate is grained using an alternating current in an aqueous solution containing nitric acid, and an alkali etching treatment in which the aluminum plate is etched in an aqueous alkali solution, thereby obtaining the lithographic printing plate support having a mean surface roughness Rₐ after the alkali etching treatment of 0.41 to 0.6 μm. By this method, there can be obtained a lithographic printing plate support for use in presensitized plates which, when processed into lithographic printing plates, have a long press life, an excellent scumming resistance, and an excellent cleaner resistance.

The entire contents of all documents cited in this specifications are incorporated herein by reference.

### BACKGROUND OF THE INVENTION

The present invention relates to a method of manufacturing a support for a lithographic printing plate. More specifically, the invention relates to a method of manufacturing a lithographic printing plate support having excellent scumming resistance, a long press life and excellent cleaner resistance.

Lithographic printing is a process that makes use of the inherent immiscibility of water and oil. Lithographic printing plates used in lithographic printing have formed on a surface thereof regions which are receptive to water and repel oil-based inks (referred to below as “non-image areas”) and regions which repel water and are receptive to oil-based inks (referred to below as “image areas”).

The lithographic printing plate support employed in a lithographic printing plate is formed using an aluminum plate. The surface of the aluminum plate is used to carry non-image areas, and must therefore have a number of conflicting properties, including, on the one hand, excellent hydrophilicity and water retention and, on the other hand, excellent adhesion to the image recording layer that is formed thereon. If the surface of the lithographic printing plate support is not hydrophilic enough, ink will adhere to non-image areas during printing, causing ink buildup on the blanket cylinder and, in turn, toning. That is, the scumming resistance of the plate will worsen. If water retention on the surface is too low, unless a large amount of dampening water is used during printing, undesirable effects such as the filling in shadow areas will occur. Also, if adhesion to the image recording layer is too low, the image recording layer will have a tendency to delaminate from the support, lowering the durability (press life) when a large number of impressions are made.

Therefore, to enhance performance characteristics such as scumming resistance and press life, a topography is created on the surface of the lithographic printing plate support by subjecting it to various graining treatments.

Known methods of graining treatment include mechanical graining, electrochemical graining, chemical graining (chemical etching), and combinations thereof.

For example, claim 2 of JP 2001-1663 A (the term “JP XXXX-XXXXXX A” as used herein means an “unexamined published Japanese patent application”) discloses a method of manufacturing an aluminum support for a lithographic printing plate that includes the steps of mechanically graining an aluminum plate, followed in turn by alkali etching, electrolytic etching with an electrolytic solution which contains 25 to 90 g/L of hydrochloric acid, 50 to 240 g/L of nitric acid and 25 to 60 g/L of aluminum ions, and includes 1 to 1.5 parts by weight of hydrochloric acid and 2 to 4 parts by weight of nitric acid per part by weight of aluminum ions, desmutting, and anodizing treatment.

### SUMMARY OF THE INVENTION

Ink adhering to the non-image areas of the lithographic printing plate is cleaned off to prevent tinting of the printed impressions. This is done by wiping the entire surface of the plate with a sponge containing a suitable amount of an acidic or alkaline plate cleaning solution, or cleaner.

However, when such cleaning is carried out, the cleaner causes the image recording layer to swell, lowering its strength, or the cleaner penetrates between the image recording layer and the support, lowering the adhesion therebetween and thus shortening the press life of the printing plate.

The inventors have conducted investigations on lithographic printing plates which use the aluminum support described in JP 2001-1663 A, and has found that the press life after such cleaning (also referred to below as the “cleaner resistance”) is low.

It is therefore an object in a first aspect of the invention to provide a lithographic printing plate support from which there can be obtained a presensitized plate having a long press life, an excellent scumming resistance, and an excellent cleaner resistance.

In printing with a lithographic printing plate, the worker visually checks the degree of shine in non-image areas on the plate surface, and adjusts the balance in the amounts of ink and dampening water accordingly. Hence, the ease of checking the degree of shine, i.e., the ease of perceiving the amount of dampening water on the plate surface, is an important property of the lithographic printing plate.

As a result of investigations on lithographic printing plates which use the aluminum support described in JP 2001-1663 A, the inventors have also found that, in addition to the low cleaner resistance, the shininess of the plate surface when the plate has been set on the printing press, i.e., the ease of perceiving the amount of dampening water on the plate surface, is also low.

It is therefore an object in a second aspect of the invention to provide a lithographic printing plate support from which there can be obtained a presensitized plate that has a long press life and is endowed with an excellent scumming resistance, excellent cleaner resistance, and excellent shininess.

Upon conducting further investigations on lithographic printing plates made using the aluminum support described in JP 2001-1663 A, the inventors have also found that the low cleaner resistance is due to an excessive mean surface roughness Rₐ following mechanical graining.

Additionally, as a result of extensive research aimed at enhancing the press life, scumming resistance and cleaner resistance, the inventors have discovered that the cleaner resistance of a presensitized plate is improved by the use of a lithographic printing plate support which is manufactured by subjecting an aluminum plate at least to, in order, mechanical graining treatment to a mean surface roughness Rₐ of 0.25 to 0.40 μm using a brush and an abrasive-containing slurry, electrochemical graining treatment with an alternating current in a nitric acid-containing aqueous solution, and alkali etching treatment in an aqueous alkali solution, wherein the lithographic printing plate support has a mean surface roughness Rₐ after the alkali etching treatment of 0.41 to 0.6 μm. The first aspect of the invention has been thus completed.

Furthermore, through extensive research aimed at enhancing the press life, scumming resistance, cleaner resistance and shininess, the inventors have also discovered that the press life, scumming resistance, cleaner resistance and shininess of a presensitized plate are improved by the use of a lithographic printing plate support which is manufactured by subjecting an aluminum plate at least to, in order, mechanical graining treatment to a mean surface roughness Rₐ of 0.25 to 0.42 μm using a brush and an abrasive-containing slurry, electrochemical graining treatment with an alternating current in an aqueous solution containing nitric acid and aluminum ions, and alkali etching treatment in an aqueous alkali solution, wherein the ratio R of the aluminum ion concentration A to the nitric acid concentration N in the electrolytic solution is at least 0.6, the alternating current used in electrochemical graining treatment has a ratio r of the amount of electricity QR when the aluminum plate acts as a cathode to the amount of electricity QF when the aluminum plate acts as an anode which satisfies the relationship 0.8≦r≦1.0, and the lithographic printing plate support has a mean surface roughness Rₐ after the alkali etching treatment of 0.43 to 0.60 μm. The second aspect of the invention has been thus completed.

Accordingly, in the first aspect, the invention provides the following methods (1) to (5) of manufacturing a lithographic printing plate support.

(1) A method of manufacturing a lithographic printing plate support wherein an aluminum plate is subjected at least to, in order, a mechanical graining treatment in which the aluminum plate is grained to a mean surface roughness Rₐ of 0.25 to 0.40 μm using a brush and a slurry containing an abrasive, an electrochemical graining treatment in which the aluminum plate is grained using an alternating current in an aqueous solution containing nitric acid, and an alkali etching treatment in which the aluminum plate is etched in an aqueous alkali solution, thereby obtaining the lithographic printing plate support having a mean surface roughness Rₐ after the alkali etching treatment of 0.41 to 0.6 μm.

(2) The method of manufacturing a lithographic printing plate support according to (1), wherein the aluminum plate is subjected between the mechanical graining treatment and the electrochemical graining treatment to an alkali etching treatment in which the aluminum plate is etched in an aqueous alkali solution, and after the alkali etching treatment following the electrochemical graining treatment, the aluminum plate is subjected to, in order, an electrochemical graining treatment in which the aluminum plate is grained using an alternating current in an aqueous solution containing hydrochloric acid, and an anodizing treatment, thereby obtaining the lithographic printing plate support.

(3) The method of manufacturing a lithographic printing plate support according to (1) or (2), wherein the alternating current used in the aqueous solution containing nitric acid has a ratio r of an amount of electricity QR when the aluminum plate acts as a cathode to an amount of electricity QF when the aluminum plate acts as an anode which satisfies a relationship 0.4≦r≦0.8.

(4) The method of manufacturing a lithographic printing plate support according to any one of (1) to (3), wherein the alternating current used in the aqueous solution containing nitric acid has a trapezoidal waveform.

(5) The method of manufacturing a lithographic printing plate support according to any one of (1) to (4), wherein the aqueous solution containing nitric acid has a nitric acid concentration of 15 to 50 g/L.

In the second aspect, the invention provides the following methods (6) to (8) of manufacturing a support for a lithographic printing plate.

(6) A method of manufacturing a lithographic printing plate support

wherein an aluminum plate is subjected at least to, in order, a mechanical graining treatment in which the aluminum plate is grained to a mean surface roughness Rₐ of 0.25 to 0.42 μm using a brush and a slurry containing an abrasive, an electrochemical graining treatment in which the aluminum plate is grained using an alternating current in an aqueous solution containing nitric acid and aluminum ions, and an alkali etching treatment in which the aluminum plate is etched in an aqueous alkali solution, thereby obtaining the lithographic printing plate support having a mean surface roughness Rₐ after the alkali etching treatment of 0.43 to 0.60 μm, and

wherein the aqueous solution has a ratio R of an aluminum ion concentration A to a nitric acid concentration N of at least 0.6, the alternating current has a ratio r of an amount of electricity QR when the aluminum plate acts as a cathode to an amount of electricity QF when the aluminum plate acts as an anode which satisfies a relationship 0.8≦r≦1.0.

(7) The method of manufacturing a lithographic printing plate support according to (6), wherein the aqueous solution containing nitric acid and aluminum ions contains 1 to 15 g/L of nitric acid and 1 to 15 g/L of aluminum ions.

(8) The method of manufacturing a lithographic printing plate support according to (6) or (7), wherein the aluminum plate is subjected between the mechanical graining treatment and the electrochemical graining treatment to an alkali etching treatment in which the aluminum plate is etched in an aqueous alkali solution, and after the alkali etching treatment following the electrochemical graining treatment, the aluminum plate is subjected to, in order, an electrochemical graining treatment in which the aluminum plate is grained using an alternating current in an aqueous solution containing hydrochloric acid, and an anodizing treatment, thereby obtaining the lithographic printing plate support.

As described below, according to the first aspect of the invention, there can be obtained a lithographic printing plate support for use in presensitized plates which, when processed into lithographic printing plates, have a long press life, an excellent scumming resistance, and an excellent cleaner resistance.

As also described below, according to the second aspect of the invention, there can be obtained a lithographic printing plate support for use in presensitized plates which, when processed into lithographic printing plates, have a long press life, an excellent scumming resistance, an excellent cleaner resistance, and an excellent shininess.

### BRIEF DESCRIPTION OF THE DRAWINGS

In the accompanying drawings:

FIG. 1 is a side view illustrating the brush graining step in the inventive method of manufacturing a lithographic printing plate support;

FIG. 2 is a schematic cross-sectional view of an apparatus which carries out rinsing with a free-falling curtain of water and that may be used for rinsing treatment in the inventive method of manufacturing a lithographic printing plate support;

FIG. 3 is a graph showing an example of a current waveform that may be used in electrochemical graining treatment in the inventive method of manufacturing a lithographic printing plate support;

FIG. 4 is a side view of a radial electrolytic cell that may be used in electrochemical graining treatment with alternating current in the inventive method of manufacturing a lithographic printing plate support;

FIG. 5 is a schematic view of an anodizing apparatus that may be used to carry out anodizing treatment in the inventive method of manufacturing a lithographic printing plate support; and

FIG. 6 is a schematic view of another anodizing apparatus that may be used to carry out anodizing treatment in the inventive method of manufacturing a lithographic printing plate support.

### DETAILED DESCRIPTION OF THE INVENTION

The first and second aspects of the invention (sometimes collectively referred to below as simply “the invention”) are described in detail below.

[Method of Manufacturing a Lithographic Printing Plate Support]

<Aluminum Plate (Rolled Aluminum)>

The aluminum plate used in the invention is made of a dimensionally stable metal composed primarily of aluminum; that is, aluminum or an aluminum alloy. Aside from a pure aluminum plate, an alloy plate composed primarily of aluminum and containing trace amounts of other elements can also be used.

In the present specification, the foregoing substrates made of aluminum or aluminum alloy are referred to collectively by the term ‘aluminum plate’. Other elements which may be present in the aluminum alloy include silicon, iron, manganese, magnesium, chromium, zinc, bismuth, nickel and titanium. The content of other elements in the alloy is at most 10 wt %.

Aluminum plates suitable for such use in the invention are not specified here as to composition, but include known materials that appear in the 4^{th} edition of Aluminum Handbook published in 1990 by the Japan Light Metal Association, such as pure aluminum plates having the Japanese designations JIS A1050, JIS A1052, JIS A1100 and JIS A1070, the manganese-containing aluminum plate having the designation JIS A3004, and the aluminum-manganese-based plate having the International Alloy Designation 3103A. For increased tensile strength, it is preferable to use aluminum-magnesium alloys and aluminum-manganese-magnesium alloys (JIS A3005) composed of the above aluminum alloys to which at least 0.1 wt % of magnesium has been added. Aluminum-zirconium alloys and aluminum-silicon alloys which additionally contain zirconium or silicon may also be used. Use can also be made of aluminum-magnesium-silicon alloys.

It is also possible to use aluminum plate obtained by rolling UBC (used beverage can) metal from aluminum beverage cans that have been melted down.

It is preferable for the aluminum plate used in the inventive method of manufacturing a lithographic printing plate support to contain 0.0 to 0.25 wt % of copper. When the aluminum plate has a copper content within this range, pits which are relatively large and more uniform are formed in the subsequently described first electrochemical graining treatment. Lithographic printing plates obtained using the resulting lithographic printing plate support thus have a longer press life.

To induce the formation of uniform pits (honeycombed pits) in the subsequently described first electrochemical graining treatment, the copper content is more preferably 0.15 wt % or less, even more preferably 0.12 wt % or less, and most preferably 0.10 wt % or less.

An aluminum plate having a silicon content of 0.07 to 0.09 wt %, an iron content of 0.20 to 0.29 wt %, a manganese content of 0.01 wt % or less, a magnesium content of 0.01 wt % or less, a chromium content of 0.01 wt % or less, a zinc content of 0.01 wt % or less, a titanium content of 0.02 wt % or less, and an aluminum content of at least 99.4 wt % is preferred.

The techniques relating to JIS 1050 materials that have been proposed by the present applicant are described in, for example, JP 59-153861 A, JP 61-51395 A, JP 62-146694 A, JP 60-215725 A, JP 60-215726 A, JP 60-215727 A, JP 60-216728 A, JP 61-272367 A, JP 58-11759 A, JP 58-42493 A, JP 58-221254 A, JP 62-148295 A, JP 4-254545 A, JP 4-165041 A, JP 3-68939 B (the term “JP XX-XXXXXX B” as used herein means an “examined Japanese patent publication”), JP 3-234594 A, JP 1-47545 B, JP 62-140894 A, JP 1-35910 B and JP 55-28874 B.

The techniques relating to JIS 1070 materials that have been proposed by the present applicant are described in, for example, JP 7-81264 A, JP 7-305133 A, JP 8-49034 A, JP 8-73974 A, JP 8-108659 A and JP 8-92679 A.

The techniques relating to aluminum-magnesium alloys that have been proposed by the present applicant are described in, for example, JP 62-5080 B, JP 63-60823 B, JP 3-61753 B, JP 60-203496 A, JP 60-203497 A, JP 3-11635 B, JP 61-274993 A, JP 62-23794 A, JP 63-47347 A, JP 63-47348 A, JP 63-47349 A, JP 64-1293 A, JP 63-135294 A, JP 63-87288 A, JP 4-73392 B, JP 7-100844 B, JP 62-149856 A, JP 4-73394 B, JP 62-181191 A, JP 5-76530 B, JP 63-30294 A, JP 6-37116 B, JP 2-215599 A and JP 61-201747 A.

The techniques relating to aluminum-manganese alloys that have been proposed by the present applicant are described in, for example, JP 60-230951 A, JP 1-306288 A, JP 2-293189 A, JP 54-42284 B, JP 4-19290 B, JP 4-19291 B, JP 4-19292 B, JP 61-35995 A, JP 64-51992 A, JP 4-226394 A, U.S. Pat. No. 5,009,722 and U.S. Pat. No. 5,028,0276.

The techniques relating to aluminum-manganese-magnesium alloys that have been proposed by the present applicant are described in, for example, JP 62-86143 A, JP 3-222796 A, JP 63-60824 B, JP 60-63346 A, JP 60-63347 A, JP 1-293350 A, EP 223,737 B, U.S. Pat. No. 4,818,300 and GB 1,222,777 B.

The techniques relating to aluminum-zirconium alloys that have been proposed by the present applicant are described in, for example, JP 63-15978 B, JP 61-51395 A, JP 63-143234 A and JP 63-143235 A.

The techniques relating to aluminum-magnesium-silicon alloys that have been proposed by the present applicant are described in, for example, GB 1,421,710 B.

The aluminum alloy may be formed into a plate by the following method, for example. First, an aluminum alloy melt that has been adjusted to a given alloying ingredient content is subjected to cleaning treatment by an ordinary method, then is cast. Cleaning treatment, which is carried out to remove hydrogen and other unwanted gases from the melt, typically involves flux treatment; degassing treatment using argon gas, chlorine gas or the like; filtering treatment using, for example, what is referred to as a rigid media filter (e.g., ceramic tube filter, ceramic foam filter), a filter that employs alumina flakes, alumina balls or the like as the filter medium, or a glass cloth filter; or a combination of degassing treatment and filtering treatment.

It is preferable to carry out cleaning treatment so as to prevent defects due to foreign matter such as nonmetallic inclusions and oxides in the melt, and defects due to dissolved gases in the melt. The filtration of melts is described in, for example, JP 6-57432 A, JP 3-162530 A, JP 5-140659 A, JP 4-231425 A, JP 4-276031 A, JP 5-311261 A, and JP 6-136466 A. The degassing of melts is described in, for example, JP 5-51659 A and JP 5-49148 U (the term “JP XX-XXXXXX U” as used herein means an “unexamined published Japanese utility model application”). The present applicant proposes a technique concerning the degassing of melts in JP 7-40017 A.

Next, the melt that has been subjected to cleaning treatment as described above is cast. Casting processes include those which use a stationary mold, such as direct chill casting, and those which use a moving mold, such as continuous casting.

In direct chill casting, the melt is solidified at a cooling speed of 0.5 to 30° C./s. At less than 0.5° C./s, many coarse intermetallic compounds are formed. When direct chill casting is carried out, an ingot having a thickness of 300 to 800 mm can be obtained. If necessary, this ingot is scalped by a conventional method, generally removing 1 to 30 mm, and preferably 1 to 10 mm, of material from the surface. The ingot may also be optionally soaked, either before or after scalping. In cases where soaking is carried out, the ingot is heat treated at 450 to 620° C. for 1 to 48 hours to prevent the coarsening of intermetallic compounds. The effects of soaking treatment may be inadequate if heat treatment time is shorter than one hour. Production costs may be reduced if soaking is not carried out.

The ingot is then hot-rolled and cold-rolled, giving a rolled aluminum plate. A temperature of 350 to 500° C. at the start of hot rolling is appropriate. Intermediate annealing may be carried out before or after hot rolling, or even during hot rolling. The intermediate annealing conditions may consist of 2 to 20 hours of heating at 280 to 600° C., and preferably 2 to 10 hours of heating at 350 to 500° C., in a batch-type annealing furnace, or of heating for up to 6 minutes at 400 to 600° C., and preferably up to 2 minutes at 450 to 550° C., in a continuous annealing furnace. Using a continuous annealing furnace to heat the rolled plate at a temperature rise rate of 10 to 200° C./s enables a finer crystal structure to be achieved.

The aluminum plate that has been finished by the above step to a given thickness of, say, 0.1 to 0.5 mm may then be passed through a leveling machine such as a roller leveler or a tension leveler to improve the flatness. The flatness may be improved in this way after the continuous aluminum plate has been cut into discrete sheets. However, to enhance productivity, it is preferable to carry out such flattening with the rolled aluminum in the state of a continuous coil. The plate may also be passed through a slitter line to cut it to a predetermined width. A thin film of oil may be provided on the aluminum plate surface to prevent scuffing due to rubbing between adjoining aluminum plates. Suitable use may be made of either a volatile or non-volatile oil film, as needed.

Continuous casting processes that are industrially carried out include processes which use cooling rolls, such as the twin roll process (Hunter process) and the 3C process; and processes which use a cooling belt or a cooling block, such as the twin belt process (Hazelett process) and the Alusuisse Caster II process. When a continuous casting process is used, the melt is solidified at a cooling rate of 100 to 1,000° C./s. Continuous casting processes generally have a faster cooling rate than direct chill casting processes, and thus are characterized by the ability to achieve a higher solid solubility of alloying ingredients in the aluminum matrix. The techniques relating to continuous casting processes that have been proposed by the present applicant are described in, for example, JP 3-79798 A, JP 5-201166 A, JP 5-156414 A, JP 6-262203 A, JP 6-122949 A, JP 6-210406 A and JP 6-26308 A.

When continuous casting is carried out, such as by a process involving the use of cooling rolls (e.g., the Hunter process), the melt can be directly and continuously cast as a plate having a thickness of 1 to 10 mm, thus making it possible to omit the hot rolling step. Moreover, when use is made of a process that employs a cooling belt (e.g., the Hazelett process), a plate having a thickness of 10 to 50 mm can be cast. Generally, a hot-rolling roll is positioned immediately downstream of a casting machine, and the cast plate is successively rolled, enabling a continuously cast and rolled plate having a thickness of 1 to 10 mm to be obtained.

These continuously cast and rolled plates are then passed through such steps as cold rolling, intermediate annealing, flattening and slitting in the same way as described above for direct chill casting, and thereby finished to a plate thickness of typically 0.1 to 0.5 mm. The techniques relating to the intermediate annealing conditions and cold rolling conditions in a continuous casting process that have been proposed by the present applicant are described in, for example, JP 6-220593 A, JP 6-210308 A, JP 7-54111 A and JP 8-92709 A.

It is preferable for the aluminum plate used in the invention to be well-tempered in accordance with H18 defined in JIS.

It is desirable for the aluminum plate manufactured as described above to have the following properties.

For the aluminum plate to achieve the stiffness required of a lithographic printing plate support, it should have a 0.2% proof stress of preferably at least 120 MPa. To ensure some degree of stiffness even when burning treatment has been carried out, the 0.2% proof stress following 3 to 10 minutes of heat treatment at 270° C. should be at least 80 MPa, and preferably at least 100 MPa. Particularly, in cases where the aluminum plate is required to have a high stiffness, use may be made of an aluminum material containing magnesium or manganese. However, because a higher stiffness lowers the ease with which the plate can be fit onto the plate cylinder of the printing press, the plate material and the amounts of minor components added thereto are suitably selected according to the intended application. The techniques proposed by the present applicant are described in, for example, JP 7-126820 A and JP 62-140894 A.

The aluminum plate more preferably has a tensile strength of 160±15 N/mm², a 0.2% proof stress of 140±15 MPa, and an elongation as specified in JIS Z2241 and Z2201 of 1 to 10%.

Because the crystal structure at the surface of the aluminum plate may give rise to a poor surface quality when chemical graining treatment and electrochemical graining treatment are carried out, it is preferable that the crystal structure at the surface not be too coarse. The crystal structure at the surface of the aluminum plate has a width of preferably up to 200 μm, more preferably up to 100 μm, and most preferably up to 50 μm. Moreover, the crystal structure has a length of preferably up to 5,000 μm, more preferably up to 1,000 μm, and most preferably up to 500 μm. The techniques proposed by the present applicant are described in, for example, JP 6-218495 A, JP 7-39906 A and JP 7-124609 A.

It is preferable for the alloying ingredient distribution at the surface of the aluminum plate to be reasonably uniform because non-uniform distribution of alloying ingredients at the surface of the aluminum plate sometimes leads to a poor surface quality when chemical graining treatment and electrochemical graining treatment are carried out. The techniques proposed by the present applicant are described in, for example, JP 6-48058 A, JP 5-301478 A and JP 7-132689 A.

The size and density of intermetallic compounds in the aluminum plate may exert an effect on the chemical graining treatment and the electrochemical graining treatment. The techniques proposed by the present applicant are described in, for example, JP 7-138687 A and JP 4-254545 A.

<Surface Treatment>

In the method of manufacturing a lithographic printing plate support according to the first aspect of the invention, the above-described aluminum plate is subjected at least to, in order: mechanical graining treatment to a mean surface roughness Rₐ of 0.25 to 0.40 μm using a brush and an abrasive-containing slurry, electrochemical graining treatment using an alternating current in a nitric acid-containing aqueous solution (also referred to below as “first electrochemical graining treatment”), and alkali etching treatment in an aqueous alkali solution (also referred to below as “second etching treatment”) so as to obtain a lithographic printing plate support having a mean surface roughness Rₐ after the alkali etching treatment of 0.41 to 0.6 μm.

It is preferable to obtain the lithographic printing plate support by additionally subjecting the foregoing aluminum plate, between the mechanical graining treatment and the first electrochemical graining treatment, to alkali etching in an aqueous alkali solution (also referred to below as “first etching treatment”), then, following the second etching treatment, also subjecting the aluminum plate to, in order, electrochemical graining using an alternating current in a hydrochloric acid-containing aqueous solution (also referred to below as “second electrochemical treatment”), and anodizing treatment.

In the method of manufacturing a lithographic printing plate support according to the second aspect of the invention, the above-described aluminum plate is subjected at least to, in order: mechanical graining treatment to a mean surface roughness Rₐ of 0.25 to 0.42 μm using a brush and an abrasive-containing slurry, electrochemical graining treatment in an aqueous solution containing nitric acid and aluminum ions and having a ratio R of the aluminum ion concentration A to the nitric acid concentration N(R=A/N) of at least 0.6 using an alternating current having a ratio r of the amount of electricity QR when the aluminum plate acts as a cathode to the amount of electricity QF when the aluminum plate acts as an anode (r=QR/QF) which satisfies the relationship 0.8≦r≦1.0 (this treatment is also referred to below as “first electrochemical graining treatment”), and alkali etching treatment in an aqueous alkali solution (also referred to below as “second etching treatment”) so as to obtain a lithographic printing plate support having a mean surface roughness Rₐ after the alkali etching treatment of 0.43 to 0.6 μm.

Various steps other than those mentioned above may also be included in the inventive method of manufacturing a lithographic printing plate support.

A preferred example is a method in which the aluminum plate is subjected to, in order, mechanical graining treatment, first etching treatment, desmutting treatment in an acidic aqueous solution (also referred to below as “first desmutting treatment”), first electrochemical graining treatment, second etching treatment, desmutting treatment in an acidic aqueous solution (also referred to below as “second desmutting treatment”), second electrochemical graining treatment, etching treatment in an aqueous alkali solution (also referred below as “third etching treatment”), desmutting treatment in an acidic aqueous solution (also referred to below as “third desmutting treatment”), and anodizing treatment.

A method in which, following the above anodizing treatment, the aluminum plate is additionally subjected to sealing treatment, hydrophilizing treatment, or sealing treatment followed by hydrophilizing treatment is also preferred.

The surface treatment steps are each described below in detail.

<Mechanical Graining Treatment>

In the first aspect of the invention, mechanical graining treatment is carried out using a brush and an abrasive-containing slurry so as to give the above-described aluminum plate a mean surface roughness Rₐ of 0.25 to 0.40 μm, preferably 0.28 to 0.37 μm, and more preferably 0.30 to 0.35 μm.

By setting the mean surface roughness Rₐ within the foregoing range through mechanical graining treatment, then carrying out the subsequently described first electrochemical graining treatment, there can be obtained an aluminum plate having an excellent cleaner resistance. Moreover, deep pits that may arise locally can be prevented from being formed, enabling a presensitized plate of excellent sensitivity to be obtained.

In the second aspect of the invention, mechanical graining treatment is carried out using a brush and an abrasive-containing slurry so as to give the above-described aluminum plate a mean surface roughness Rₐ of 0.25 to 0.42 μm, preferably 0.30 to 0.40 μm, and more preferably 0.31 to 0.39 μm.

By setting the mean surface roughness Rₐ within the foregoing range through mechanical graining treatment, the average slope Δa at the surface of the aluminum plate is not too large. As a result, the aluminum plate does not readily undergo a decline in scumming resistance even when the amount of dissolution from the aluminum plate in the first etching treatment has been set to a low value. Because the amount of dissolution from the aluminum plate has been set to a low value, the amount of etching solution used can be reduced. Moreover, deep pits that may arise locally can be prevented from being formed, enabling a presensitized plate of excellent sensitivity to be obtained.

It is more preferable for the mean surface roughness to average slope ratio Rₐ/Δa multiplied by 100 to be from 3.5 to 6.0.

The above-described mechanical graining treatment is a brush graining method in which the aluminum plate is abraded with one type of brush or two or more types having different bristle diameters while an abrasive-containing slurry is fed to the surface of the plate. Preferred examples include wire brush graining in which the aluminum surface is scratched with metal wire, and brush graining in which the surface is grained with a nylon brush.

Brush graining is generally carried out with a roller brush (also known as a “brush roll”), examples of which include those obtained by setting bristles, such as plastic bristles (e.g., bristles made of a plastic such as nylon, polypropylene or polyvinyl chloride), animal bristles or steel wire, on the surface of a cylindrical roller core so that the bristles have a uniform length and distribution on the roller core, brushes obtained by opening small holes in the core and setting bundles of brush bristles therein, and channel roller-type brushes. Brush graining is carried out by rubbing one or both sides of the aluminum plate while spraying an abrasive-containing slurry onto the rotating roller brush.

The bristles on the brush have a flexural modulus of preferably 10,000 to 40,000 kgf/cm², and more preferably 15,000 to 35,000 kgf/cm², and have a stiffness of preferably 500 gf or less, and more preferably 400 gf or less.

Nylon is preferred as a bristle material that fully satisfies these characteristics. Specific nylons that can be used for this purpose include nylon 6, nylon 6.6, and nylon 6.10. Of these, the use of nylon 6.10 is especially preferred from the standpoint of such properties as tensile strength, wear resistance, dimensional stability to water absorption, flexural strength, heat resistance, and recovery.

Such a nylon brush is preferably made of bristles having a low water absorption. A preferred example is Nylon Bristle 200T (available from Toray Industries, Inc.), which is made of nylon 6.10, has a softening point of 180° C., a melting point of 212 to 214° C., a specific gravity of 1.08 to 1.09, a water absorption at 20° C. and 65% relative humidity of 1.4 to 1.8 and at 20° C. and 100% relative humidity of 2.2 to 2.8, a dry tensile strength of 4.5 to 6 g/d, a dry tensile elongation of 20 to 35%, a boiling water shrinkage of 1 to 4%, a dry resistance to stretching of 39 to 45 g/d, and a Young's modulus when dry of 380 to 440 kg/mm².

The length of the bristles on the brush after they have been set is preferably 10 to 200 mm. The bristles are set on the roller core to a density of preferably 30 to 1,000 bristles/cm², and more preferably 50 to 300 bristles/cm².

The bristles have a diameter of preferably 0.24 to 0.83 mm. At a bristle diameter within this range, the desired mean surface roughness (Rₐ=0.25 to 0.40 μm) is more easily achieved and the scumming resistance of the printing plate on a blanket cylinder is also good.

It is also preferable for the bristles to have a circular cross-sectional shape.

The number of brushes is preferably from 1 to 10, and more preferably from 1 to 6.

Moreover, as noted in JP 6-135175 A, the brushes (e.g., roller-type brushes) may be used as a combination of two or more types of brushes of differing bristle diameter. In such a case, more than one brush (e.g., two or three brushes) may be used for each type differing in bristle diameter. When two or more types of brushes are used, the brushes initially used in brush graining are generally called the first brushes, and the brushes finally used are called the second brushes.

When a roller-type brush is used as the brush in brush graining, the number of revolutions of the brush is preferably selected from a range of 100 to 500 rpm.

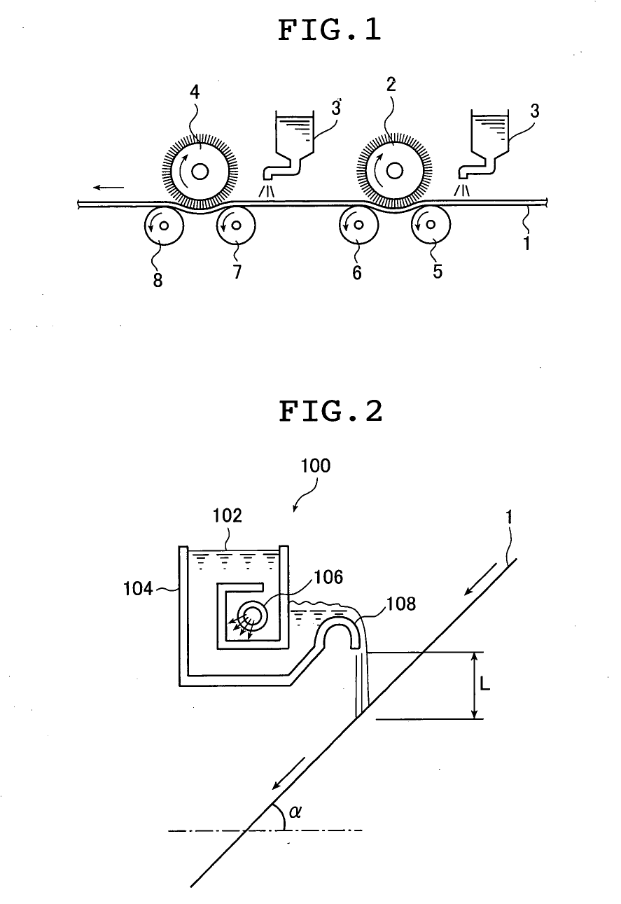

The direction in which the roller-type brush is rotated is preferably the same as the direction in which the aluminum plate is conveyed, as shown in FIG. 1. However, if a plurality of roller-type brushes are used, some of the roller-type brushes may be rotated in the reverse direction. The force with which the roller-type brush is pressed against the plate is preferably controlled by the load on the driving motor which rotates the roller-type brush. Specifically, the driving motor has a power consumption of preferably 1.0 to 15 kW. In addition, support rollers which have a rubber or metal surface and retain a good degree of straightness may be used with the roller-type brushes.

The abrasive slurry is preferably one obtained by dispersing in water a known abrasive mentioned in JP 6-135175 A and JP 50-40047 B, specific examples of which include pumice, silica sand, aluminum hydroxide, alumina powder, silicon carbide, silicon nitride, volcanic ash, carborundum, and emery having an average particle size of 1 to 50 μm (and preferably 20 to 45 μm), to a specific gravity of 1.05 to 1.3, and preferably 1.10 to 1.20. Here, “average particle size” refers to the particle size at a cumulative fraction of 50% when cumulative frequencies of different particle size fractions based on the total volume of the abrasive present in the slurry have been determined. Abrasive having an average particle size within the above-indicated range exhibits an excellent graining efficiency and is capable of forming small grained pits.

The use of pumice, silica sand or aluminum hydroxide as the abrasive is more preferred. Silica sand is especially preferred.

The use of pumice is advantageous because it is inexpensive and the supply is stable owing to its use as an industrial-grade abrasive.

It is preferable to use pumice containing the following ingredients.

<Pumice Ingredients>

| | | |
|---|---|---|
| Silica (SiO₂) | 70 to 80 | wt % |
| Alumina (Al₂O₃) | 10 to 20 | wt % |
| Iron oxide (Fe₂O₃) | up to 3 | wt % |

| | |
|---|---|
| Other ingredients | balance |

Because silica sand is relatively hard compared with other abrasives and does not break down easily, the particles very rarely break up during the above-described metal graining treatment. Hence, the surface of the resulting lithographic printing plate support is uniformly grained and the formation of streaks on the surface can be reduced, giving the surface of the lithographic printing plate support a good appearance. This has the advantage of, for example, making it easier to visually discern surface scratches.

The silica sand has an average particle size of preferably 3 to 40 μm, and more preferably 5 to 30 μm. By using silica sand with an average particle size in this range, the graining efficiency can be enhanced and the grained pits can be made smaller, thus making it possible to obtain a lithographic printing plate having a long press life, an excellent scumming resistance, an excellent cleaner resistance, and most particularly an excellent shininess. The silica sand used for this purpose is preferably one containing the following ingredients.

<Silica Sand Ingredients>

| | | |
|---|---|---|
| Silica (SiO₂) | at least 93 | wt % |
| Alumina (Al₂O₃) | up to 3 | wt % |
| Iron oxide (Fe₂O₃) | up to 2 | wt % |

| | |
|---|---|
| Other ingredients | balance |

In addition to the abrasive, the abrasive slurry may include also, for example, a thickener, a dispersant (e.g., surfactant) and a preservative.

A preferred method for supplying such an abrasive slurry to the surface of the aluminum plate includes that of spraying the slurry. Alternatively, use can be made of the methods mentioned in JP 55-74898 A, JP 61-162351 A and 63-104889 A. In addition, as described in JP 9-509108 A, use can also be made of a method in which the surface of the aluminum plate is brush grained in an aqueous slurry containing a mixture of particles composed of alumina and quartz in a weight ratio of from 95:5 to 5:95. The average particle size of the above mixture is preferably from 1 to 40 μm, and most preferably from 1 to 20 μm, in the first aspect of the invention, and is from 5 to 30 μm in the second aspect of the invention.

In the practice of the invention, by suitably adjusting various conditions, such as the rotational speed of the brushes, the number of brushes, the direction of brush rotation, the diameter and length of the bristles on the brush, the diameter of the brush roller, the type of abrasive, the particle size of the abrasive, the specific gravity of the abrasive, the flow rate of the abrasive, the pressing force (amount of push down) with which the brush is pressed against the plate, and the traveling speed of the aluminum plate, the mean surface roughness Rₐ of the aluminum plate following mechanical graining treatment can be set in the first aspect of the invention within a range of 0.25 to 0.40 μm, and can be set in the second aspect of the invention within a range of 0.25 to 0.42 μm.

These conditions are most preferably set within the following ranges.

<First Aspect of Invention>

Rotational speed of brush: 150 to 350 rpm
Number of brushes: 1 to 3
Direction of brush rotation: same as direction in which aluminum plate travels
Diameter of bristles: 0.24 to 0.3 mm
Length of bristles: 30 to 100 mm
Diameter of brush roller: 300 to 600 mm
Type of abrasive: aluminum hydroxide; classified silica sand, or crushed and classified pumice
Particle size of abrasive: average particle size, 20 to 40 μm
Specific gravity of abrasive: 1.05 to 1.18
Traveling speed of aluminum plate: 30 to 300 m/min
   <Second Aspect of Invention>
Rotational speed of brush: 150 to 350 rpm
Number of brushes: 1 to 4
Direction of brush rotation: same as direction in which aluminum plate travels
Diameter of bristles: 0.24 to 0.3 mm
Length of bristles: 30 to 100 mm
Diameter of brush roller: 300 to 600 mm
Type of abrasive: silica sand
Particle size of abrasive: average particle size, 5 to 30 μm
Specific gravity of abrasive: 1.10 to 1.20
Traveling speed of aluminum plate: 30 to 300 m/min

Examples of apparatuses suitable for mechanical graining treatment carried out by the above-described brushing graining method include those mentioned in JP 6-135175 A and JP 50-40047 B.

FIG. 1 is a side view illustrating the brush graining step in the inventive method of manufacturing a lithographic printing plate support.

As shown in FIG. 1, roller-type brushes 2 and 4, and two pairs of support rollers 5,6 and 7,8 for supporting the respective roller-type brushes 2 and 4 are arranged on opposite sides of an aluminum plate 1. The two rollers in each pair of support rollers 5,6 and 7,8 are arranged so as to have a minimum distance between their respective outer surfaces which is smaller than the outside diameter of the roller-type brushes 2 and 4. The aluminum plate 1 travels at a constant speed while being pressed by the roller-type brushes 2 and 4 to be sandwiched between the brushes 2, 4 and the pairs of support rollers 5,6 and 7,8. The surface of the aluminum plate 1 is brush grained by supplying an abrasive slurry 3 onto the plate 1 and rotating the roller-type brushes 2 and 4.

In the practice of the invention, the mean surface roughness Rₐ of the aluminum plate is determined by two-dimensional roughness measurement carried out using a stylus-type roughness tester (e.g., Surfcom 575, manufactured by Tokyo Seimitsu Co., Ltd.). The mean surface roughness as defined in ISO 4287 is measured five times, and the average of the five resulting values is treated as the mean surface roughness Rₐ. The average slope Δa is similarly determined by measuring the two-dimensional roughness with a stylus-type roughness tester, and carrying out measurement according to the method specified in ISO 4287.

The measurement conditions when determining the two-dimensional roughness are as follows: cutoff value, 0.8 mm; slope correction, FLAT-ML; measurement length, 3 mm; longitudinal magnification, 10,000×; scan rate, 0.3 mm/s; stylus tip diameter, 2 μm.

<First Etching Treatment>

In the first etching treatment, the aluminum plate which has been subjected to the above-described mechanical graining treatment is brought into contact with an alkali solution so as to dissolve the surface layer.

In the practice of the invention, it is advantageous to subject the aluminum plate that has been mechanically grained as described above to the first etching treatment. Carrying out the first etching treatment after mechanical graining treatment removes contaminants such as abrasive and aluminum debris, rolling oil, smut and the natural oxide film that arise on the surface of the aluminum plate as a result of mechanical graining treatment, enabling a more uniform topography to be achieved on the surface by the first electrochemical graining treatment and also enabling the first electrochemical graining treatment to be effectively carried out.

In the first aspect of the invention, the amount of material removed in the first etching treatment (also referred to below as the “etching amount”) is preferably at least 0.1 g/m², more preferably at least 0.5 μm², and even more preferably at least 1 g/m², but preferably not more than 10 g/m², more preferably not more than 8 g/m², even more preferably not more than 5 g/m², and most preferably not more than 3 g/m².

In the second aspect of the invention, the etching amount in the first etching treatment is preferably from 0.1 to 6 g/m², and more preferably from 2.0 to 5.5 g/m².

When the etching amount is too small, it may be impossible to form uniform pits in the first electrochemical graining treatment, resulting in a poor uniformity. On the other hand, when the etching amount is too large, the amount of aqueous alkali solution used increases, which is economically disadvantageous.

Alkalis that may be used in the alkali solution are exemplified by caustic alkalis and alkali metal salts. Specific examples of suitable caustic alkalis include sodium hydroxide and potassium hydroxide. Specific examples of suitable alkali metal salts include alkali metal silicates such as sodium metasilicate, sodium silicate, potassium metasilicate and potassium silicate; alkali metal carbonates such as sodium carbonate and potassium carbonate; alkali metal aluminates such as sodium aluminate and potassium aluminate; alkali metal aldonates such as sodium gluconate and potassium gluconate; and alkali metal hydrogenphosphates such as disodium hydrogenphosphate, dipotassium hydrogenphosphate, sodium dihydrogenphosphate and potassium dihydrogenphosphate. Of these, caustic alkali solutions and solutions containing both a caustic alkali and an alkali metal aluminate are preferred on account of the high etch rate and low cost. An aqueous solution of sodium hydroxide is especially preferred.

In the first etching treatment, the alkali solution has a concentration of preferably at least 30 g/L, and more preferably at least 300 g/L, but preferably not more than 500 g/L, and more preferably not more than 450 g/L.

It is desirable for the alkali solution to contain aluminum ions. The aluminum ion concentration is preferably at least 1 g/L, and more preferably at least 50 g/L, but preferably not more than 200 g/L, and more preferably not more than 150 g/L. Such an alkali solution can be prepared using, for example, water, a 48 wt % aqueous sodium hydroxide solution, and sodium aluminate.

In the first etching treatment, the alkali solution has a temperature of preferably at least 30° C., and more preferably at least 50° C., but preferably not more than 80° C., and more preferably not more than 75° C.

In the first etching treatment, the treatment time is preferably at least 1 second, and more preferably at least 2 seconds, but preferably not more than 30 seconds, and more preferably not more than 15 seconds.

When the aluminum plate is continuously etched, the aluminum ion concentration in the alkali solution rises and the amount of material etched from the aluminum plate changes. It is thus desirable to control the etching solution composition as follows.

First, a matrix of the electrical conductivity, specific gravity and temperature or a matrix of the conductivity, ultrasonic wave propagation velocity and temperature is prepared with respect to a matrix of the sodium hydroxide concentration and the aluminum ion concentration. The solution composition is then measured based on either the conductivity, specific gravity and temperature or the conductivity, ultrasonic wave propagation velocity and temperature, and sodium hydroxide and water are added up to control target values for the solution composition. Next, the etching solution which has increased in volume with the addition of sodium hydroxide and water is allowed to overflow from a circulation tank, thereby keeping the amount of solution constant. The sodium hydroxide added may be industrial-grade 40 to 60 wt % sodium hydroxide.

The conductivity meter and hydrometer used to measure electrical conductivity and specific gravity are each preferably temperature-compensated instruments. The hydrometer is preferably a pressure differential hydrometer.

Illustrative examples of methods for bringing the aluminum plate into contact with the alkali solution include passing the aluminum plate through a tank filled with the alkali solution, immersing the aluminum plate in a tank filled with the alkali solution, and spraying the surface of the aluminum plate with the alkali solution.

The most desirable of these is a method that involves spraying the surface of the aluminum plate with the alkali solution. A method in which the etching solution is sprayed from at least one spray line, and preferably two or more spray lines, each having 2 to 5 mm diameter openings spaced at a pitch of 10 to 50 mm, at a rate of 10 to 100 L/min per spray line is desirable.

Following completion of the alkali etching treatment, it is desirable to remove etching solution remaining on the aluminum plate with nip rollers, subject the plate to rinsing treatment with water for 1 to 10 seconds, then remove the water with nip rollers.

Rinsing treatment is preferably carried out by rinsing with a rinsing apparatus that uses a free-falling curtain of water and also by rinsing with spray lines.

FIG. 2 is a schematic cross-sectional view of an apparatus 100 which carries out rinsing with a free-falling curtain of water. As shown in FIG. 2, the apparatus 100 that carries out rinsing treatment with a free-falling curtain of water has a water holding tank 104 that holds water 102, a pipe 106 that feeds water to the water holding tank 104, and a flow distributor 108 that supplies a free-falling curtain of water from the water holding tank 104 to an aluminum plate 1.

In this apparatus 100, the pipe 106 feeds water 102 to the water holding tank 104. When the water 102 in the tank 104 overflows, it is distributed by the flow distributor 108 and a free-falling curtain of water is supplied to the aluminum plate 1. During the use of this apparatus 100, the flow rate is preferably 10 to 100 L/min. The distance L over which the water 102 between the apparatus 100 and the aluminum plate 1 exists as a free-falling curtain of liquid is preferably from 20 to 50 mm. Moreover, it is preferable for the aluminum plate 1 to be inclined at an angle α to the horizontal of 30 to 80°.

By using an apparatus like that in FIG. 2 which rinses the aluminum plate with a free-falling curtain of water, the aluminum plate can be uniformly rinsed. This makes it possible to enhance the uniformity of the treatment carried out prior to rinsing.

A suitable example of an apparatus that carries out rinsing treatment with a free-falling curtain of water is described in JP 2003-96584 A.

Alternatively, rinsing may be carried out with a spray line having a plurality of spray tips that discharge fan-like sprays of water and are disposed along the width of the aluminum plate. The interval between the spray tips is preferably 20 to 100 mm, and the amount of water discharged per spray tip is preferably 0.5 to 20 L/min. The use of a plurality of spray lines is preferred.

<First Desmutting Treatment>

After the first etching treatment, it is preferable to carry out acid pickling (first desmutting treatment) to remove contaminants (smut) remaining on the surface of the aluminum plate. Desmutting treatment is carried out by bringing an acidic solution into contact with the aluminum plate.

Examples of acids that may be used include nitric acid, sulfuric acid, phosphoric acid, chromic acid, hydrofluoric acid and tetrafluoroboric acid.

In the first desmutting treatment which follows the first etching treatment, it is preferable to use overflow from the electrolytic solution employed in the subsequently carried out first electrochemical graining treatment.

The composition of the desmutting treatment solution can be controlled by selecting and using a method of control based on electrical conductivity and temperature with respect to a matrix of the acidic solution concentration and the aluminum ion concentration, a method of control based on electrical conductivity, specific gravity and temperature with respect to the above matrix, or a method of control based on electrical conductivity, ultrasonic wave propagation velocity and temperature with respect to the above matrix.

In the first desmutting treatment, it is preferable to use an acidic solution containing 1 to 400 g/L of acid and 0.1 to 5 g/L of aluminum ions.

The acidic solution has a temperature of preferably at least 20° C., and more preferably at least 30° C., but preferably not more than 70° C., and more preferably not more than 60° C.

In the first desmutting treatment, the treatment time is preferably at least 1 second, and more preferably at least 4 seconds, but preferably not more than 60 seconds, and more preferably not more than 40 seconds.

Illustrative examples of the method of bringing the aluminum plate into contact with the acidic solution include passing the aluminum plate through a tank filled with the acidic solution, immersing the aluminum plate in a tank filled with the acidic solution, and spraying the acidic solution onto the surface of the aluminum plate.

Of these, a method in which the acidic solution is sprayed onto the surface of the aluminum plate is preferred. More specifically, a method in which a desmutting solution is sprayed from at least one spray line, and preferably two or more spray lines, each having 2 to 5 mm diameter openings spaced at a pitch of 10 to 50 mm, at a rate of 10 to 100 L/min per spray line is desirable.

After desmutting treatment, it is preferable to remove solution remaining on the plate with nip rollers, then to carry out rinsing treatment with water for 1 to 10 seconds and remove the water from the plate with nip rollers.

Rinsing treatment here is the same as rinsing treatment following alkali etching treatment. However, it is preferable for the amount of water discharged per spray tip to be from 1 to 20 L/min.

If overflow from the electrolytic solution used in the subsequently carried out first electrochemical graining treatment is employed as the desmutting solution in the first desmutting treatment, rather than having desmutting treatment followed by the removal of solution with nip rollers and rinsing treatment, it is preferable to handle the aluminum plate up until the first electrochemical graining treatment step by suitably spraying it with the desmutting solution as needed so that the surface of the aluminum plate does not dry.

<First Electrochemical Graining Treatment>

The first electrochemical graining treatment in the first aspect of the invention is an electrochemical graining treatment which uses an alternating current in a nitric acid-containing aqueous solution (referred to below as the “first electrolytic solution”).

The first electrochemical graining treatment in the second aspect of the invention is an electrochemical graining treatment which uses an alternating current that satisfies the condition 0.8≦r≦1.0 in a nitric acid and aluminum ion-containing aqueous solution having a ratio R of at least 0.6 (referred to below as the “first electrolytic solution”).

By carrying out the first electrochemical graining treatment after the above-described mechanical graining treatment, pits having an average opening diameter of 1 to 6 μm can be formed on the surface of the aluminum plate, thus enabling a support to be achieved which has a long press life and excellent cleaner resistance and scumming resistance. Moreover, the amount of electricity used in the first electrochemical graining treatment can be reduced. If the aluminum plate has a relatively high copper content, relatively large and uniform recesses (pits) are formed on the surface of the aluminum plate in the first electrochemical graining treatment. Lithographic printing plates manufactured from the resulting lithographic printing plate supports thus have a long press life.

The first electrochemical graining treatment may be carried out in accordance with the electrochemical graining processes (electrolytic graining processes) described in, for example, JP 48-28123 B and GB 896,563 B. These electrolytic graining processes use an alternating current having a sinusoidal waveform, although they may also be carried out using special waveforms like those described in JP 52-58602 A. Use can also be made of the waveforms described in JP 3-79799 A. Other processes that may be employed for this purpose include those described in JP 55-158298 A, JP 56-28898 A, JP 52-58602 A, JP 52-152302 A, JP 54-85802 A, JP 60-190392 A, JP 58-120531 A, JP 63-176187 A, JP 1-5889 A, JP 1-280590 A, JP 1-118489 A, JP 1-148592 A, JP 1-178496 A, JP 1-188315 A, JP 1-154797 A, JP 2-235794 A, JP 3-260100 A, JP 3-253600 A, JP 4-72079 A, JP 4-72098 A, JP 3-267400 A and JP 1-141094 A. In addition to the above, electrolysis can also be carried out using alternating currents of a special frequency such as have been proposed in connection with methods for manufacturing electrolytic capacitors. These are described in, for example, U.S. Pat. No. 4,276,129 and U.S. Pat. No. 4,676,879.

Various electrolytic cells and power supplies have been proposed for use in electrolytic treatment. Use may be made of those described in, for example, U.S. Pat. No. 4,203,637, JP 56-123400 A, JP 57-59770 A, JP 53-12738 A, JP 53-32821 A, JP 53-32822 A, JP 53-32823 A, JP 55-122896 A, JP 55-132884 A, JP 62-127500 A, JP 1-52100 A, JP 1-52098 A, JP 60-67700 A, JP 1-230800 A, JP 3-257199 A, JP 52-58602 A, JP 52-152302 A, JP 53-12738 A, JP 53-12739 A, JP 53-32821 A, JP 53-32822 A, JP 53-32833 A, JP 53-32824 A, JP 53-32825 A, JP 54-85802 A, JP 55-122896 A, JP 55-132884 A, JP 48-28123 B, JP 51-7081 B, JP 52-133838 A, JP 52-133840 A, JP 52-133844 A, JP 52-133845 A, JP 53-149135 A and JP 54-146234 A.

In a preferred embodiment of the first aspect of the invention, the first electrolytic solution has a nitric acid concentration of at least 1 g/L but less than 15 g/L (this embodiment is referred to below as “Embodiment A”). In Embodiment A, the nitric acid concentration of the first electrolytic solution is more preferably from 7.5 to 12.5 g/L.

In another preferred embodiment, the first electrolytic solution has a nitric acid concentration of 15 to 50 g/L (this embodiment is referred to below as “Embodiment B”). In Embodiment B, the nitric acid concentration of the first electrolytic solution is more preferably from 17.5 to 30 g/L. By setting the nitric acid concentration in a range of 15 to 50 g/L and subsequently carrying out second etching treatment, even in a relatively low amount of electricity, it is possible to give the aluminum plate that has been subjected to the second etching treatment a mean surface roughness Rₐ suitable for a lithographic printing plate support.

Also, in the first aspect of the invention, the aluminum ion concentration of the first electrolytic solution is preferably from 1 to 15 g/L, and more preferably from 1.5 to 10 g/L. The aluminum ion concentration can be adjusted by adding, for example, aluminum nitrate nonahydrate.

In the first aspect of the invention, it is preferable for the first electrolytic solution to contain from 10 to 150 mg/L of ammonium ions.

In the second aspect of the invention, the first electrolytic solution has a nitric acid concentration of preferably 1 to 15 g/L, and more preferably 3.0 to 12.5 g/L.

Also, in the second aspect of the invention, the first electrolytic solution has an aluminum ion concentration of preferably 1 to 15 g/L, and more preferably 3.0 to 12.5 g/L. The aluminum ion concentration can be adjusted by adding, for example, aluminum nitrate nonahydrate.

In the second aspect of the invention, it is preferable for the first electrolytic solution to have a ratio R of the aluminum ion concentration A to the nitric acid concentration N (R=A/N) of at least 0.6, preferably from 0.6 to 3, and more preferably from 0.75 to 2.2. By setting R within this range, there can be obtained an aluminum support for a lithographic printing plate which has a long life and an excellent scumming resistance and shininess.

In the second aspect of the invention, it is preferable for the first electrolytic solution to contain from 10 to 200 mg/L of ammonium ions.

Moreover, in the practice of the invention, the first electrolytic solution may be used after adding thereto at least one nitrate ion-containing compound, such as aluminum nitrate, sodium nitrate or ammonium nitrate, in a range of from 1 g/L to saturation. Metals which are present in the aluminum alloy, such as iron, copper, manganese, nickel, titanium, magnesium and silicon may also be dissolved in the first electrolytic solution.

When electrolytic graining treatment is continuously carried out on the aluminum plate, the aluminum ion concentration in the alkali solution rises over time, as a result of which the shape of the asperities formed on the aluminum plate by the first electrochemical graining treatment will fluctuate. It is thus advantageous to control the composition of the first electrolytic solution as follows.

First, a matrix of the electrical conductivity, specific gravity and temperature or a matrix of the conductivity, ultrasonic wave propagation velocity and temperature is prepared with respect to a matrix of the nitric acid concentration and the aluminum ion concentration. The solution composition is then measured based on either the conductivity, specific gravity and temperature or the conductivity, ultrasonic wave propagation velocity and temperature, and nitric acid and water are added to the solution up to control target values for the solution composition. Next, the first electrolytic solution which has increased in volume with the addition of nitric acid and water is allowed to overflow from a circulation tank, thereby holding the amount of solution constant. The nitric acid added may be industrial-grade 30 to 70 wt % nitric acid.

The conductivity meter and hydrometer used to measure electrical conductivity and specific gravity are each preferably temperature-compensated instruments. The hydrometer is preferably a pressure differential hydrometer.

To measure the solution composition to a high accuracy, it is preferable that samples collected from the first electrolytic solution for the purpose of measurement be furnished for measurement after first being controlled to a fixed temperature (e.g., 40±0.5° C.) using a different heat exchanger from the one used for the first electrolytic solution.

Moreover, by adding and using a compound capable of forming a complex with copper, uniform graining is possible even on an aluminum plate having a high copper content. Compounds capable of forming a complex with copper include ammonia; amines obtained by substituting a hydrogen atom on ammonia with an (aliphatic or aromatic) hydrocarbon group, such as methylamine, ethylamine, dimethylamine, diethylamine, trimethylamine, cyclohexylamine, triethanolamine, triisopropanolamine and ethylenediaminetetraacetic acid (EDTA); and metal carbonates such as sodium carbonate, potassium carbonate and potassium hydrogencarbonate. Additional compounds suitable for this purpose include ammonium salts such as ammonium nitrate, ammonium chloride, ammonium sulfate, ammonium phosphate and ammonium carbonate.

The first electrolytic solution has a temperature of preferably 5 to 55° C., and more preferably 20 to 50° C.

In Embodiment A of the first aspect of the invention, the first electrochemical graining treatment is carried out in such a way that the ratio r of the amount of electricity QR when the aluminum plate acts as a cathode to the amount of electricity QF when the aluminum plate acts as an anode (i.e., r=QR/QF; this ratio is sometimes referred below as the “current ratio”) preferably satisfies the relationship 0.4≦r≦0.8, and more preferably satisfies the relationship 0.5≦r≦0.7. Within this range, a mean surface roughness Rₐ and surface shape suitable for the lithographic printing plate support prepared from the aluminum plate can be obtained with a smaller amount of electricity.

In Embodiment B of the first aspect of the invention, the ratio r is preferably from 0.3 to 1.0, and more preferably from 0.92 to 0.98.

In the second aspect of the invention, the first electrochemical graining treatment is carried out in such a way that the ratio r of the amount of electricity QR when the aluminum plate acts as a cathode to the amount of electricity QF when the aluminum plate acts as an anode satisfies the relationship 0.8≦r≦1.0. Within this range, more uniform pits are formed and, when the aluminum plate is prepared as a support for a lithographic printing plate, there can be obtained a lithographic printing plate support having an excellent scumming resistance and a long press life.

No particular limitation is imposed on the waveform of the alternating current used in the first electrochemical graining treatment. For example, a sinusoidal, square, trapezoidal or triangular waveform may be used. Of these, a square or trapezoidal waveform is preferred. A trapezoidal waveform is especially preferred.

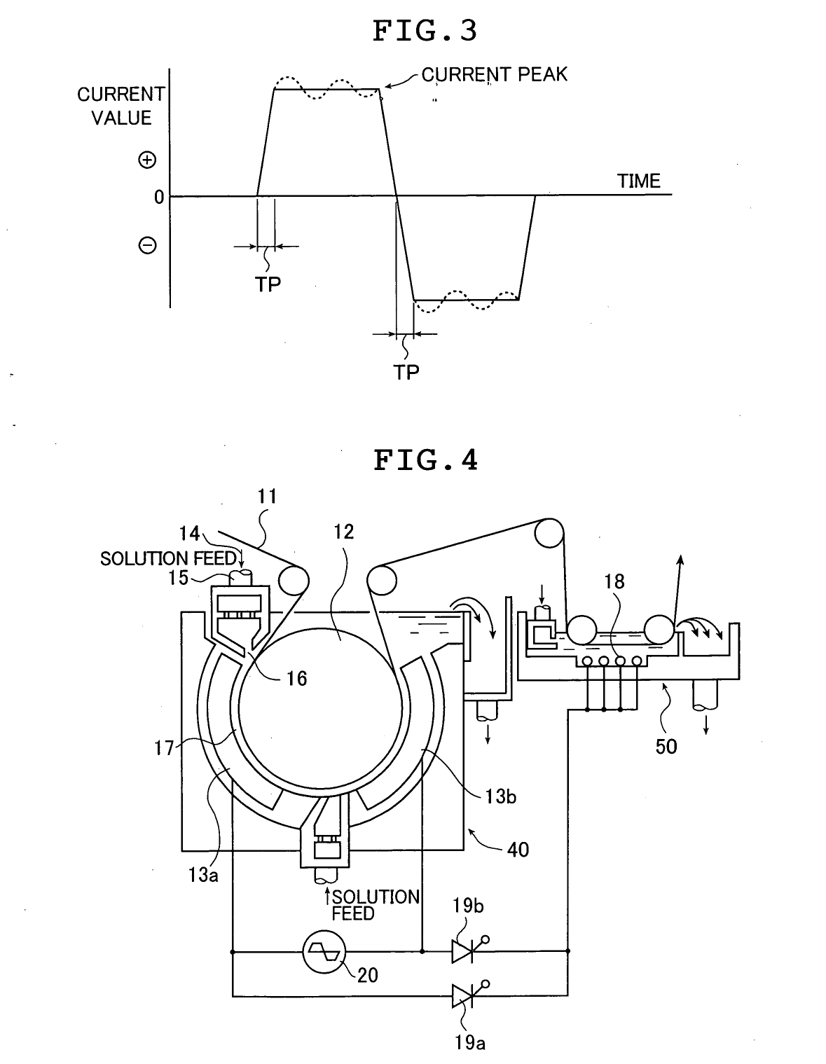

“Trapezoidal waveform” refers herein to a waveform like that shown in FIG. 3. In this trapezoidal waveform, it is preferable for the time TP until the current reaches a peak from zero to be from 0.5 to 3.0 ms. At a TP of more than 3 ms, particularly when a nitric acid-containing aqueous solution is used, the aluminum plate tends to be affected by ammonium ions and other trace ingredients in the first electrolytic solution that spontaneously increase during electrolytic treatment, making it difficult to carry out uniform graining. As a result, there is a tendency for lithographic printing plates obtained using the aluminum plate to have a diminished scumming resistance. By using trapezoidal waves, it is also possible to design the power supply to a lower maximum current value at the same average current value, enabling a reduction in the costs associated with the power supply.

The duty ratio of trapezoidal waves that may be used is preferably from 0.33 to 0.67. However, as noted in JP 5-195300 A, the use of trapezoidal waves having a duty ratio of 0.5 is preferred in an indirect power feed system that does not use a conductor roll to feed current to the aluminum. As used herein, “duty ratio” refers to the value obtained by dividing the duration of the anodic reaction at the aluminum plate within a single cycle by the period of the cycle.

The frequency of trapezoidal waves that may be used is preferably from 0.1 to 120 Hz, although a frequency of 50 to 70 Hz is preferable from the standpoint of the equipment. At a frequency lower than 50 Hz, the carbon electrode serving as the main electrode tends to dissolve more readily. On the other hand, at a frequency higher than 70 Hz, the power supply circuit is more readily subject to the influence of inductance thereon, increasing the power supply costs.

One or more AC power supplies may be connected to the electrolytic cell. To control the anode/cathode current ratio of the alternating current applied to the aluminum plate facing the main electrodes and thereby carry out uniform graining and to dissolve carbon from the main electrodes, it is advantageous to provide an auxiliary anode and divert some of the alternating current as shown in FIG. 4. FIG. 4 shows an aluminum plate 11, a radial drum roller 12, main electrodes 13a and 13b, an electrolytic treatment solution 14, a solution feed inlet 15, a slit 16, a solution channel 17, an auxiliary anode 18, thyristors 19a and 19b, an AC power supply 20, a main electrolytic cell 40 and an auxiliary anode cell 50. By using a rectifying or switching device to divert some of the current as direct current to an auxiliary anode provided in a separate cell from that containing the two main electrodes, it is possible to control the ratio between the current furnished for the anodic reaction which acts on the aluminum plate facing the main electrodes and the current value furnished for the cathodic reaction.

Any known electrolytic cell employed for surface treatment, including vertical, flat and radial type electrolytic cells, may be used to carry out the first electrochemical graining treatment. Radial-type electrolytic cells such as those described in JP 5-195300 A are especially preferred. The electrolytic solution is passed through the electrolytic cell either parallel or counter to the direction in which the aluminum plate (aluminum web) advances through the process.

Pits having an average opening diameter of 1 to 6 μm can be formed by the first electrochemical graining treatment. However, when the amount of electricity is made relatively large, the electrolytic reaction becomes concentrated, resulting in the formation of honeycombed pits larger than 6 μm.

To obtain such a grained surface, the total amount of electricity furnished to the anodic reaction at the aluminum plate up until completion of the electrolytic reaction is preferably from 50 to 300 C/dm², and more preferably from 100 to 250 C/dm².

Following completion of the first electrochemical graining treatment, it is desirable to remove solution remaining on the aluminum plate with nip rollers, rinse the plate with water for 1 to 10 seconds, then remove the water with nip rollers.

Rinsing treatment is preferably carried out using a spray line. The spray line used in rinsing treatment is typically one having a plurality of spray tips, each of which discharges a fan-like spray of water, arrayed along the width of the aluminum plate. The interval between the spray tips is preferably 20 to 100 mm, and the amount of water discharged per spray tip is preferably 1 to 20 L/min. Rinsing with a plurality of spray lines is preferred.

The peak current density when the aluminum plate undergoes an anodic reaction within the main electrolytic cell in the first electrochemical graining treatment is preferably from 10 to 300 A/dm², more preferably from 15 to 200 A/dm², and even more preferably from 20 to 125 A/dm². A current density in this range provides a better productivity. Moreover, the voltage remains at a moderate level and the power supply capacity is not too large, enabling the power supply costs to be reduced.

The power supply may be, for example, one which uses commercial AC power or may be an inverter-controlled power supply. Of these, an inverter-controlled power supply which uses an insulated gate bipolar transistor (IGBT) is preferred because it can generate a given waveform by pulse width modulation (PWM) and has an excellent load-following ability during control in which the voltage is regulated to keep the current value (current density at aluminum plate) constant in response to such parameters as the width and thickness of the aluminum plate and fluctuations in the concentrations of ingredients within the electrolytic solution.

<Second Etching Treatment>

It is desirable to carry out a second etching treatment between the first electrochemical graining treatment and the second electrochemical graining treatment.

The purpose of the second etching treatment is to dissolve the smut that arises in the first electrochemical graining treatment by bringing the aluminum plate which has been subjected to the first electrochemical graining treatment into contact with an alkali solution, and to dissolve the edges of the pits formed by the first electrochemical graining treatment. Because the second etching treatment is basically the same as the first etching treatment, only those features that differ are described below.

The amount of material removed from the aluminum plate in the second etching treatment is preferably at least 0.05 g/m², and more preferably at least 0.1 g/m², but preferably not more than 4 g/m², and more preferably not more than 3.5 g/m². If too little material is removed by etching, smoothing of the edges of the pits formed in the first electrochemical graining treatment does not occur, as a result of which ink tends to catch on the edges of the pits, which may worsen the scumming resistance in non-image areas of the lithographic printing plate. On the other hand, if too much material is removed in etching, the asperities formed in the first electrochemical graining treatment become smaller, which may shorten the press life.

In the second etching treatment, the alkali solution has a concentration of preferably at least 30 g/L, and more preferably at least 300 g/L, but preferably not more than 500 g/L, and more preferably not more than 450 g/L.

It is advantageous for the alkali solution to contain aluminum ions. The aluminum ion concentration is preferably at least 1 g/L, and more preferably at least 50 g/L, but preferably not more than 200 g/L, and more preferably not more than 150 g/L. Such an alkali solution can be prepared using water, a 48 wt % aqueous sodium hydroxide solution, and sodium aluminate.

In the second etching treatment, the alkali solution has a temperature of preferably at least 30° C., and more preferably at least 35° C., but preferably not more than 60° C., and more preferably not more than 50° C.

In the second etching treatment, the treatment time is preferably at least 1 second, and more preferably at least 2 seconds, but preferably not more than 30 seconds, and more preferably not more than 10 seconds.

The mean surface roughness Rₐ after the second etching treatment is preferably from 0.43 to 0.60. At a mean surface roughness Rₐ in this range, a lithographic printing plate support having an excellent shininess can be obtained.

The surface of the aluminum plate following the second etching treatment is preferably such that the ratio of the average slope to the mean surface roughness (Δa/Rₐ) multiplied by 100 is from 4.0 to 6.0.

<Second Desmutting Treatment>

After the second etching treatment, it is preferable to carry out acid pickling (second desmutting treatment) to remove smut remaining on the surface of the aluminum plate. Because the second desmutting treatment is basically the same as the first desmutting treatment, only the features that differ are described below.

In the second desmutting treatment, it is preferable to use nitric acid or sulfuric acid.

Treatment is preferably carried out using an acidic solution containing 1 to 400 g/L of acid and 0.5 to 8 g/L of aluminum ions.

In the second desmutting treatment, the treatment time is preferably at least 1 second, and more preferably at least 4 seconds, but preferably not more than 60 seconds, and more preferably not more than 20 seconds.

<Second Electrochemical Graining Treatment>

After the above second etching treatment has been carried out, it is preferable to carry out the second electrochemical graining treatment.

The second electrochemical graining treatment is an electrochemical graining treatment in which an alternating current is passed through the aluminum plate in a hydrochloric acid-containing aqueous solution (referred to below as the second electrolytic solution”). By carrying out the second electrochemical graining treatment, a surface topography which includes pits having an average opening diameter of 0.05 to 0.5 μm can be formed on the surface of the aluminum plate. As a result, a better cleaner resistance is achieved.

Aside from the difference in the electrolytic solution, the second electrochemical graining treatment may be carried out by substantially the same method as the above-described first electrochemical graining treatment. Only the features that differ are described below.

The second electrolytic solution may be prepared by adding to an aqueous solution having a hydrochloric acid concentration of 1 to 100 g/L at least one chloride compound containing chloride ions, such as aluminum chloride, sodium chloride or ammonium chloride, in a range of 1 g/L to saturation. Metals which are present in the aluminum alloy, such as iron, copper, manganese, nickel, titanium, magnesium and silicon may also be dissolved in the second electrolytic solution.

More specifically, the use of a solution prepared by dissolving aluminum chloride in an aqueous hydrochloric acid solution having a hydrochloric acid concentration of 2 to 10 g/L, and adjusting the aluminum ion concentration to 3 to 7 g/L is preferred.

The second electrolytic solution has a temperature of preferably at least 25° C., and more preferably at least 30° C., but preferably not more than 55° C., and more preferably not more than 40° C.

Because hydrochloric acid itself has a strong ability to dissolve aluminum, fine asperities can be formed on the surface by slightly carrying out electrolysis. These fine asperities have an average opening diameter of 0.01 to 0.2 μm, and are uniformly formed over the entire surface of the aluminum plate. To obtain such a grained surface, the total amount of electricity furnished for the anodic reaction on the aluminum plate up until completion of the electrolytic reaction is preferably at least 10 C/dm², and more preferably at least 50 C/dm², but preferably not more than 100 C/dm², and more preferably not more than 80 C/dm². The peak current density at this time is preferably from 20 to 100 A/dm².

The current ratio r is preferably from 0.9 to 1.0, and more preferably from 0.92 to 0.98.

In an amount of electricity in the above range, the amount of aluminum which dissolves in the second electrochemical graining treatment is small. Hence, the aluminum plate has a mean surface roughness Rₐ following the second electrochemical graining treatment which is substantially the same as that after the second etching treatment. Moreover, even when the subsequently described anodizing treatment is carried out, the mean surface roughness Rₐ at the surface of the aluminum plate is substantially the same as that after the second etching treatment.

In the second electrochemical graining treatment, the peak current density when the aluminum plate undergoes an anodic reaction within the main electrolytic cell is preferably from 10 to 300 A/dm², more preferably from 15 to 200 A/dm², and even more preferably from 20 to 125 A/dm². A current density in this range provides a better productivity. Moreover, the voltage remains at a moderate level and the power supply capacity is not too large, enabling the power supply costs to be reduced.

No particular limitation is imposed on the waveform of the alternating current used in the second electrochemical graining treatment. For example, a sinusoidal, square, trapezoidal or triangular waveform may be used. Of these, a square or trapezoidal waveform is preferred. A trapezoidal waveform is especially preferred. The trapezoidal waves used have a TP of preferably from 0.5 to 3 ms, and more preferably from 0.6 to 1.5 ms.

The power supply may be, for example, one which uses commercial AC power or may be an inverter-controlled power supply. Of these, an inverter-controlled power supply which uses an insulated gate bipolar transistor (IGBT) is preferred because it can generate a given waveform by pulse width modulation (PWM) and has an excellent load-following ability during control in which the voltage is regulated to keep the current value (current density at aluminum plate) constant in response to such parameters as the width and thickness of the aluminum plate and fluctuations in the concentrations of ingredients within the electrolytic solution.

When electrolytic graining treatment is continuously carried out on the aluminum plate, the aluminum ion concentration in the alkali solution rises over time, as a result of which the shape of the asperities formed on the aluminum plate by the second electrochemical graining treatment fluctuates. It is thus advantageous to control the composition of the hydrochloric acid electrolytic solution as follows.

First, a matrix of the electrical conductivity, specific gravity and temperature or a matrix of the conductivity, ultrasonic wave propagation velocity and temperature is prepared with respect to a matrix of the hydrochloric acid concentration and the aluminum ion concentration. The solution composition is then measured based on either the conductivity, specific gravity and temperature or the conductivity, ultrasonic wave propagation velocity and temperature, and hydrochloric acid and water are added up to control target values for the solution composition. Next, the electrolytic solution which has increased in volume with the addition of hydrochloric acid and water is allowed to overflow from a circulation tank, thereby holding the amount of solution constant. The hydrochloric acid added may be industrial-grade 10 to 40 wt % hydrochloric acid.

The conductivity meter and hydrometer used to measure electrical conductivity and specific gravity are each preferably temperature-compensated instruments. The hydrometer is preferably a pressure differential hydrometer.

To measure the solution composition to high accuracy, it is preferable that samples collected from the electrolytic solution for the purpose of measurement be furnished for measurement after first being controlled to a fixed temperature (e.g., 35±0.5° C.) using a different heat exchanger from the one used for the electrolytic solution.

<Third Etching Treatment>

It is desirable to carry out a third etching treatment after the second electrochemical graining treatment.

The purpose of the third etching treatment is to dissolve the smut that arises in the second electrochemical graining treatment by bringing the aluminum plate which has been subjected to the second electrochemical graining treatment into contact with an alkali solution, and to dissolve the edges of the pits formed by the second electrochemical graining treatment. Because the third etching treatment is basically the same as the first etching treatment, only the features that differ are described below.

The amount of material removed by the third etching treatment is preferably at least 0.01 g/m², and more preferably at least 0.05 g/m², but preferably not more than 0.3 g/m², and more preferably not more than 0.25 g/m². If too little material is removed by etching, smoothing of the edges of the pits formed in the second electrochemical graining treatment does not occur, as a result of which ink tends to catch on the edges of the pits, which may worsen the scumming resistance in non-image areas of the lithographic printing plate. On the other hand, if too much material is removed in etching, the asperities formed in the first and second electrochemical graining treatments become smaller, which may shorten the press life.

In the third etching treatment, the alkali solution has a concentration of preferably at least 30 g/L. However, to keep the asperities formed in the preceding second electrochemical graining treatment from becoming too small, the concentration is preferably not more than 100 g/L, and more preferably not more than 70 g/L.

It is advantageous for the alkali solution to contain aluminum ions. The aluminum ion concentration is preferably at least 1 g/L, and more preferably at least 3 g/L, but preferably not more than 50 g/L, and more preferably not more than 8 g/L. Such an alkali solution can be prepared using water, a 48 wt % aqueous sodium hydroxide solution, and sodium aluminate.

In the third etching treatment, the alkali solution has a temperature of preferably at least 25° C., and more preferably at least 30° C., but preferably not more than 60° C., and more preferably not more than 50° C.

In the third etching treatment, the treatment time is preferably at least 1 second, and more preferably at least 2 seconds, but preferably not more than 30 seconds, and more preferably not more than 10 seconds.

<Third Desmutting Treatment>

After the third etching treatment, it is preferable to carry out acid pickling (third desmutting treatment) to remove smut remaining on the surface of the aluminum plate. Because the third desmutting treatment is basically the same as the first desmutting treatment, only the features that differ are described below.

In the third desmutting treatment, it is preferable to use an acidic solution containing 5 to 400 g/L of acid and 0.5 to 8 g/L of aluminum ions.

In the third desmutting treatment, the treatment time is preferably at least 1 second, and more preferably at least 3 seconds, but preferably not more than 60 seconds, and more preferably not more than 15 seconds.

In the third desmutting treatment, when a solution of the same type as the electrolytic solution (e.g., sulfuric acid) employed in the subsequently carried out anodizing treatment is used as the desmutting solution, solution removal with nip rollers and rinsing that are to be carried out between the third desmutting treatment and the anodizing treatment can be eliminated.

<Anodizing Treatment>

Preferably, the aluminum plate treated as described above is also subjected to anodizing treatment. Anodizing treatment may be carried out by any method commonly used in the art. More specifically, an anodized layer can be formed on the surface of the aluminum plate by passing a current through the aluminum plate as the anode in, for example, a solution having a sulfuric acid concentration of 50 to 300 g/L and an aluminum ion concentration of up to 5 wt %. The solution used for anodizing treatment includes any one or combination of, for example, sulfuric acid, phosphoric acid, chromic acid, oxalic acid, sulfamic acid, benzenesulfonic acid and amidosulfonic acid.

It is acceptable for at least ingredients ordinarily present in the aluminum plate, electrodes, tap water, ground water and the like to be present in the electrolytic solution. In addition, secondary and tertiary ingredients may be added. Here, “second and tertiary ingredients” includes, for example, the ions of metals such as sodium, potassium, magnesium, lithium, calcium, titanium, aluminum, vanadium, chromium, manganese, iron, cobalt, nickel, copper and zinc; cations such as ammonium ions; and anions such as nitrate ions, carbonate ions, chloride ions, phosphate ions, fluoride ions, sulfite ions, titanate ions, silicate ions and borate ions. These may be present in concentrations of about 0 to 10,000 ppm.

The anodizing treatment conditions vary empirically according to the electrolytic solution used, although it is generally suitable for the solution to have an electrolyte concentration of 1 to 80 wt % and a temperature of 5 to 70° C., and for the current density to be 0.5 to 60 A/dm², the voltage to be 1 to 100 V, and the electrolysis time to be 15 seconds to 50 minutes. These conditions may be adjusted to obtain the desired anodized layer weight.

Methods that may be used to carry out anodizing treatment include those described in JP 54-81133 A, JP 57-47894 A, JP 57-51289 A, JP 57-51290 A, JP 57-54300 A, JP 57-136596 A, JP 58-107498 A, JP 60-200256 A, JP 62-136596 A, JP 63-176494 A, JP 4-176897 A, JP 4-280997 A, JP 6-207299 A, JP 5-24377 A, JP 5-32083 A, JP 5-125597 A and JP 5-195291 A.

Of these, as described in JP 54-12853 A and JP 48-45303 A, it is preferable to use a sulfuric acid solution as the electrolytic solution. The electrolytic solution has a sulfuric acid concentration of preferably 10 to 300 g/L (1 to 30 wt %), and more preferably 50 to 200 g/L (5 to 20 wt %), and has an aluminum ion concentration of preferably 1 to 25 g/L (0.1 to 2.5 wt %), and more preferably 2 to 10 g/L (0.2 to 1 wt %). An electrolytic solution of this type can be prepared by adding a compound such as aluminum sulfate to dilute sulfuric acid having a sulfuric acid concentration of 50 to 200 g/L.

Control of the electrolytic solution composition is typically carried out using a method similar to that employed in the above-described first electrochemical graining treatment. That is, control is preferably effected by means of the electrical conductivity, specific gravity and temperature or of the conductivity, ultrasonic wave propagation velocity and temperature with respect to a matrix of the sulfuric acid concentration and the aluminum ion concentration.

The electrolytic solution has a temperature of preferably 25 to 55° C., and more preferably 30 to 50° C.

When anodizing treatment is carried out in an electrolytic solution containing sulfuric acid, direct current or alternating current may be applied across the aluminum plate and the counterelectrode.

When a direct current is applied to the aluminum plate, the current density is preferably 1 to 60 A/dm², and more preferably 5 to 40 A/dm².

To keep burnt deposits (areas of the anodized layer which are thicker than surrounding areas) from arising on portions of the aluminum plate due to the concentration of current when anodizing treatment is carried out as a continuous process, it is preferable to apply current at a low density of 5 to 10 A/m² at the start of anodizing treatment and to increase the current density to 30 to 50 A/dm² or more as anodizing treatment proceeds.

Specifically, it is preferable for current from the DC power supplies to be allocated such that current from downstream DC power supplies is equal to or greater than current from upstream DC power supplies. Current allocation in this way will discourage the formation of burnt deposits, enabling high-speed anodization to be carried out.

When anodizing treatment is carried out as a continuous process, this is preferably done using a system that supplies power to the aluminum plate through the electrolytic solution.

By carrying out anodizing treatment under such conditions, a porous film having numerous micropores can be obtained. These micropores generally have an average diameter of about 5 to 50 nm and an average pore density of about 300 to 800 pores/μm².

The weight of the anodized layer is preferably 1 to 5 g/m². At less than 1 g/m², scratches are readily formed on the plate. On the other hand, a weight of more than 5 g/m² requires a large amount of electrical power, which is economically disadvantageous. An anodized layer weight of 1.5 to 4 g/m² is more preferred. It is also desirable for anodizing treatment to be carried out in such a way that the difference in the anodized layer weight between the center of the aluminum plate and areas near the edges is not more than 1 g/m².

Examples of electrolyzing apparatuses that may be used in anodizing treatment include those described in JP 48-26638 A, JP 47-18739 A, JP 58-24517 B and JP 2001-11698 A.

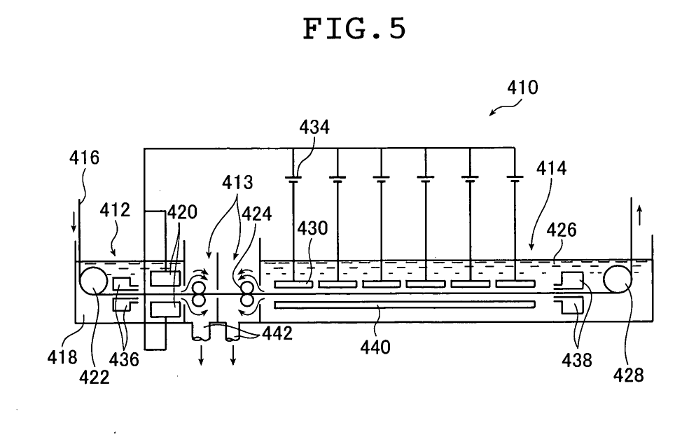

Of these, an apparatus like that shown in FIG. 5 is preferred. FIG. 5 is a schematic view of an apparatus for anodizing the surface of an aluminum plate.

In an anodizing apparatus 410 shown in FIG. 5, to apply a current to an aluminum plate 416 through an electrolytic solution, a power supplying tank 412 is disposed on the upstream side of the aluminum plate 416 in its moving direction and an anodizing treatment tank 414 is disposed on the downstream side. The aluminum plate 416 is moved by path rollers 422 and 428 in the direction indicated by arrows in FIG. 5. The power supplying tank 412 through which the aluminum plate 416 first passes is provided with anodes 420 which are connected to the positive poles of DC power supplies 434; and the aluminum plate 416 serves as the cathode. Hence, a cathodic reaction arises at the aluminum plate 416.

The anodizing treatment tank 414 through which the aluminum plate 416 next passes is provided with a cathode 430 which is connected to the negative poles of the DC power supplies 434; the aluminum plate 416 serves as the anode. Hence, an anodic reaction arises at the aluminum plate 416, and an anodized layer is formed on the surface of the aluminum plate 416.

The aluminum plate 416 and the cathode 430 are separated by an interval of preferably 50 to 200 mm. The cathode 430 may be made of aluminum. To make it easier to vent from the system hydrogen gas generated by the anodic reaction, it is preferable for the cathode 430 to be divided into a plurality of sections in the direction of advance of the aluminum plate 416 rather than to be a single electrode having a broad surface area.

As shown in FIG. 5, it is advantageous to provide, between the power supplying tank 412 and the anodizing treatment tank 414, an intermediate tank 413 which does not hold the electrolytic solution. By providing such an intermediate tank 413, bypass of the current from the anode 420 to the cathode 430 without passing through the aluminum plate 416 can be prevented. It is preferable to minimize the bypass current by providing nip rollers 424 in the intermediate tank 413 to remove the solution remaining on the aluminum plate 416. The solution removed by the nip rollers 424 is discharged to the outside of the anodizing apparatus 410 through discharge outlets 442.

To lower the voltage loss, the electrolytic solution 418 which is supplied to the power supplying tank 412 is set to a higher temperature and/or concentration than an electrolytic solution 426 which is supplied to the anodizing treatment tank 414. Moreover, the composition, temperature and other characteristics of the electrolytic solutions 418 and 426 are set based on such considerations as the anodized layer forming efficiency, the shapes of micropores on the anodized layer, the hardness of the anodized layer, the voltage, and the cost of the electrolytic solution.

The power supplying tank 412 and the anodizing treatment tank 414 are supplied with electrolytic solution injected by solution feed nozzles 436 and 438. To ensure that the distribution of electrolytic solution remains uniform and thereby prevent the localized concentration of current on the aluminum plate 416 in the anodizing treatment tank 414, the solution feed nozzles 436 and 438 have a construction in which slits are provided to keep the flow of injected liquid constant in the width direction.

In the anodizing treatment tank 414, a shield 440 is provided on the opposite side of the aluminum plate 416 from the cathode 430 to inhibit the flow of current to the opposite side of the aluminum plate 416 from the surface on which the anodized layer is to be formed. The interval between the aluminum plate 416 and the shield 440 is preferably 5 to 30 mm. It is preferable to use a plurality of DC power supplies 434 with their positive poles connected in common, thereby enabling control of the current distribution within the anodizing treatment tank 414.

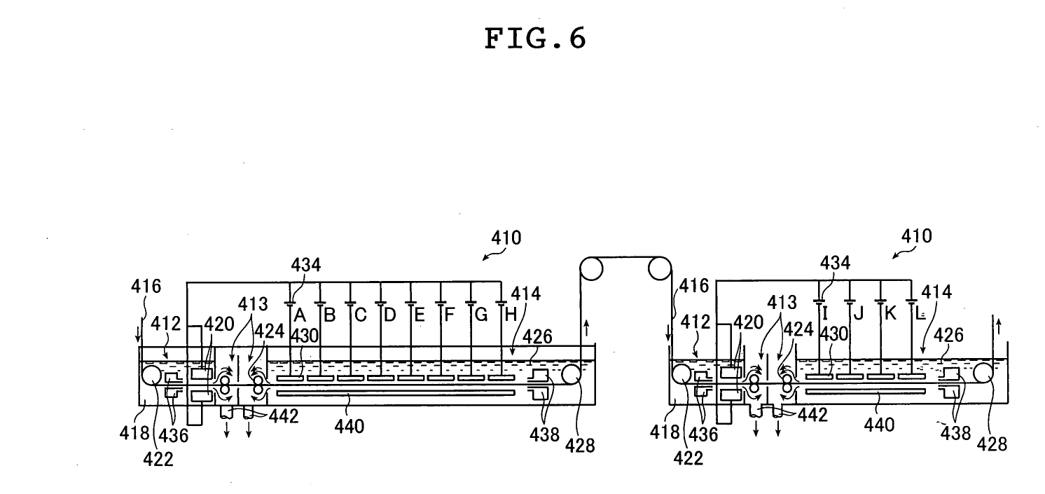

The anodizing apparatus shown in FIG. 6 is composed of two of the above-described anodizing apparatuses shown in FIG. 5 which are connected in series.

<Sealing Treatment>

In the practice of the invention, if necessary, sealing treatment may be carried out to close the micropores present in the anodized layer. Sealing treatment may be carried out in accordance with a known method, such as boiling water treatment, hot water treatment, steam treatment, sodium silicate treatment, nitrite treatment and ammonium acetate treatment. For example, sealing treatment may be carried out using the apparatuses and processes described in JP 56-12518 B, JP 4-4194 A, JP 5-202496 A and JP 5-179482 A.

<Hydrophilizing Treatment>

It is advantageous to carry out hydrophilizing treatment after anodizing treatment or after sealing treatment. Illustrative examples of suitable hydrophilizing treatments include the potassium hexafluorozirconate treatment described in U.S. Pat. No. 2,946,638, the phosphomolybdate treatment described in U.S. Pat. No. 3,201,247, the alkyl titanate treatment described in GB 1,108,559 B, the polyacrylic acid treatment described in DE 1,091,433 B, the polyvinylphosphonic acid treatments described in DE 1,134,093 B and GB 1,230,447 B, the phosphonic acid treatment described in JP 44-6409 B, the phytic acid treatment described in U.S. Pat. No. 3,307,951, the treatments involving the divalent metal salts of lipophilic organic polymeric compounds described in JP 58-16893 A and JP 58-18291 A, a treatment like that described in U.S. Pat. No. 3,860,426 in which an aqueous metal salt (e.g., zinc acetate)-containing hydrophilic cellulose (e.g., carboxymethyl cellulose) undercoat is provided, and an undercoating treatment like that described in JP 59-101651 A in which a sulfo group-bearing water-soluble polymer is applied.

Additional examples of suitable hydrophilizing treatments include those which involve undercoating the aluminum plate with the phosphates mentioned in JP 62-19494 A, the water-soluble epoxy compounds mentioned in JP 62-33692 A, the phosphoric acid-modified starches mentioned in JP 62-97892 A, the diamine compounds mentioned in JP 63-56498 A, the inorganic or organic salts of amino acids mentioned in JP 63-130391 A, the carboxy or hydroxy group-bearing organic phosphonic acids mentioned in JP 63-145092 A, the amino group and phosphonate group-containing compounds mentioned in JP 63-165183 A, the specific carboxylic acid derivatives mentioned in JP 2-316290 A, the phosphate esters mentioned in JP 3-215095 A, the compounds having one amino group and one phosphorus oxo acid group mentioned in JP 3-261592 A, the phosphate esters mentioned in JP 3-215095 A, the aliphatic or aromatic phosphonic acids (e.g., phenylphosphonic acid) mentioned in JP 5-246171 A, the sulfur atom-containing compounds (e.g., thiosalicylic acid) mentioned in JP 1-307745 A, and the phosphorus oxo acid group-bearing compounds mentioned in JP 4-282637 A.

Coloration with an acid dye as mentioned in JP 60-64352 A may also be carried out.

It is preferable to carry out hydrophilizing treatment by a method in which the aluminum plate is immersed in an aqueous solution of an alkali metal silicate such as sodium silicate or potassium silicate, or is coated with a hydrophilic vinyl polymer or a hydrophilic compound so as to form a hydrophilic undercoat.

Hydrophilizing treatment with an aqueous solution of an alkali metal silicate such as sodium silicate or potassium silicate can be carried out according to the processes and procedures described in U.S. Pat. No. 2,714,066 and U.S. Pat. No. 3,181,461.

Illustrative examples of suitable alkali metal silicates include sodium silicate, potassium silicate and lithium silicate. The use of No. 1 sodium silicate or No. 3 sodium silicate is preferred. No. 1 sodium silicate is especially preferred.

When No. 1 sodium silicate is used in the aqueous solution employed for hydrophilizing treatment, the concentration of No. 1 sodium silicate is preferably from 1 to 10 wt %, the solution temperature is preferably from 10 to 30° C., and the treatment time is preferably from 1 to 15 seconds.

The aqueous solution of an alkali metal silicate may include also a suitable amount of, for example, sodium hydroxide, potassium hydroxide, lithium hydroxide or the like.

The aqueous solution of an alkali metal silicate may include also an alkaline earth metal salt or a Group 4 (Group IVA) metal salt. Examples of suitable alkaline earth metal salts include nitrates such as calcium nitrate, strontium nitrate, magnesium nitrate and barium nitrate; and also sulfates, hydrochlorides, phosphates, acetates, oxalates, and borates. Exemplary Group 4 (Group IVA) metal salts include titanium tetrachloride, titanium trichloride, titanium potassium fluoride, titanium potassium oxalate, titanium sulfate, titanium tetraiodide, zirconyl chloride, zirconium dioxide and zirconium tetrachloride. These alkaline earth metal salts and Group 4 (Group IVA) metal salts may be used singly or in combinations of two or more thereof.

The amount of silicon adsorbed as a result of alkali metal silicate treatment can be measured with a fluorescent x-ray analyzer, and is preferably about 1.0 to 10.0 mg/m² and more preferably 3 to 10 mg/m². In an amount of silicon adsorption in a range of 3 to 10 mg/m³, halftone dot areas have a good scumming resistance.

To be more specific, in the shadow areas (halftone dot areas) of a printed impression, the halftone dot area ratio is high (70 to 90%); in corresponding regions of the lithographic printing plate, image areas (image recording layer) have a large surface area, and non-image areas (exposed portions of the support) have a relatively small surface area. There is a tendency in such cases for ink that has been placed on neighboring image areas of the plate to come into mutual contact during printing, causing the ink to adhere to non-image area therebetween and thus filling in (plugging) the corresponding non-image area on the impression.

However, by carrying out hydrophilizing treatment and setting the amount of silicon which deposits on the surface of the lithographic printing plate support at from 3 to 10 mg/m², the hydrophilicity of non-image areas is improved. Hence, when a lithographic printing plate is produced using the resulting lithographic printing plate support and printing is carried out with the printing plate, the scumming resistance in halftone dot areas of the printing plate can be improved.

The above-described alkali metal silicate treatment has the effect of enhancing the resistance at the surface of the lithographic printing plate support to dissolution in an alkali developer, suppressing the leaching of aluminum components into the developer, and reducing the generation of development scum arising from developer fatigue.

Alternatively, hydrophilizing treatment involving the formation of a hydrophilic undercoat can be carried out in accordance with the conditions and procedures described in JP 59-101651 A and JP 60-149491 A.

Hydrophilic vinyl polymers that may be used in such a method include copolymers of a sulfo group-bearing vinyl polymerizable compound such as polyvinylsulfonic acid or sulfo group-bearing p-styrenesulfonic acid with a conventional vinyl polymerizable compound such as an alkyl (meth)acrylate. Examples of hydrophilic compounds that may be used in this method include compounds having at least one group selected from among —NH₂ group, —COOH group and sulfo group.

<Drying>

After the lithographic printing plate support has been obtained as described above, it is advantageous to dry the surface of the support before providing an image recording layer thereon. Drying is preferably carried out after the support has been rinsed with water and the water removed with nip rollers following the final surface treatment.

The drying temperature is preferably at least 70° C., and more preferably at least 80° C., but preferably not more than 110° C., and more preferably not more than 100° C.

The drying time is preferably from 2 to 15 seconds.

<Control of the Solution Compositions>

In the practice of the invention, it is preferable for the compositions of the various solutions used in the above-described surface treatment to be controlled by the method described in JP 2001-121837 A. This typically involves first preparing a large number of treatment solution samples to various concentrations, then measuring the ultrasonic wave propagation velocity at two solution temperatures for each sample and constructing a matrix-type data table based on the results. During treatment, it is preferable to measure the solution temperature and ultrasonic wave propagation velocity in real time and to control the concentration based on these measurements. In cases where an electrolytic solution having a sulfuric acid concentration of 250 g/L or more is used in desmutting treatment, controlling the concentration by the foregoing method is especially preferred.

The various electrolytic solutions used in electrolytic graining treatment and anodizing treatment preferably have a copper concentration of not more than 100 ppm. If the copper concentration is too high, copper will deposit onto the aluminum plate when the production line stops. When the line starts moving again, the deposited copper may be transferred to the path rollers, which can cause uneven treatment.

[Presensitized Plate]

A presensitized plate can be obtained by providing an image recording layer on the lithographic printing plate support obtained according to this invention. A photosensitive composition may be used to form the image recording layer.

Preferred examples of photosensitive compositions that may be used in the invention include thermal positive-type photosensitive compositions containing an alkali-soluble polymeric compound and a photothermal conversion substance (such compositions and the image recording layers obtained using these compositions are referred to below as “thermal positive-type” compositions and image recording layers), thermal negative-type photosensitive compositions containing a curable compound and a photothermal conversion substance (such compositions and the image recording layers obtained therefrom are similarly referred to below as “thermal negative-type” compositions and image recording layers), photopolymerizable photosensitive compositions (referred to below as “photopolymer-type” compositions), negative-type photosensitive compositions containing a diazo resin or a photo-crosslinkable resin (referred to below as “conventional negative-type” compositions), positive-type photosensitive compositions containing a quinonediazide compound (referred to below as “conventional positive-type” compositions), and photosensitive compositions that do not require a special development step (referred to below as “non-treatment type” compositions). These preferred photosensitive compositions are described below.

<Thermal Positive-Type Photosensitive Compositions>

<Photosensitive Layer>

Thermal positive-type photosensitive compositions contain an alkali-soluble polymeric compound and a photothermal conversion substance. In a thermal positive-type image recording layer, the photothermal conversion substance converts light energy such as from an infrared laser into heat, which efficiently eliminates interactions that lower the alkali solubility of the alkali-soluble polymeric compound.

The alkali-soluble polymeric compound may be, for example, a resin having an acidic group on the molecule, or a mixture of two or more such resins. Resins having an acidic group, such as a phenolic hydroxy group, a sulfonamide group (—SO₂NH—R, wherein R is a hydrocarbon group) or an active imino group (—SO₂NHCOR, —SO₂NHSO₂R or —CONHSO₂R, wherein R is as defined above), are especially preferred on account of their solubility in alkaline developers.

For an excellent image formability with exposure to light from an infrared laser, for example, resins having phenolic hydroxy groups are especially desirable. Preferred examples of such resins include novolak resins such as phenol-formaldehyde resins, m-cresol-formaldehyde resins, p-cresol-formaldehyde resins, cresol-formaldehyde resins in which the cresol is a mixture of m-cresol and p-cresol, and phenol/cresol mixture-formaldehyde resins (phenol-cresol-formaldehyde co-condensation resins) in which the cresol is m-cresol, p-cresol or a mixture of m- and p-cresol.

Additional preferred examples include the polymeric compounds described in JP 2001-305722 A (especially paragraphs [0023] to [0042]), the polymeric compounds having recurring units of general formula (1) described in JP 2001-215693 A, and the polymeric compounds described in JP 2002-311570 A (especially paragraph [0107]).

To provide a good recording sensitivity, the photothermal conversion substance is preferably a pigment or dye that absorbs light in the infrared wavelength range of 700 to 1200 nm. Illustrative examples of suitable dyes include azo dyes, metal complex azo dyes, pyrazolone azo dyes, naphthoquinone dyes, anthraquinone dyes, phthalocyanine dyes, carbonium dyes, quinoneimine dyes, methine dyes, cyanine dyes, squarylium dyes, pyrylium salts and metal-thiolate complexes (e.g., nickel-thiolate complexes). Of these, cyanine dyes are preferred. The cyanine dyes of general formula (I) described in JP 2001-305722 A are especially preferred.

A dissolution inhibitor may be included in thermal positive-type photosensitive compositions. Preferred examples of dissolution inhibitors include those described in paragraphs [0053] to [0055] of JP 2001-305722 A.

The thermal positive-type photosensitive compositions preferably also include, as additives, sensitivity regulators, print-out agents for obtaining a visible image immediately after heating from light exposure, compounds such as dyes as image colorants, and surfactants for enhancing coatability and treatment stability. Compounds as described in paragraphs [0056] to [0060] of JP 2001-305722 A are preferred additives.

Use of the photosensitive compositions described in detail in JP 2001-305722 A is desirable in consideration of additional advantages as well.

The thermal positive-type image recording layer is not limited to a single layer, but may have a two-layer construction.

Preferred examples of image recording layers with a two-layer construction (also referred to as “multilayer-type image recording layers”) include those comprising a bottom layer (“layer A”) of excellent press life and solvent resistance which is provided on the side close to the support and a layer (“layer B”) having an excellent positive-image formability which is provided on layer A. This type of image recording layer has a high sensitivity and can provide a broad development latitude. Layer B generally contains a photothermal conversion substance. Preferred examples of the photothermal conversion substance include the dyes mentioned above.

Preferred examples of resins that may be used in layer A include polymers that contain as a copolymerizable component a monomer having a sulfonamide group, an active imino group or a phenolic hydroxy group; such polymers have an excellent press life and solvent resistance. Preferred examples of resins that may be used in layer B include phenolic hydroxy group-bearing resins which are soluble in aqueous alkali solutions.

In addition to the above resins, various additives may be included, if necessary, in the compositions used to form layers A and B. For example, suitable use can be made of the additives described in paragraphs [0062] to [0085] of JP 2002-323769 A. The additives described in paragraphs [0053] to [0060] of JP 2001-305722 A as above are also suitable for use.

The components and proportions thereof in each of layers A and B are preferably selected as described in JP 11-218914 A.

<Intermediate Layer>

It is advantageous to provide an intermediate layer between the thermal positive-type image recording layer and the support. Preferred examples of ingredients that may be used in the intermediate layer include the various organic compounds described in paragraph [0068] of JP 2001-305722 A.

<Others>

The methods described in detail in JP 2001-305722 A may be used to form a thermal positive-type image recording layer and to make a printing plate having such a layer.

<Thermal Negative-Type Photosensitive Compositions>

Thermal negative-type photosensitive compositions contain a curable compound and a photothermal conversion substance. A thermal negative-type image recording layer is a negative-type photosensitive layer in which areas irradiated with light such as from an infrared laser cure to form image areas.

<Polymerizable Layer>

An example of a preferred thermal negative-type image recording layer is a polymerizable image recording layer (polymerizable layer). The polymerizable layer contains a photothermal conversion substance, a radical generator, a radical-polymerizable compound which is a curable compound, and a binder polymer. In the polymerizable layer, the photothermal conversion substance converts absorbed infrared light into heat, and the heat decomposes the radical generator, thereby generating radicals. The radicals then trigger the chain polymerization and curing of the radical-polymerizable compound.

Illustrative examples of the photothermal conversion substance include photothermal conversion substances that may be used in the above-described thermal positive-type photosensitive compositions. Specific examples of cyanine dyes, which are especially preferred, include those described in paragraphs [0017] to [0019] of JP 2001-133969 A.

Preferred radical generators include onium salts. The onium salts described in paragraphs [0030] to [0033] of JP 2001-133969 A are especially preferred.

Exemplary radical-polymerizable compounds include compounds having one, and preferably two or more, terminal ethylenically unsaturated bonds.

Preferred binder polymers include linear organic polymers. Linear organic polymers which are soluble or swellable in water or a weakly alkaline aqueous solution are preferred. Of these, (meth)acrylic resins having unsaturated groups (e.g., allyl, acryloyl) or benzyl groups and carboxy groups in side chains are especially preferred because they provide an excellent balance of film strength, sensitivity and developability.

Radical-polymerizable compounds and binder polymers that may be used include those described specifically in paragraphs [0036] to [0060] of JP 2001-133969 A.

Thermal negative-type photosensitive compositions preferably contain additives described in paragraphs [0061] to [0068] of JP 2001-133969 A (e.g., surfactants for enhancing coatability).

The methods described in detail in JP 2001-133969 A may be used to form a polymerizable layer and to make a printing plate having such a layer.

<Acid-Crosslinkable Layer>

Another preferred thermal negative-type image recording layer is an acid-crosslinkable image recording layer (abbreviated hereinafter as “acid-crosslinkable layer”). An acid-crosslinkable layer contains a photothermal conversion substance, a thermal acid generator, a compound (crosslinker) which is curable and which crosslinks under the influence of an acid, and an alkali-soluble polymeric compound which is capable of reacting with the crosslinker in the presence of an acid. In an acid-crosslinkable layer, the photothermal conversion substance converts absorbed infrared light into heat. The heat decomposes the thermal acid generator, thereby generating an acid which causes the crosslinker and the alkali-soluble polymeric compound to react and cure.

The photothermal conversion substance is exemplified by the same substances as can be used in the polymerizable layer.

Exemplary thermal acid generators include photoinitiators for photopolymerization, dye photochromogenic substances, and heat-decomposable compounds such as acid generators which are used in microresists and the like.

Exemplary crosslinkers include hydroxymethyl- or alkoxymethyl-substituted aromatic compounds, compounds having N-hydroxymethyl, N-alkoxymethyl or N-acyloxymethyl groups, and epoxy compounds.

Exemplary alkali-soluble polymeric compounds include novolak resins and polymers having hydroxyaryl groups in side chains.

<Photopolymer-Type Photosensitive Compositions>

Photopolymer-type photosensitive compositions contain an addition-polymerizable compound, a photopolymerization initiator and a polymer binder.

Preferred addition-polymerizable compounds include compounds containing an ethylenically unsaturated bond which are addition-polymerizable. Ethylenically unsaturated bond-containing compounds are compounds which have a terminal ethylenically unsaturated bond. Such compounds may have the chemical form of a monomer, a prepolymer, or a mixture thereof. The monomers are exemplified by esters of unsaturated carboxylic acids (e.g., acrylic acid, methacrylic acid, itaconic acid, maleic acid) and aliphatic polyols, and amides of unsaturated carboxylic acids and aliphatic polyamines.

Preferred addition-polymerizable compounds include also urethane-type addition-polymerizable compounds.

The photopolymerization initiator may be any of various photopolymerization initiators or a system of two or more photopolymerization initiators (photoinitiation system) which is suitably selected according to the wavelength of the light source to be used. Preferred examples include the initiation systems described in paragraphs [0021] to [0023] of JP 2001-22079 A.

The polymer binder, inasmuch as it must function as a film-forming agent for the photopolymerizable photosensitive composition and, at the same time, must allow the image recording layer to dissolve in an alkaline developer, should be an organic polymer which is soluble or swellable in an alkaline aqueous solution. Preferred examples of such organic polymers include those described in paragraphs [0036] to [0063] of JP 2001-22079 A.

It is preferable for the photopolymer-type photosensitive composition to include the additives described in paragraphs [0079] to [0088] of JP 2001-22079 A (e.g., surfactants for improving coatability, colorants, plasticizers, thermal polymerization inhibitors).

To prevent oxygen from inhibiting polymerization, it is preferable to provide an oxygen-blocking protective layer on top of the photopolymer-type image recording layer. The polymer present in the oxygen-blocking protective layer is exemplified by polyvinyl alcohols and copolymers thereof.

It is also desirable to provide an intermediate layer or a bonding layer like those described in paragraphs [0124] to [0165] of JP 2001-228608 A.

<Conventional Negative-Type Photosensitive Compositions>

Conventional negative-type photosensitive compositions contain a diazo resin or a photo-crosslinkable resin. Among others, photosensitive compositions which contain a diazo resin and an alkali-soluble or swellable polymeric compound (binder) are preferred.

The diazo resin is exemplified by condensation products of an aromatic diazonium salt with an active carbonyl group-bearing compound such as formaldehyde; and organic solvent-soluble diazo resin inorganic salts which are the reaction products of a hexafluorophosphate or tetrafluoroborate with the condensation product of a p-diazophenylamine and formaldehyde. The high-molecular-weight diazo compounds described in JP 59-78340 A, in which the content of hexamer and larger polymers is at least 20 mol %, are especially preferred.

Exemplary binders include copolymers containing acrylic acid, methacrylic acid, crotonic acid or maleic acid as an essential component. Specific examples include the multi-component copolymers of such monomers as 2-hydroxyethyl (meth)acrylate, (meth)acrylonitrile and (meth)acrylic acid described in JP 50-118802 A, and the multi-component copolymers of alkyl acrylates, (meth)acrylonitrile and unsaturated carboxylic acids described in JP 56-4144 A.

Conventional negative-type photosensitive compositions preferably contain as additives the print-out agents, dyes, plasticizers for imparting flexibility and wear resistance to the applied coat, development promoters and other compounds, and the surfactants for enhancing coatability described in paragraphs [0014] to [0015] of JP 7-281425 A.

Below the conventional negative-type photosensitive layer, it is advantageous to provide the intermediate layer which contains a polymeric compound having an acid group-bearing component and an onium group-bearing component described in JP 2000-105462 A.

<Conventional Positive-Type Photosensitive Compositions>

Conventional positive-type photosensitive compositions contain a quinonediazide compound. Photosensitive compositions containing an o-quinonediazide compound and an alkali-soluble polymeric compound are especially preferred.

Illustrative examples of the o-quinonediazide compound include esters of 1,2-naphthoquinone-2-diazido-5-sulfonylchloride and a phenol-formaldehyde resin or a cresol-formaldehyde resin, and the esters of 1,2-naphthoquinone-2-diazido-5-sulfonylchloride and pyrogallol-acetone resins described in U.S. Pat. No. 3,635,709.

Illustrative examples of the alkali-soluble polymeric compound include phenol-formaldehyde resins, cresol-formaldehyde resins, phenol-cresol-formaldehyde co-condensation resins, polyhydroxystyrene, N-(4-hydroxyphenyl)methacrylamide copolymers, the carboxy group-bearing polymers described in JP 7-36184 A, the phenolic hydroxy group-bearing acrylic resins described in JP 51-34711 A, the sulfonamide group-bearing acrylic resins described in JP 2-866 A, and urethane resins.

Conventional positive-type photosensitive compositions preferably contain as additives the compounds such as sensitivity regulators, print-out agents and dyes described in paragraphs [0024] to [0027] of JP 7-92660 A, and surfactants for enhancing coatability such as those described in paragraph [0031] of JP 7-92660 A.

Below the conventional positive-type photosensitive layer, it is advantageous to provide an intermediate layer similar to the intermediate layer which is preferably used in the case of the conventional negative-type photosensitive layer as above.

<Non-Treatment Type Photosensitive Compositions>

Illustrative examples of non-treatment type photosensitive compositions include thermoplastic polymer powder-based photosensitive compositions, microcapsule-based photosensitive compositions, and sulfonic acid-generating polymer-containing photosensitive compositions. All of these are heat-sensitive compositions containing a photothermal conversion substance. The photothermal conversion substance is preferably a dye of the same type as those which can be used in the above-described thermal positive-type photosensitive compositions.

Thermoplastic polymer powder-based photosensitive compositions are composed of a hydrophobic, heat-meltable finely divided polymer dispersed in a hydrophilic polymer matrix. In the thermoplastic polymer powder-based image recording layer, the fine particles of hydrophobic polymer melt under the influence of heat generated by light exposure and mutually fuse, forming hydrophobic regions which serve as the image areas.

The finely divided polymer is preferably one in which the particles melt and fuse together under the influence of heat. A finely divided polymer in which the individual particles have a hydrophilic surface, enabling them to disperse in a hydrophilic component such as dampening water, is especially preferred. Preferred examples include the finely divided thermoplastic polymers described in Research Disclosure No. 33303 (January 1992), JP 9-123387 A, JP 9-131850 A, JP 9-171249 A, JP 9-171250 A and EP 931,647. Of these, polystyrene and polymethyl methacrylate are preferred. Illustrative examples of finely divided polymers having a hydrophilic surface include those in which the polymer itself is hydrophilic, and those in which the surfaces of the polymer particles have been rendered hydrophilic by adsorbing thereon a hydrophilic compound such as polyvinyl alcohol or polyethylene glycol.

The finely divided polymer preferably has reactive functional groups.

Preferred examples of microcapsule-type photosensitive compositions include those described in JP 2000-118160 A, and compositions like those described in JP 2001-277740 A in which a compound having thermally reactive functional groups is enclosed within microcapsules.

Illustrative examples of sulfonic acid-generating polymers that may be used in sulfonic acid generating polymer-containing photosensitive compositions include the polymers described in JP 10-282672 A that have sulfonate ester groups, disulfone groups or sec- or tert-sulfonamide groups in side chains.

Including a hydrophilic resin in a non-treatment type photosensitive composition not only provides a good on-press developability, it also enhances the film strength of the photosensitive layer itself. Preferred hydrophilic resins include resins having hydrophilic groups such as hydroxy, carboxy, hydroxyethyl, hydroxypropyl, amino, aminoethyl, aminopropyl or carboxymethyl groups; and hydrophilic binder resins of a sol-gel conversion-type.

A non-treatment type image recording layer can be developed on the press, and thus does not require a special development step. The methods described in detail in JP 2002-178655 A may be used as the method of forming a non-treatment type image recording layer and the associated plate making and printing methods.

<Back Coat>

If necessary, the presensitized plate of the invention obtained by providing any of the various above image recording layers on a lithographic printing plate support obtained according to the invention may be provided on the rear side with a coat composed of an organic polymeric compound to prevent scuffing of the image recording layer when the presensitized plates are stacked on top of each other.

[Lithographic Plate Making Process]

The presensitized plate prepared using a lithographic printing plate support obtainable according to the invention is then subjected to any of various treatment methods depending on the type of the image recording layer, thereby obtaining a lithographic printing plate.

Illustrative examples of sources of actinic light that may be used for imagewise exposure include mercury vapor lamps, metal halide lamps, xenon lamps and chemical lamps. Examples of laser beams that may be used include those from helium-neon lasers (He—Ne lasers), argon lasers, krypton lasers, helium-cadmium lasers, KrF excimer lasers, semiconductor lasers, YAG lasers and YAG-SHG lasers.

Following the above exposure, if the image recording layer is of a thermal positive type, thermal negative type, conventional negative type, conventional positive type or photopolymer type, it is preferable to carry out development using a developer in order to prepare a lithographic printing plate.

The developer is preferably an alkaline developer, and more preferably an alkaline aqueous solution which is substantially free of organic solvent.

Developers which are substantially free of alkali metal silicates are also preferred. One example of a suitable method of development using a developer which is substantially free of alkali metal silicates is the method described in detail in JP 11-109637 A.

Developers which contain an alkali metal silicate may also be used.

### EXAMPLES

Hereinafter, the present invention is described in detail by way of examples. However, the present invention is not limited thereto.

### Examples of the First Aspect of the Invention

1-1. Manufacture of Lithographic Printing Plate Supports

### Examples 1-1 to 1-41 and 2-1 to 2-43

In each of Examples 1-1 to 1-41 and 2-1 to 2-43, a melt was prepared from an aluminum alloy of the composition shown in Table 1 below (with the balance being aluminum and inadvertent impurities; units are in wt %). The melt was subjected to molten metal treatment and filtration, then was cast into a 500 mm thick, 1,200 mm wide ingot by a direct chill casting process. The ingot was scalped with a scalping machine, removing an average of 10 mm of material from the surface, then was soaked and held at 550° C. for about 5 hours. When the temperature had fallen to 400° C., the ingot was rolled on a hot rolling mill to a thickness of 2.7 mm. In addition, heat treatment was carried out at 500° C. in a continuous annealing furnace, following which cold rolling was carried out to a final thickness of 0.3 mm and a width of 1,060 mm, thereby giving an aluminum plate.

TABLE 1

| Aluminum | | | | | | | | |
|---|---|---|---|---|---|---|---|---|
| plate | Si | Fe | Cu | Mn | Mg | Cr | Zn | Ti |
| 1-1 | 0.080 | 0.300 | 0.000 | 0.001 | 0.000 | 0.001 | 0.003 | 0.021 |
| 1-2 | 0.080 | 0.300 | 0.001 | 0.001 | 0.000 | 0.001 | 0.003 | 0.021 |
| 1-3 | 0.076 | 0.270 | 0.023 | 0.001 | 0.000 | 0.001 | 0.003 | 0.021 |
| 1-4 | 0.076 | 0.270 | 0.035 | 0.001 | 0.000 | 0.001 | 0.003 | 0.021 |
| 1-5 | 0.076 | 0.270 | 0.050 | 0.001 | 0.000 | 0.001 | 0.003 | 0.021 |
| 1-6 | 0.278 | 0.413 | 0.201 | 0.892 | 0.783 | 0.022 | 0.122 | 0.034 |

The aluminum plate was then subjected to the following treatment.

<Surface Treatment>

Surface treatment was effected by consecutively carrying out the following treatment operations (a) to (k) on the aluminum plate.

(a) Mechanical Graining Treatment

Mechanical graining was carried out with rotating roller-type nylon brushes while supplying to the surface of the aluminum plate from a spray line an abrasive slurry composed of a suspension (specific gravity, 1.12) in water of an abrasive obtained by crushing pumice and classifying the crushed pumice to an average particle size of 30 μm.

The abrasive had a Mohs hardness of 5 and contained 73 wt % of SiO₂, 14 wt % of Al₂O₃, 1.2 wt % of Fe₂O₃, 1.34 wt % of CaO, 0.3 wt % of MgO, 2.6 wt % of K₂O, and 2.7 wt % of Na₂O.

The nylon brushes were No. 3 brushes in which the bristles were made of nylon 6.10 and had a bristle length (before implantation) of 50 mm and a bristle diameter of 0.295 mm. Each brush was constructed of a 300 mm diameter stainless steel cylinder in which holes had been formed and bristles densely set. Three rotating brushes were used.

Two support rollers (200 mm diameter) were provided below each nylon brush and spaced 300 mm apart. The brushes were made to rotate in the same direction as the direction in which the aluminum plate was moved.

The degree to which the nylon brushes pushed against the plate was adjusted by regulating the load on the motor driving the rotation of the brushes.

This mechanical graining treatment was carried out while suitably adjusting such parameters as the flow rate of the abrasive, the rotational speed of the brushes, and the movement speed of the aluminum plate so as to give the aluminum plate following the treatment a mean surface roughness Rₐ of 0.25 to 0.40 μm. Table 2 gives the mean surface roughness Rₐ of the aluminum plate following mechanical graining treatment.

The mean surface roughness Rₐ of the aluminum plate was obtained by carrying out two-dimensional roughness measurement with a stylus-type roughness tester (Surfcom 575, available from Tokyo Seimitsu Co., Ltd.), measuring the mean surface roughness as defined by ISO 4287 five times, and determining the average of the five values.

The conditions used in measuring the two-dimensional roughness were as follows: cutoff value, 0.8 mm; slope correction, FLAT-ML; measurement length, 3 mm; longitudinal magnification, 10,000×; scan rate, 0.3 mm/s; stylus tip diameter, 2 μm.

(b) Etching with Aqueous Alkali Solution (First Etching Treatment)

Etching was carried out by using a spray line to spray the aluminum plate with an aqueous solution having a sodium hydroxide concentration of 27 wt %, an aluminum ion concentration of 6.5 wt %, and a temperature of 70° C. Table 2 shows the amount of material removed by etching from the side of the aluminum plate to be subsequently subjected to the first electrochemical graining treatment.

Etching solution remaining on the aluminum plate was removed with nip rollers, following which the plate was rinsed with water. Water remaining on the plate was then removed with nip rollers. Rinsing treatment was carried out by rinsing with an apparatus that uses a free-falling curtain of water, and also by rinsing for 5 seconds with a spray line having, at 80 mm intervals, a plurality of spray tips which discharge fan-like sprays of water.

(c) Desmutting with Acidic Aqueous Solution (First Desmutting Treatment)

Next, desmutting treatment was carried out. The acidic aqueous solution used in desmutting treatment was wastewater generated in the subsequently described first electrochemical graining step.

Desmutting treatment was carried out by spraying the plate with the acidic aqueous solution (solution temperature, 35° C.) from a spray line for 5 seconds.

Solution remaining on the plate was subsequently removed with nip rollers.

(d) First Electrochemical Graining Treatment

The aluminum plate was then subjected to the first electrochemical graining treatment using an electrolytic solution having the nitric acid concentration, aluminum ion concentration and solution temperature shown in Table 2. The aluminum ion concentration was adjusted by adding aluminum nitrate. The aluminum ion concentration was 70 mg/L.

Electrochemical graining treatment was carried out using a power supply that controlled the current by pulse width modulation using an IBGT device, and thereby generated an alternating current of a given waveform.

A carbon electrode was used as the counterelectrode, and an iridium oxide electrode was used as the auxiliary anode. Two radial electrolytic cells like that shown in FIG. 4 were used.

The waveform and frequency of the alternating current generated, and the time TP until the current reached a peak from zero are shown in Table 2. The duty ratio was 0.5. Table 2 also shows the current density (peak value of alternating current) and the total amount of electricity during the anodic reaction on the aluminum plate, as well as the current ratio r in the main electrolytic cells. The current ratio r was adjusted by the amount of current diverted to the auxiliary anode.

The aluminum plate was fed to the main electrolytic cell at a relative velocity with respect to the electrolytic solution in the main electrolytic cell of 1 to 2 m/s, or an average speed of 1.5 m/s.

The solution was then removed from the plate with nip rollers. In addition, rinsing treatment was carried out using a spray line of the same construction as that used in the rinsing treatment in step (b) above, following which water remaining on the plate was removed with nip rollers.

(e) Etching with Aqueous Alkali Solution (Second Etching Treatment)

Etching was carried out by using a spray line to spray the aluminum plate with an aqueous solution having a sodium hydroxide concentration of 27 wt %, an aluminum ion concentration of 5.5 wt %, and a temperature of 65° C. Table 2 shows the amount of material removed by etching from the side of the aluminum plate to be subsequently subjected to the second electrochemical graining treatment.

The solution was then removed from the plate with nip rollers. In addition, rinsing treatment was carried out using a spray line of the same construction as that used in the rinsing treatment in step (b) above, following which water remaining on the plate was removed with nip rollers.

(f) Desmutting with Acidic Aqueous Solution (Second Desmutting Treatment)

Next, desmutting was carried out. The acidic aqueous solution used for this purpose was prepared by dissolving 1.5 g/L of aluminum ions in an aqueous solution having a sulfuric acid concentration of 300 g/L. Desmutting treatment was carried out by spraying the aluminum plate with this acidic aqueous solution (solution temperature, 60° C.) from a spray line for 10 seconds.

The solution was then removed from the plate with nip rollers. In addition, rinsing treatment was carried out using a spray line of the same construction as that used in the rinsing treatment in step (b) above, following which water remaining on the plate was removed with nip rollers.

(g) Second Electrochemical Graining Treatment

Use was made of an electrolytic solution having the hydrochloric acid concentration and the aluminum ion concentration shown in Table 2 and having a solution temperature of 35° C. Aluminum chloride was used to adjust the aluminum ion concentration.

Electrochemical graining treatment was carried out using a power supply that controlled the current by pulse width modulation using an IBGT device, and thereby generated an alternating current of a given waveform.

A carbon electrode was used as the counterelectrode, and an iridium oxide electrode was used as the auxiliary anode. One radial electrolytic cell like that shown in FIG. 4 was used.

The alternating current generated had a trapezoidal waveform. The frequency was 60 Hz, the time TP until the current reached a peak from zero was 0.8 ms, and the duty ratio was 0.5. Table 2 shows the current density (peak value of alternating current) during the anodic reaction on the aluminum plate; the amount of electricity was 63 C/dm², and the current ratio was 0.95. The current ratio was adjusted by the amount of current diverted to the auxiliary anode. The aluminum plate was fed to the main electrolytic cell at a relative velocity with respect to the electrolytic solution in the main electrolytic cell of 1 to 2 m/s, or an average speed of 1.5 m/s.

The solution was then removed from the plate with nip rollers. In addition, rinsing treatment was carried out using a spray line of the same construction as that used in the rinsing treatment in step (b) above, following which water remaining on the plate was removed with nip rollers.

(h) Etching with Aqueous Alkali Solution (Third Etching Treatment)

Etching was carried out by using a spray line to spray the aluminum plate with an aqueous solution having a sodium hydroxide concentration of 5 wt %, an aluminum ion concentration of 0.5 wt %, and a temperature of 35° C. Table 2 shows the amount of material removed by etching from the side of the aluminum plate that has been subjected to the second electrochemical graining treatment.

The solution was then removed from the plate with nip rollers. In addition, rinsing treatment was carried out using a spray line of the same construction as that used in the rinsing treatment in step (b) above, following which water remaining on the plate was removed with nip rollers.

(i) Desmutting with Acidic Aqueous Solution (Third Desmutting Treatment)

Desmutting was then carried out. The acidic aqueous solution used in desmutting treatment was the wastewater generated in the anodizing treatment step. This wastewater was an aqueous solution of 170 g/L sulfuric acid that contained 5 g/L of aluminum ions. Desmutting treatment was carried out by spraying the aluminum plate with this acidic aqueous solution (solution temperature, 60° C.) from a spray line for 5 seconds. Solution remaining on the plate was then removed with nip rollers.

(j) Anodizing Treatment

Next, anodizing treatment was carried out using an anodizing apparatus.

A solution prepared by dissolving aluminum sulfate in an aqueous solution of sulfuric acid (170 g/L) to an aluminum ion concentration of 5 g/L was used as the electrolytic solution (temperature, 33° C.). Anodizing treatment was carried out in such a way that the average current density during the anodic reaction on the aluminum plate was 10 A/dm². The weight of the anodized layer ultimately obtained was 2.4 g/m².

The solution was then removed from the plate with nip rollers. In addition, rinsing treatment was carried out using a spray line of the same construction as that used in the rinsing treatment in step (b) above, following which water remaining on the plate was removed with nip rollers.

(k) Hydrophilizing Treatment 1

The aluminum plate was immersed for 10 seconds in an aqueous solution containing 1.0 wt % of No. 3 sodium silicate (solution temperature, 20° C.). The aluminum plate surface had a silicon content, as measured with a fluorescent x-ray analyzer, of 3.5 mg/m².

The solution was then removed from the plate with nip rollers. In addition, rinsing treatment was carried out using a spray line of the same construction as that used in the rinsing treatment in step (b) above, after which water remaining on the plate was removed with nip rollers. This was followed by drying in which 90° C. air was blown across the plate for 10 seconds, thereby giving a support for a lithographic printing plate.

### Examples 1-42 to 1-44 and 2-44 to 2-47

In Examples 1-42 to 1-44 and 2-44 to 2-47, aside from carrying out treatment (1) described below instead of the above treatment (k), supports for lithographic printing plates were obtained by carrying out the surface treatment in the same way as in Examples 1-1 to 1-41 and 2-1 to 2-43.

(1) Hydrophilizing Treatment 2

The aluminum plate was immersed for 8 seconds in an aqueous solution containing 4.0 wt % of No. 1 sodium silicate (solution temperature, 22° C.). The aluminum plate surface had a silicon content, as measured with a fluorescent x-ray analyzer, of 5.3 mg/m².

The solution was then removed from the plate with nip rollers. In addition, rinsing treatment was carried out using a spray line of the same construction as that used in the rinsing treatment in step (b) above, after which water remaining on the plate was removed with nip rollers. This was followed by drying in which 90° C. air was blown across the plate for 10 seconds, thereby giving a support for a lithographic printing plate.

### Comparative Example 1

In Comparative Example 1, a support for a lithographic printing plate was obtained by carrying out the surface treatment in the same way as in Examples 1-1 to 1-41 and 2-1 to 2-43 except that the above step (a) was not carried out.

1-2. Surface Examination of Lithographic Printing Plate Supports

The surface of each of the lithographic printing plate supports obtained in above Examples 1-1 to 1-44 and 2-1 to 2-47 was examined under a scanning electron microscope (JSM-5500, manufactured by JEOL Ltd.; the same applies below) at a magnification of 50,000×, whereupon fine asperities having an average opening diameter of 0.05 to 0.3 μm were found to have uniformly and densely formed.

In addition, examination under a scanning electron microscope at a magnification of 2,000× showed that asperities (honeycombed pits) having an average opening diameter of 1 to 6 μm were uniformly formed on the surfaces of the lithographic printing plate supports in Examples 1-1 to 1-44 and 2-1 to 2-47.

Moreover, examination of each lithographic printing plate support at a 30° inclination revealed that large asperities (undulations) having a pitch of 5 to 20 μm had been formed.

1-3. Measurement of Mean Surface Roughness Rₐ of Aluminum Plates

The mean surface roughness Rₐ of the aluminum plate was measured following the second etching treatment and following anodizing treatment. The results are shown in Table 2. In Examples 1-1 to 1-44 and 2-1 to 2-47, the mean surface roughness Rₐ fell in a range of 0.41 to 0.60, whereas in Comparative Example 1, the mean surface roughness Rₐ was small and inadequate.

The mean surface roughness Rₐ was measured by the same method as that described above in (a) Mechanical Graining Treatment.

1-4. Fabrication of Presensitized Plates

Presensitized plates for lithographic printing were fabricated by providing a thermal positive-type image recording layer in the manner described below on each of the lithographic printing plate supports obtained above.

First, an undercoating solution of the composition indicated below was applied onto the respective lithographic printing plate supports obtained in Examples 1-1 to 1-41, 2-41 to 2-43 and Comparative Example 1, and dried at 80° C. for 15 seconds, thereby forming an undercoat. The weight of the undercoat after drying was 15 mg/m².

<Composition of Undercoating Solution>

| | |
|---|---|
| Polymeric compound of the following formula | 0.3 g |

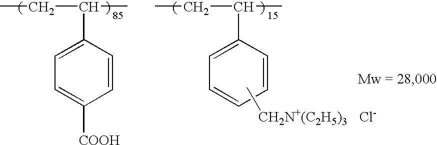

| | |
|---|---|
| Methanol | 100 g |
| Water | 1 g |

In addition, an image recording layer coating solution A of the composition indicated below was prepared. This solution was applied onto the undercoated lithographic printing plate support and dried to obtain a dried coating weight (heat-sensitive layer coating weight) of 1.8 g/m², thus forming a thermal positive-type image recording layer 1 and giving a presensitized plate.

<Composition of Image Recording Layer Coating Solution A>

| | |
|---|---|
| Novolak resin (m-cresol/p-cresol = 60/40; weight-average | 0.90 g |
| molecular weight, 7,000; unreacted | |
| cresol content, 0.5 wt %) | |
| Ethyl methacrylate/isobutyl methacrylate/methacrylic | 0.10 g |
| acid copolymer (molar ratio: 35/35/30) | |
| Cyanine Dye A of the following formula | 0.1 g |
| 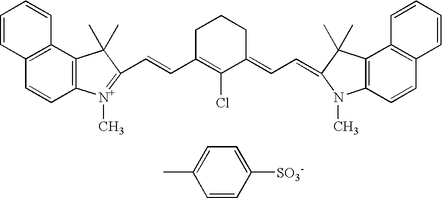 | |
| Tetrahydrophthalic anhydride | 0.05 g |
| p-Toluenesulfonic acid | 0.002 g |
| Dye obtained by changing counterion in Ethyl Violet to | 0.02 g |
| 6-hydroxy-β-naphthalenesulfonic acid | |
| Fluorochemical surfactant (Megaface E-780F, available | 0.0045 g |
| from Dainippon Ink and Chemicals, Inc.; solids content, | (solids) |
| 30 wt %) | |
| Fluorochemical surfactant (Megaface F-781F, available | 0.035 g |
| from Dainippon Ink and Chemicals, Inc.; solids content, | |
| 100 wt %) | |
| Methyl ethyl ketone | 12 g |

Alternatively, first an undercoating solution of the composition indicated below was applied onto the respective lithographic printing plate supports obtained in Examples 1-42 to 1-44 and 2-44 to 2-47, and dried at 80° C. for 15 seconds, thereby forming an undercoat. The weight of the undercoat after drying was 15 mg/m².

<Composition of Undercoating Solution>

| | |
|---|---|
| Polymeric compound of the following formula | 0.3 g |

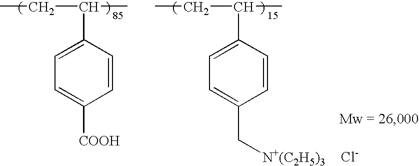

| | |
|---|---|
| Methanol | 100 g |
| Water | 1 g |

Next, an image recording layer coating solution B1 of the composition indicated below was applied onto the undercoat with a wire bar and dried at 140° C. for 50 seconds to a dried coating weight of 0.85 g/m².

An image recording layer coating solution B2 of the composition indicated below was subsequently applied with a wire bar and dried at 140° C. for 1 minute to a dried coating weight of 0.25 g/m², thus forming a multilayer-type thermal positive-type image recording layer 2 and obtaining a presensitized plate.

<Image Recording Layer Coating Solution B1>

| | |
|---|---|
| N-(4-Aminosulfonylphenyl) methacrylamide/acrylonitrile/ | 1.920 g |
| methyl methacrylate copolymer (molar ratio: 36/34/30; | |
| weight-average molecular weight, 50,000) | |
| m,p-Cresol novolak (m-cresol/p-cresol ratio, 6/4; | 0.213 g |
| weight-average molecular weight, 4,000) | |
| Cyanine Dye B of the following formula | 0.032 g |
| 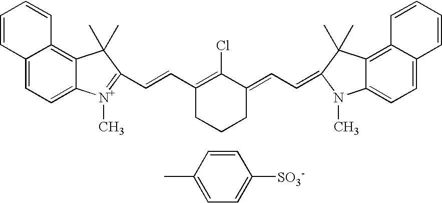 | |
| p-Toluenesulfonic acid | 0.008 g |
| Tetrahydrophthalic anhydride | 0.19 g |
| Bis (p-hydroxyphenyl) sulfone | 0.126 g |
| 2-Methoxy-4-(N-phenylamino)benzenediazonium | 0.032 g |
| hexafluorophosphate | |
| Dye obtained by changing counterion in | 0.078 g |
| Victoria Pure Blue BOH to 1-naphthalenesulfonic acid anion | |
| Fluorochemical surfactant (Megaface F-780, available | 0.020 g |
| from Dainippon Ink and Chemicals, Inc.) | |
| γ-Butyrolactone | 13.18 g |
| Methyl ethyl ketone | 25.41 g |
| 1-Methoxy-2-propanol | 12.97 g |

<Image Recording Layer Coating Solution B2>

| | |
|---|---|
| Phenol/m,p-cresol novolak (phenol/m-cresol/p-cresol = | 0.274 g |
| 5/3/2; weight-average molecular weight, 4,000) | |
| Cyanine Dye B of the above formula | 0.029 g |
| 30% Solution in methyl ethyl ketone of Structural | |
| Polymer C of the following formula | 0.14 g |
| 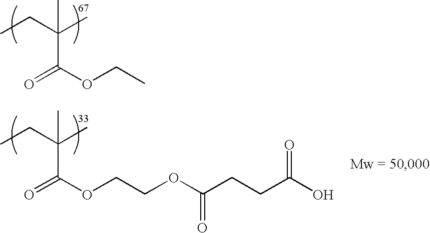 | |
| Quaternary ammonium salt D of the following formula | 0.004 g |
| 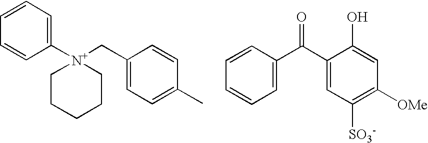 | |
| Sulfonium salt E of the following formula | 0.065 g |
| 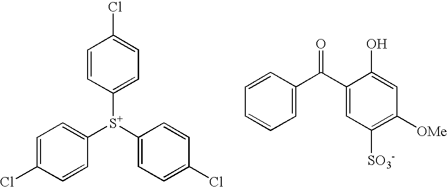 | |
| Fluorochemical surfactant (Megaface F-780, available from | 0.004 g |
| Dainippon Ink and Chemicals, Inc.) | |
| Fluorochemical surfactant (Megaface F-782, available from | 0.020 g |
| Dainippon Ink and Chemicals, Inc.) | |
| Methyl ethyl ketone | 10.39 g |
| 1-Methoxy-2-propanol | 20.98 g |

1-5. Evaluation of Presensitized Plates

The presensitized plates obtained as described above were evaluated as follows for the press life, cleaner resistance (chemical resistance), scumming resistance, and scumming resistance in non-image areas between halftone dots.

(1) Press Life

The presensitized plates were imagewise exposed using a Trendsetter (manufactured by Creo) at a drum rotation speed of 150 rpm and a beam intensity of 10 W.

Next, development was carried out over a period of 20 seconds using a PS Processor 940H (manufactured by Fuji Photo Film Co., Ltd.) charged with an alkaline developer of the composition indicated below while holding the developer at a temperature of 30° C., thereby giving lithographic printing plates. All of the presensitized plates had good sensitivities.

<Alkaline Developer Composition>

| | |
|---|---|
| D-Sorbit | 2.5 wt % |
| Sodium hydroxide | 0.85 wt % |
| Polyethylene glycol lauryl ether (weight- | 0.5 wt % |
| average molecular weight, 1,000) | |
| Water | 96.15 wt % |

The press life was evaluated by printing copies from the resulting printing plate on a Lithrone printing press (manufactured by Komori Corporation) using DIC-GEOS(N) black ink (Dainippon Ink and Chemicals, Inc.) and determining the total number of impressions that were printed until the density of solid images began to noticeably decline on visual inspection.

The results are shown in Table 2. The meanings of the rating symbols used in Table 2 are as follows.

A: 30,000 or more copies

A-B: At least 20,000 but fewer than 30,000 copies

B: At least 10,000 but fewer than 20,000 copies

(2) Cleaner Resistance (Chemical Resistance)

The cleaner resistance was evaluated as in (1) Press life except that, each time 5,000 impressions were printed, a multi-purpose cleaner available from Fuji Photo Film Co., Ltd. was applied onto the surface of the image recording layer and wiped it off with water one minute later. The cleaner resistance was evaluated based on the number of impressions that were printed until the ink concentration (reflection density) was decreased by 0.1 from the time when printing had been started. The cleaner resistance was used as a method for evaluating the press life.

The results are shown in Table 2. The meanings of the rating symbols used in Table 2 are as follows.

A: 10,000 or more copies

A-B: At least 6,000 but fewer than 10,000 copies

B: At least 3,000 but fewer than 6,000 copies

B-C: At least 2,000 but fewer than 3,000 copies

(3) Scumming Resistance

The scumming resistance was evaluated by visually inspecting the blanket for toning after 10,000 impressions had been printed on a Mitsubishi Daiya F2 printing press (Mitsubishi Heavy Industries, Ltd.) with DIC-GEOS (s) Magenta ink (Dainippon Ink and Chemicals, Inc.) using lithographic printing plates obtained in the same way as described above in connection with evaluation of the press life.

The results are shown in Table 2. The meanings of the rating symbols used in Table 2 are as follows.

A: Blanket was substantially free of toning

A-B: Slight toning of the blanket was observed

(4) Scumming Resistance in Non-Image Areas between Halftone Dots

In each case, the lithographic printing plate obtained as described above was mounted on a SOR-M printing press (Heidelberger Druckmaschinen AG), printing was carried out using a 3% aqueous solution of IF102 (Fuji Photo Film Co., Ltd.) as the dampening water and Values (N) black ink (Dainippon Ink and Chemicals, Inc.) as the ink. The amount of dampening water was gradually adjusted downward from the standard water level in the press, and the degree to which filling-in arose in shadow areas (halftone dot ratio, 80%) was visually assessed.

The results are shown in Table 2. The meanings of the rating symbols used in Table 2 are as follows.
A: Substantially no scumming in non-image areas between halftone dots
A-B: Slight scumming was observed in non-image areas between halftone dots

As is apparent from Table 2, the lithographic printing plates obtained using lithographic printing plate supports manufactured according to the inventive method (Examples 1-1 to 1-44 and 2-41 to 2-43) all were excellent in press life, scumming resistance, cleaner resistance, and scumming resistance in non-image areas between halftone dots. In particular, each of the lithographic printing plates obtained in Examples 1-42 to 1-44 and 2-44 to 2-47 which had a large amount of silicon adsorbed on the support surface and was provided with a multilayer-type thermal positive-type image recording layer 2, had especially outstanding scumming resistance in non-image areas between halftone dots.

By contrast, the lithographic printing plate obtained in Comparative Example 1 had a shorter press life and an inferior cleaner resistance.

TABLE 2

| | | | Etching amount | | | | | | | | | | Etching amount | Rₐ after |
|---|---|---|---|---|---|---|---|---|---|---|---|---|---|---|
| | | Rₐ after | in first | First Electrochemical Graining Treatment | | | | | | | | | in second | second |
| | | mechanical | etching | Nitric acid | | | | | | | Current | Am't | etching | etching |
| | Aluminum | graining | treatment | conc. | Al ion conc. | Solution temp. | | | Frequency | Current | density | of electricity | treatment | treatment |
| | plate | (μm) | (g/m²) | (g/l) | (g/l) | (° C.) | Waveform | Tp (msec) | (Hz) | ratio | (A/dm²) | (C/dm²) | (g/m²) | (μm) |
| Example 1-1 | 1-3 | 0.35 | 3 | 10.0 | 4.5 | 35 | trapezoidal | 0.8 | 60 | 0.65 | 50 | 200 | 3 | 0.50 |
| Example 1-2 | 1-3 | 0.35 | 3 | 10.0 | 4.5 | 35 | trapezoidal | 0.8 | 60 | 0.60 | 50 | 200 | 3 | 0.50 |
| Example 1-3 | 1-3 | 0.30 | 3 | 10.0 | 4.5 | 35 | trapezoidal | 0.8 | 60 | 0.60 | 50 | 200 | 3 | 0.45 |
| Example 1-4 | 1-3 | 0.40 | 3 | 10.0 | 4.5 | 35 | trapezoidal | 0.8 | 60 | 0.60 | 50 | 200 | 3 | 0.55 |
| Example 1-5 | 1-3 | 0.35 | 3 | 10.0 | 4.5 | 35 | trapezoidal | 0.8 | 60 | 0.55 | 50 | 200 | 3 | 0.50 |
| Example 1-6 | 1-3 | 0.35 | 3 | 10.0 | 4.5 | 35 | trapezoidal | 0.8 | 60 | 0.50 | 50 | 200 | 3 | 0.55 |
| Example 1-7 | 1-3 | 0.35 | 3 | 10.0 | 4.5 | 35 | sinusoidal | — | 60 | 0.60 | 80 | 230 | 3 | 0.50 |
| Example 1-8 | 1-3 | 0.35 | 3 | 10.0 | 4.5 | 35 | sinusoidal | — | 50 | 0.60 | 80 | 230 | 3 | 0.50 |
| Example 1-9 | 1-3 | 0.35 | 3 | 10.0 | 4.5 | 35 | sinusoidal | — | 60 | 0.60 | 80 | 230 | 3 | 0.50 |
| Example 1-10 | 1-3 | 0.35 | 3 | 10.0 | 4.5 | 35 | trapezoidal | 0.8 | 60 | 0.60 | 50 | 250 | 3 | 0.50 |
| Example 1-11 | 1-3 | 0.35 | 3 | 10.0 | 4.5 | 35 | trapezoidal | 0.8 | 60 | 0.60 | 50 | 180 | 3 | 0.50 |
| Example 1-12 | 1-3 | 0.35 | 3 | 10.0 | 4.5 | 35 | trapezoidal | 0.8 | 60 | 0.60 | 50 | 180 | 3 | 0.50 |
| Example 1-13 | 1-3 | 0.35 | 3 | 10.0 | 4.5 | 35 | trapezoidal | 0.8 | 60 | 0.60 | 50 | 180 | 3 | 0.50 |
| Example 1-14 | 1-3 | 0.35 | 3 | 10.0 | 4.5 | 35 | trapezoidal | 0.8 | 60 | 0.60 | 50 | 180 | 3 | 0.50 |
| Example 1-15 | 1-3 | 0.35 | 3 | 10.0 | 4.5 | 35 | trapezoidal | 0.8 | 60 | 0.60 | 50 | 180 | 3 | 0.50 |
| Example 1-16 | 1-3 | 0.35 | 3 | 10.0 | 4.5 | 35 | trapezoidal | 0.8 | 60 | 0.60 | 50 | 180 | 3 | 0.50 |
| Example 1-17 | 1-3 | 0.35 | 3 | 10.0 | 4.5 | 35 | trapezoidal | 0.8 | 60 | 0.60 | 50 | 180 | 1 | 0.50 |
| Example 1-18 | 1-3 | 0.35 | 3 | 10.0 | 4.5 | 35 | trapezoidal | 0.8 | 60 | 0.60 | 50 | 180 | 2 | 0.50 |
| Example 1-19 | 1-3 | 0.35 | 3 | 10.0 | 4.5 | 35 | trapezoidal | 0.8 | 60 | 0.60 | 50 | 180 | 5 | 0.50 |
| Example 1-20 | 1-3 | 0.35 | 3 | 10.0 | 4.5 | 35 | trapezoidal | 0.8 | 60 | 0.60 | 50 | 180 | 7 | 0.50 |
| Example 1-21 | 1-3 | 0.35 | 1 | 10.0 | 4.5 | 35 | trapezoidal | 0.8 | 60 | 0.60 | 50 | 180 | 3 | 0.50 |
| Example 1-22 | 1-3 | 0.35 | 5 | 10.0 | 4.5 | 35 | trapezoidal | 0.8 | 60 | 0.60 | 50 | 180 | 3 | 0.50 |
| Example 1-23 | 1-3 | 0.35 | 3 | 10.0 | 4.5 | 35 | trapezoidal | 0.8 | 60 | 0.60 | 30 | 180 | 3 | 0.50 |
| Example 1-24 | 1-3 | 0.35 | 3 | 10.0 | 4.5 | 35 | trapezoidal | 0.8 | 60 | 0.60 | 100 | 180 | 3 | 0.50 |
| Example 1-25 | 1-3 | 0.35 | 3 | 10.0 | 4.5 | 35 | trapezoidal | 2.0 | 60 | 0.60 | 50 | 180 | 3 | 0.50 |
| Example 1-26 | 1-3 | 0.35 | 3 | 10.0 | 4.5 | 35 | trapezoidal | 0.8 | 60 | 0.60 | 50 | 150 | 3 | 0.50 |
| Example 1-27 | 1-3 | 0.35 | 3 | 10.0 | 4.5 | 35 | trapezoidal | 0.8 | 60 | 0.60 | 50 | 100 | 3 | 0.50 |
| Example 1-28 | 1-3 | 0.35 | 3 | 10.0 | 4.5 | 50 | trapezoidal | 0.8 | 60 | 0.60 | 50 | 180 | 3 | 0.50 |
| Example 1-29 | 1-3 | 0.35 | 3 | 10.0 | 4.5 | 40 | trapezoidal | 0.8 | 60 | 0.60 | 50 | 180 | 3 | 0.50 |
| Example 1-30 | 1-3 | 0.35 | 3 | 10.0 | 4.5 | 25 | trapezoidal | 0.8 | 60 | 0.60 | 50 | 180 | 3 | 0.50 |
| Example 1-31 | 1-3 | 0.35 | 3 | 12.5 | 4.5 | 35 | trapezoidal | 0.8 | 60 | 0.60 | 50 | 180 | 3 | 0.50 |
| Example 1-32 | 1-3 | 0.35 | 3 | 7.5 | 4.5 | 35 | trapezoidal | 0.8 | 60 | 0.60 | 50 | 180 | 3 | 0.50 |
| Example 1-33 | 1-3 | 0.35 | 3 | 10.0 | 1.0 | 35 | trapezoidal | 0.8 | 60 | 0.60 | 50 | 180 | 3 | 0.50 |
| Example 1-34 | 1-3 | 0.35 | 3 | 10.0 | 7.5 | 35 | trapezoidal | 0.8 | 60 | 0.60 | 50 | 180 | 3 | 0.50 |
| Example 1-35 | 1-1 | 0.35 | 3 | 10.0 | 4.5 | 25 | trapezoidal | 0.8 | 60 | 0.60 | 50 | 180 | 3 | 0.50 |
| Example 1-36 | 1-1 | 0.35 | 3 | 10.0 | 4.5 | 30 | trapezoidal | 0.8 | 60 | 0.60 | 50 | 180 | 3 | 0.50 |
| Example 1-37 | 1-1 | 0.35 | 3 | 10.0 | 4.5 | 35 | trapezoidal | 0.8 | 60 | 0.60 | 50 | 180 | 3 | 0.50 |
| Example 1-38 | 1-2 | 0.35 | 3 | 10.0 | 4.5 | 35 | trapezoidal | 0.8 | 60 | 0.60 | 50 | 180 | 3 | 0.50 |
| Example 1-39 | 1-4 | 0.35 | 3 | 10.0 | 4.5 | 35 | trapezoidal | 0.8 | 60 | 0.60 | 50 | 180 | 3 | 0.50 |
| Example 1-40 | 1-5 | 0.35 | 3 | 10.0 | 4.5 | 35 | trapezoidal | 0.8 | 60 | 0.60 | 50 | 180 | 3 | 0.50 |
| Example 1-41 | 1-6 | 0.35 | 3 | 10.0 | 4.5 | 35 | trapezoidal | 0.8 | 60 | 0.60 | 50 | 180 | 3 | 0.50 |
| Example 1-42 | 1-2 | 0.35 | 3 | 10.0 | 4.5 | 35 | trapezoidal | 0.8 | 60 | 0.60 | 50 | 180 | 3 | 0.50 |
| Example 1-43 | 1-4 | 0.35 | 3 | 10.0 | 4.5 | 35 | trapezoidal | 0.8 | 60 | 0.60 | 50 | 180 | 3 | 0.50 |
| Example 1-44 | 1-5 | 0.35 | 3 | 10.0 | 4.5 | 35 | trapezoidal | 0.8 | 60 | 0.60 | 50 | 180 | 3 | 0.50 |
| Comp. Ex. 1 | 1-2 | | 3 | 10.0 | 4.5 | 35 | trapezoidal | 0.8 | 60 | 0.95 | 50 | 200 | 3 | 0.38 |

| | | | | | | | | | | | | | | Rₐ of |
|---|---|---|---|---|---|---|---|---|---|---|---|---|---|---|
| | | | | | | | | | | | | | | support |
| | | | Etching amount | | | | | | | | | | Etching amount | after |
| | | Rₐ after | in first | First Electrochemical Graining Treatment | | | | | | | | | in second | second |
| | | mechanical | etching | Nitric acid | | | | | | | Current | Am't of | etching | etching |
| | Aluminum | graining | treatment | conc. | Al ion conc. | Solution temp. | | | Frequency | Current | density | electricity | treatment | treatment |
| | plate | (μm) | (g/m²) | (g/l) | (g/l) | (° C.) | Waveform | Tp (msec) | (Hz) | ratio | (A/dm²) | (C/dm²) | (g/m²) | (μm) |
| Example 2-1 | 1-1 | 0.35 | 3 | 15 | 4.5 | 35 | trapezoidal | 0.8 | 60 | 0.95 | 50 | 200 | 3 | 0.50 |
| Example 2-2 | 1-1 | 0.35 | 3 | 20 | 4.5 | 35 | trapezoidal | 0.8 | 60 | 0.95 | 50 | 200 | 3 | 0.50 |
| Example 2-3 | 1-1 | 0.35 | 3 | 25 | 4.5 | 35 | trapezoidal | 0.8 | 60 | 0.95 | 50 | 200 | 3 | 0.50 |
| Example 2-4 | 1-1 | 0.30 | 3 | 25 | 4.5 | 35 | trapezoidal | 0.8 | 60 | 0.95 | 50 | 200 | 3 | 0.45 |
| Example 2-5 | 1-1 | 0.40 | 3 | 25 | 4.5 | 35 | trapezoidal | 0.8 | 60 | 0.95 | 50 | 200 | 3 | 0.55 |
| Example 2-6 | 1-1 | 0.35 | 3 | 30 | 4.5 | 35 | trapezoidal | 0.8 | 60 | 0.95 | 50 | 200 | 3 | 0.50 |
| Example 2-7 | 1-1 | 0.35 | 3 | 35 | 4.5 | 35 | trapezoidal | 0.8 | 60 | 0.95 | 50 | 200 | 3 | 0.55 |
| Example 2-8 | 1-1 | 0.35 | 3 | 20 | 4.5 | 35 | sinusoidal | — | 60 | 0.95 | 80 | 230 | 3 | 0.50 |
| Example 2-9 | 1-1 | 0.35 | 3 | 20 | 4.5 | 35 | sinusoidal | — | 50 | 0.95 | 80 | 230 | 3 | 0.50 |
| Example 2-10 | 1-1 | 0.35 | 3 | 20 | 4.5 | 35 | sinusoidal | — | 60 | 0.95 | 80 | 230 | 3 | 0.50 |
| Example 2-11 | 1-1 | 0.35 | 3 | 25 | 4.5 | 35 | trapezoidal | 0.8 | 60 | 0.95 | 50 | 250 | 3 | 0.50 |
| Example 2-12 | 1-1 | 0.35 | 3 | 25 | 4.5 | 35 | trapezoidal | 0.8 | 60 | 0.95 | 50 | 180 | 3 | 0.50 |
| Example 2-13 | 1-1 | 0.35 | 3 | 25 | 4.5 | 35 | trapezoidal | 0.8 | 60 | 0.95 | 50 | 180 | 3 | 0.50 |
| Example 2-14 | 1-1 | 0.35 | 3 | 25 | 4.5 | 35 | trapezoidal | 0.8 | 60 | 0.95 | 50 | 180 | 3 | 0.50 |
| Example 2-15 | 1-1 | 0.35 | 3 | 25 | 4.5 | 35 | trapezoidal | 0.8 | 60 | 0.95 | 50 | 180 | 3 | 0.50 |
| Example 2-16 | 1-1 | 0.35 | 3 | 25 | 4.5 | 35 | trapezoidal | 0.8 | 60 | 0.95 | 50 | 180 | 3 | 0.50 |
| Example 2-17 | 1-1 | 0.35 | 3 | 25 | 4.5 | 35 | trapezoidal | 0.8 | 60 | 0.95 | 50 | 180 | 3 | 0.50 |
| Example 2-18 | 1-1 | 0.35 | 3 | 25 | 4.5 | 35 | trapezoidal | 0.8 | 60 | 0.95 | 50 | 180 | 3 | 0.50 |
| Example 2-19 | 1-1 | 0.35 | 3 | 25 | 4.5 | 35 | trapezoidal | 0.8 | 60 | 0.95 | 50 | 180 | 1 | 0.50 |
| Example 2-20 | 1-1 | 0.35 | 3 | 25 | 4.5 | 35 | trapezoidal | 0.8 | 60 | 0.95 | 50 | 180 | 2 | 0.50 |
| Example 2-21 | 1-1 | 0.35 | 3 | 25 | 4.5 | 35 | trapezoidal | 0.8 | 60 | 0.95 | 50 | 180 | 5 | 0.50 |
| Example 2-22 | 1-1 | 0.35 | 3 | 25 | 4.5 | 35 | trapezoidal | 0.8 | 60 | 0.95 | 50 | 180 | 7 | 0.50 |
| Example 2-23 | 1-1 | 0.35 | 1 | 25 | 4.5 | 35 | trapezoidal | 0.8 | 60 | 0.95 | 50 | 180 | 3 | 0.50 |
| Example 2-24 | 1-1 | 0.35 | 5 | 25 | 4.5 | 35 | trapezoidal | 0.8 | 60 | 0.95 | 50 | 180 | 3 | 0.50 |
| Example 2-25 | 1-1 | 0.35 | 3 | 25 | 4.5 | 35 | trapezoidal | 0.8 | 60 | 0.95 | 30 | 180 | 3 | 0.50 |
| Example 2-26 | 1-1 | 0.35 | 3 | 25 | 4.5 | 35 | trapezoidal | 0.8 | 60 | 0.95 | 100 | 180 | 3 | 0.50 |
| Example 2-27 | 1-1 | 0.35 | 3 | 25 | 4.5 | 35 | trapezoidal | 2.0 | 60 | 0.95 | 50 | 180 | 3 | 0.50 |
| Example 2-28 | 1-1 | 0.35 | 3 | 25 | 4.5 | 35 | trapezoidal | 0.8 | 60 | 0.95 | 50 | 150 | 3 | 0.50 |
| Example 2-29 | 1-1 | 0.35 | 3 | 25 | 4.5 | 35 | trapezoidal | 0.8 | 60 | 0.95 | 50 | 100 | 3 | 0.50 |
| Example 2-30 | 1-1 | 0.35 | 3 | 25 | 4.5 | 50 | trapezoidal | 0.8 | 60 | 0.95 | 50 | 180 | 3 | 0.50 |
| Example 2-31 | 1-1 | 0.35 | 3 | 25 | 4.5 | 25 | trapezoidal | 0.8 | 60 | 0.95 | 50 | 180 | 3 | 0.50 |
| Example 2-32 | 1-1 | 0.35 | 3 | 25 | 4.5 | 20 | trapezoidal | 0.8 | 60 | 0.95 | 50 | 180 | 3 | 0.50 |
| Example 2-33 | 1-1 | 0.35 | 3 | 25 | 4.5 | 35 | trapezoidal | 0.8 | 60 | 0.98 | 50 | 180 | 3 | 0.50 |
| Example 2-34 | 1-1 | 0.35 | 3 | 25 | 4.5 | 35 | trapezoidal | 0.8 | 60 | 0.90 | 50 | 180 | 3 | 0.50 |
| Example 2-35 | 1-1 | 0.35 | 3 | 25 | 1.0 | 35 | trapezoidal | 0.8 | 60 | 0.95 | 50 | 180 | 3 | 0.50 |
| Example 2-36 | 1-1 | 0.35 | 3 | 25 | 10.0 | 35 | trapezoidal | 0.8 | 60 | 0.95 | 50 | 180 | 3 | 0.50 |
| Example 2-37 | 1-2 | 0.35 | 3 | 20 | 4.5 | 35 | trapezoidal | 0.8 | 60 | 0.95 | 50 | 180 | 3 | 0.50 |
| Example 2-38 | 1-3 | 0.35 | 3 | 15 | 4.5 | 35 | trapezoidal | 0.8 | 60 | 0.95 | 50 | 180 | 3 | 0.50 |
| Example 2-39 | 1-3 | 0.35 | 3 | 20 | 4.5 | 35 | trapezoidal | 0.8 | 60 | 0.95 | 50 | 180 | 3 | 0.50 |
| Example 2-40 | 1-3 | 0.35 | 3 | 25 | 4.5 | 35 | trapezoidal | 0.8 | 60 | 0.95 | 50 | 180 | 3 | 0.50 |
| Example 2-41 | 1-4 | 0.35 | 3 | 20 | 4.5 | 35 | trapezoidal | 0.8 | 60 | 0.95 | 50 | 180 | 3 | 0.50 |
| Example 2-42 | 1-5 | 0.35 | 3 | 20 | 4.5 | 35 | trapezoidal | 0.8 | 60 | 0.95 | 50 | 180 | 3 | 0.55 |
| Example 2-43 | 1-6 | 0.35 | 3 | 20 | 4.5 | 35 | trapezoidal | 0.8 | 60 | 0.95 | 50 | 180 | 3 | 0.55 |
| Example 2-44 | 1-2 | 0.35 | 3 | 20 | 4.5 | 35 | trapezoidal | 0.8 | 60 | 0.95 | 50 | 180 | 3 | 0.50 |
| Example 2-45 | 1-3 | 0.35 | 3 | 20 | 4.5 | 35 | trapezoidal | 0.8 | 60 | 0.95 | 50 | 180 | 3 | 0.50 |
| Example 2-46 | 1-4 | 0.35 | 3 | 20 | 4.5 | 35 | trapezoidal | 0.8 | 60 | 0.95 | 50 | 180 | 3 | 0.50 |
| Example 2-47 | 1-5 | 0.35 | 3 | 20 | 4.5 | 35 | trapezoidal | 0.8 | 60 | 0.95 | 50 | 180 | 3 | 0.55 |

| | | | | | | | | | Etching | Rₐ of | | | Printing performance | | | |
|---|---|---|---|---|---|---|---|---|---|---|---|---|---|---|---|---|
| | Second Electrochemical Graining Treatment | | | | | | | | amount in | support | | | | Scumming | | |
| | | Al | | | | | | | third | after | | | | resistance in | | |
| | HCl | ion | Solution | | | | Current | Am't of | etching | anodizing | | | | non-image | | |
| | conc. | conc. | temp. | | Tp | Frequency | density | electricity | treatment | treatment | Hydrophilizing | Photosensitive | Scumming | areas between | Press | Cleaner |
| | (g/l) | (g/l) | (° C.) | Waveform | (msec) | (Hz) | (A/dm²) | (C/dm²) | (g/m²) | (μm) | treatment | layer | resistance | halftone dots | life | resistance |
| Example 1-1 | 7.5 | 4.5 | 35 | trapezoidal | 0.8 | 60 | 50 | 65 | 0.15 | 0.50 | 1 | 1 | A | A-B | A | A-B |
| Example 1-2 | 7.5 | 4.5 | 35 | trapezoidal | 0.8 | 60 | 50 | 65 | 0.15 | 0.50 | 1 | 1 | A | A-B | A | A-B |
| Example 1-3 | 7.5 | 4.5 | 35 | trapezoidal | 0.8 | 60 | 50 | 65 | 0.15 | 0.45 | 1 | 1 | A | A-B | A | A-B |
| Example 1-4 | 7.5 | 4.5 | 35 | trapezoidal | 0.8 | 60 | 50 | 65 | 0.15 | 0.55 | 1 | 1 | A | A-B | A | A-B |
| Example 1-5 | 7.5 | 4.5 | 35 | trapezoidal | 0.8 | 60 | 50 | 65 | 0.15 | 0.50 | 1 | 1 | A | A-B | A | A-B |
| Example 1-6 | 7.5 | 4.5 | 35 | trapezoidal | 0.8 | 60 | 50 | 65 | 0.15 | 0.55 | 1 | 1 | A | A-B | A | A-B |
| Example 1-7 | 7.5 | 4.5 | 35 | trapezoidal | 0.8 | 60 | 50 | 65 | 0.15 | 0.50 | 1 | 1 | A | A-B | A-B | A-B |
| Example 1-8 | 7.5 | 4.5 | 35 | trapezoidal | 0.8 | 60 | 50 | 65 | 0.15 | 0.50 | 1 | 1 | A | A-B | A-B | A-B |
| Example 1-9 | 7.5 | 4.5 | 35 | sinusoidal | — | 60 | 80 | 65 | 0.15 | 0.50 | 1 | 1 | A | A-B | A | B |
| Example 1-10 | 7.5 | 4.5 | 35 | trapezoidal | 0.8 | 60 | 50 | 65 | 0.15 | 0.50 | 1 | 1 | A | A-B | A | A-B |
| Example 1-11 | 7.5 | 4.5 | 35 | trapezoidal | 0.8 | 60 | 50 | 65 | 0.15 | 0.50 | 1 | 1 | A | A-B | A | A-B |
| Example 1-12 | 7.5 | 4.5 | 35 | trapezoidal | 0.8 | 60 | 100 | 65 | 0.15 | 0.50 | 1 | 1 | A | A-B | A | A-B |
| Example 1-13 | 7.5 | 4.5 | 35 | trapezoidal | 0.8 | 60 | 50 | 65 | 0.05 | 0.50 | 1 | 1 | A | A-B | A | A-B |
| Example 1-14 | 7.5 | 4.5 | 35 | trapezoidal | 0.8 | 60 | 50 | 65 | 0.20 | 0.50 | 1 | 1 | A | A-B | A | A-B |
| Example 1-15 | 5.0 | 4.5 | 35 | trapezoidal | 0.8 | 60 | 50 | 65 | 0.15 | 0.50 | 1 | 1 | A | A-B | A | A-B |
| Example 1-16 | 10.0 | 4.5 | 35 | trapezoidal | 0.8 | 60 | 50 | 65 | 0.15 | 0.50 | 1 | 1 | A | A-B | A | A-B |
| Example 1-17 | 7.5 | 4.5 | 35 | trapezoidal | 0.8 | 60 | 50 | 65 | 0.15 | 0.50 | 1 | 1 | A-B | A-B | A | A-B |
| Example 1-18 | 7.5 | 4.5 | 35 | trapezoidal | 0.8 | 60 | 50 | 65 | 0.15 | 0.50 | 1 | 1 | A | A-B | A | A-B |
| Example 1-19 | 7.5 | 4.5 | 35 | trapezoidal | 0.8 | 60 | 50 | 65 | 0.15 | 0.50 | 1 | 1 | A | A-B | A | A-B |
| Example 1-20 | 7.5 | 4.5 | 35 | trapezoidal | 0.8 | 60 | 50 | 65 | 0.15 | 0.50 | 1 | 1 | A | A-B | A-B | A-B |
| Example 1-21 | 7.5 | 4.5 | 35 | trapezoidal | 0.8 | 60 | 50 | 65 | 0.15 | 0.50 | 1 | 1 | A | A-B | A | A-B |
| Example 1-22 | 7.5 | 4.5 | 35 | trapezoidal | 0.8 | 60 | 50 | 65 | 0.15 | 0.50 | 1 | 1 | A | A-B | A | A-B |
| Example 1-23 | 7.5 | 4.5 | 35 | trapezoidal | 0.8 | 60 | 50 | 65 | 0.15 | 0.50 | 1 | 1 | A | A-B | A | A-B |
| Example 1-24 | 7.5 | 4.5 | 35 | trapezoidal | 0.8 | 60 | 50 | 65 | 0.15 | 0.50 | 1 | 1 | A | A-B | A | A-B |
| Example 1-25 | 7.5 | 4.5 | 35 | trapezoidal | 0.8 | 60 | 50 | 65 | 0.15 | 0.50 | 1 | 1 | A | A-B | A | A-B |
| Example 1-26 | 7.5 | 4.5 | 35 | trapezoidal | 0.8 | 60 | 50 | 65 | 0.15 | 0.50 | 1 | 1 | A | A-B | A | A-B |
| Example 1-27 | 7.5 | 4.5 | 35 | trapezoidal | 0.8 | 60 | 50 | 65 | 0.15 | 0.50 | 1 | 1 | A | A-B | A-B | B |
| Example 1-28 | 7.5 | 4.5 | 35 | trapezoidal | 0.8 | 60 | 50 | 65 | 0.15 | 0.50 | 1 | 1 | A | A-B | A | A-B |
| Example 1-29 | 7.5 | 4.5 | 35 | trapezoidal | 0.8 | 60 | 50 | 65 | 0.15 | 0.50 | 1 | 1 | A | A-B | A | A-B |
| Example 1-30 | 7.5 | 4.5 | 35 | trapezoidal | 0.8 | 60 | 50 | 65 | 0.15 | 0.50 | 1 | 1 | A | A-B | A | A-B |
| Example 1-31 | 7.5 | 4.5 | 35 | trapezoidal | 0.8 | 60 | 50 | 65 | 0.15 | 0.50 | 1 | 1 | A | A-B | A | A-B |
| Example 1-32 | 7.5 | 4.5 | 35 | trapezoidal | 0.8 | 60 | 50 | 65 | 0.15 | 0.50 | 1 | 1 | A | A-B | A | A-B |
| Example 1-33 | 7.5 | 4.5 | 35 | trapezoidal | 0.8 | 60 | 50 | 65 | 0.15 | 0.50 | 1 | 1 | A | A-B | A | A-B |
| Example 1-34 | 7.5 | 4.5 | 35 | trapezoidal | 0.8 | 60 | 50 | 65 | 0.15 | 0.50 | 1 | 1 | A | A-B | A | A-B |
| Example 1-35 | 7.5 | 4.5 | 35 | trapezoidal | 0.8 | 60 | 50 | 65 | 0.10 | 0.50 | 1 | 1 | A | A-B | A | A-B |
| Example 1-36 | 7.5 | 4.5 | 35 | trapezoidal | 0.8 | 60 | 50 | 65 | 0.15 | 0.50 | 1 | 1 | A | A-B | A | A-B |
| Example 1-37 | 7.5 | 4.5 | 35 | trapezoidal | 0.8 | 60 | 50 | 65 | 0.10 | 0.50 | 1 | 1 | A | A-B | A | A-B |
| Example 1-38 | 7.5 | 4.5 | 35 | trapezoidal | 0.8 | 60 | 50 | 65 | 0.10 | 0.50 | 1 | 1 | A | A-B | A | A-B |
| Example 1-39 | 7.5 | 4.5 | 35 | trapezoidal | 0.8 | 60 | 50 | 65 | 0.15 | 0.50 | 1 | 1 | A | A-B | A | A |
| Example 1-40 | 7.5 | 4.5 | 35 | trapezoidal | 0.8 | 60 | 50 | 65 | 0.15 | 0.50 | 1 | 1 | A | A-B | A | A |
| Example 1-41 | 7.5 | 4.5 | 35 | trapezoidal | 0.8 | 60 | 50 | 65 | 0.15 | 0.50 | 1 | 1 | A | A-B | A | A |
| Example 1-42 | 7.5 | 4.5 | 35 | trapezoidal | 0.8 | 60 | 50 | 65 | 0.15 | 0.50 | 2 | 2 | A | A | A | A |
| Example 1-43 | 7.5 | 4.5 | 35 | trapezoidal | 0.8 | 60 | 50 | 65 | 0.15 | 0.50 | 2 | 2 | A | A | A | A |
| Example 1-44 | 7.5 | 4.5 | 35 | trapezoidal | 0.8 | 60 | 50 | 65 | 0.15 | 0.50 | 2 | 2 | A | A | A | A |
| Comp. Ex. 1 | 7.5 | 4.5 | 35 | trapezoidal | 0.8 | 60 | 50 | 65 | 0.10 | 0.38 | 1 | 1 | A | A-B | B | B-C |

| | | | | | | | | | | | | | Printing performance | | | |
|---|---|---|---|---|---|---|---|---|---|---|---|---|---|---|---|---|
| | | | | | | | | | | | | | | Scumming | | |
| | | | | | | | | | Etching | Rₐ of | | | | resistance in | | |
| | Second Electrochemical Graining Treatment | | | | | | | | amount in | support | | | | non-image | | |
| | | Al | | | | | | | third | after | | | | areas | | |
| | HCl | ion | Solution | | | | Current | Am't of | etching | anodizing | | | | between | | |
| | conc. | conc. | temp. | | | Frequency | density | electricity | treatment | treatment | Hydrophilizing | Photosensitive | Scumming | halftone | Press | Cleaner |
| | (g/l) | (g/l) | (° C.) | Waveform | Tp (msec) | (Hz) | (A/dm²) | (C/dm²) | (g/m²) | (μm) | treatment | layer | resistance | dots | life | resistance |
| Example 2-1 | 7.5 | 4.5 | 35 | trapezoidal | 0.8 | 60 | 50 | 65 | 0.15 | 0.50 | 1 | 1 | A | A-B | A-B | A-B |
| Example 2-2 | 7.5 | 4.5 | 35 | trapezoidal | 0.8 | 60 | 50 | 65 | 0.15 | 0.50 | 1 | 1 | A | A-B | A | A-B |
| Example 2-3 | 7.5 | 4.5 | 35 | trapezoidal | 0.8 | 60 | 50 | 65 | 0.15 | 0.50 | 1 | 1 | A | A-B | A | A-B |
| Example 2-4 | 7.5 | 4.5 | 35 | trapezoidal | 0.8 | 60 | 50 | 65 | 0.15 | 0.45 | 1 | 1 | A | A-B | A | A-B |
| Example 2-5 | 7.5 | 4.5 | 35 | trapezoidal | 0.8 | 60 | 50 | 65 | 0.15 | 0.55 | 1 | 1 | A | A-B | A | A-B |
| Example 2-6 | 7.5 | 4.5 | 35 | trapezoidal | 0.8 | 60 | 50 | 65 | 0.15 | 0.50 | 1 | 1 | A-B | A-B | A | A-B |
| Example 2-7 | 7.5 | 4.5 | 35 | trapezoidal | 0.8 | 60 | 50 | 65 | 0.15 | 0.55 | 1 | 1 | A | A-B | A | A-B |
| Example 2-8 | 7.5 | 4.5 | 35 | trapezoidal | 0.8 | 60 | 50 | 65 | 0.15 | 0.50 | 1 | 1 | A | A-B | A | B |
| Example 2-9 | 7.5 | 4.5 | 35 | trapezoidal | 0.8 | 60 | 50 | 65 | 0.15 | 0.50 | 1 | 1 | A | A-B | A | B |
| Example 2-10 | 7.5 | 4.5 | 35 | sinusoidal | — | 60 | 80 | 65 | 0.15 | 0.50 | 1 | 1 | A | A-B | A | B |
| Example 2-11 | 7.5 | 4.5 | 35 | trapezoidal | 0.8 | 60 | 50 | 65 | 0.15 | 0.50 | 1 | 1 | A | A-B | A | A-B |
| Example 2-12 | 7.5 | 4.5 | 35 | trapezoidal | 0.8 | 60 | 50 | 65 | 0.15 | 0.50 | 1 | 1 | A | A-B | A | A-B |
| Example 2-13 | 7.5 | 4.5 | 35 | trapezoidal | 0.8 | 60 | 100 | 65 | 0.15 | 0.50 | 1 | 1 | A | A-B | A | A-B |
| Example 2-14 | 7.5 | 4.5 | 35 | trapezoidal | 0.8 | 60 | 50 | 65 | 0.05 | 0.50 | 1 | 1 | A | A-B | A | A-B |
| Example 2-15 | 7.5 | 4.5 | 35 | trapezoidal | 0.8 | 60 | 50 | 65 | 0.10 | 0.50 | 1 | 1 | A | A-B | A | A-B |
| Example 2-16 | 7.5 | 4.5 | 35 | trapezoidal | 0.8 | 60 | 50 | 65 | 0.20 | 0.50 | 1 | 1 | A | A-B | A | A-B |
| Example 2-17 | 5.0 | 4.5 | 35 | trapezoidal | 0.8 | 60 | 50 | 65 | 0.15 | 0.50 | 1 | 1 | A | A-B | A | A-B |
| Example 2-18 | 10.0 | 4.5 | 35 | trapezoidal | 0.8 | 60 | 50 | 65 | 0.15 | 0.50 | 1 | 1 | A | A-B | A | A-B |
| Example 2-19 | 7.5 | 4.5 | 35 | trapezoidal | 0.8 | 60 | 50 | 65 | 0.15 | 0.50 | 1 | 1 | A-B | A-B | A | A-B |
| Example 2-20 | 7.5 | 4.5 | 35 | trapezoidal | 0.8 | 60 | 50 | 65 | 0.15 | 0.50 | 1 | 1 | A | A-B | A | A-B |
| Example 2-21 | 7.5 | 4.5 | 35 | trapezoidal | 0.8 | 60 | 50 | 65 | 0.15 | 0.50 | 1 | 1 | A | A-B | A | A-B |
| Example 2-22 | 7.5 | 4.5 | 35 | trapezoidal | 0.8 | 60 | 50 | 65 | 0.15 | 0.50 | 1 | 1 | A | A-B | A-B | A-B |
| Example 2-23 | 7.5 | 4.5 | 35 | trapezoidal | 0.8 | 60 | 50 | 65 | 0.15 | 0.50 | 1 | 1 | A | A-B | A | A-B |
| Example 2-24 | 7.5 | 4.5 | 35 | trapezoidal | 0.8 | 60 | 50 | 65 | 0.15 | 0.50 | 1 | 1 | A | A-B | A | A-B |
| Example 2-25 | 7.5 | 4.5 | 35 | trapezoidal | 0.8 | 60 | 50 | 65 | 0.15 | 0.50 | 1 | 1 | A | A-B | A | A-B |
| Example 2-26 | 7.5 | 4.5 | 35 | trapezoidal | 0.8 | 60 | 50 | 65 | 0.15 | 0.50 | 1 | 1 | A | A-B | A | A-B |
| Example 2-27 | 7.5 | 4.5 | 35 | trapezoidal | 0.8 | 60 | 50 | 65 | 0.15 | 0.50 | 1 | 1 | A | A-B | A | A-B |
| Example 2-28 | 7.5 | 4.5 | 35 | trapezoidal | 0.8 | 60 | 50 | 65 | 0.15 | 0.50 | 1 | 1 | A | A-B | A | A-B |
| Example 2-29 | 7.5 | 4.5 | 35 | trapezoidal | 0.8 | 60 | 50 | 65 | 0.15 | 0.50 | 1 | 1 | A | A-B | A-B | B |
| Example 2-30 | 7.5 | 4.5 | 35 | trapezoidal | 0.8 | 60 | 50 | 65 | 0.15 | 0.50 | 1 | 1 | A | A-B | A | A-B |
| Example 2-31 | 7.5 | 4.5 | 35 | trapezoidal | 0.8 | 60 | 50 | 65 | 0.15 | 0.50 | 1 | 1 | A | A-B | A | A-B |
| Example 2-32 | 7.5 | 4.5 | 35 | trapezoidal | 0.8 | 60 | 50 | 65 | 0.15 | 0.50 | 1 | 1 | A | A-B | A | A-B |
| Example 2-33 | 7.5 | 4.5 | 35 | trapezoidal | 0.8 | 60 | 50 | 65 | 0.15 | 0.50 | 1 | 1 | A | A-B | A | A-B |
| Example 2-34 | 7.5 | 4.5 | 35 | trapezoidal | 0.8 | 60 | 50 | 65 | 0.15 | 0.50 | 1 | 1 | A | A-B | A | A-B |
| Example 2-35 | 7.5 | 4.5 | 35 | trapezoidal | 0.8 | 60 | 50 | 65 | 0.15 | 0.50 | 1 | 1 | A | A-B | A | A-B |
| Example 2-36 | 7.5 | 4.5 | 35 | trapezoidal | 0.8 | 60 | 50 | 65 | 0.15 | 0.50 | 1 | 1 | A | A-B | A | A-B |
| Example 2-37 | 7.5 | 4.5 | 35 | trapezoidal | 0.8 | 60 | 50 | 65 | 0.15 | 0.50 | 1 | 1 | A | A-B | A | A-B |
| Example 2-38 | 7.5 | 4.5 | 35 | trapezoidal | 0.8 | 60 | 50 | 65 | 0.15 | 0.50 | 1 | 1 | A | A-B | A | A |
| Example 2-39 | 7.5 | 4.5 | 35 | trapezoidal | 0.8 | 60 | 50 | 65 | 0.15 | 0.50 | 1 | 1 | A | A-B | A | A |
| Example 2-40 | 7.5 | 4.5 | 35 | trapezoidal | 0.8 | 60 | 50 | 65 | 0.15 | 0.50 | 1 | 1 | A | A-B | A | A |
| Example 2-41 | 7.5 | 4.5 | 35 | trapezoidal | 0.8 | 60 | 50 | 65 | 0.15 | 0.50 | 1 | 1 | A | A-B | A | A |
| Example 2-42 | 7.5 | 4.5 | 35 | trapezoidal | 0.8 | 60 | 50 | 65 | 0.15 | 0.55 | 1 | 1 | A | A-B | A | A |
| Example 2-43 | 7.5 | 4.5 | 35 | trapezoidal | 0.8 | 60 | 50 | 65 | 0.15 | 0.55 | 1 | 1 | A | A-B | A | A |
| Example 2-44 | 7.5 | 4.5 | 35 | trapezoidal | 0.8 | 60 | 50 | 65 | 0.15 | 0.50 | 2 | 2 | A | A | A | A |
| Example 2-45 | 7.5 | 4.5 | 35 | trapezoidal | 0.8 | 60 | 50 | 65 | 0.15 | 0.50 | 2 | 2 | A | A | A | A |
| Example 2-46 | 7.5 | 4.5 | 35 | trapezoidal | 0.8 | 60 | 50 | 65 | 0.15 | 0.50 | 2 | 2 | A | A | A | A |
| Example 2-47 | 7.5 | 4.5 | 35 | trapezoidal | 0.8 | 60 | 50 | 65 | 0.15 | 0.55 | 2 | 2 | A | A | A | A |

### Examples of the Second Aspect of the Invention

2-1. Manufacture of Lithographic Printing Plate Supports

### Examples 3-1 to 3-45 and Comparative Example 2

In each of these examples, aside from preparing a melt using an aluminum alloy of the composition shown in Table 3 (with the balance being aluminum and inadvertent impurities; units are in wt %), an aluminum plate was obtained by the same method as for the first aspect of the invention.

TABLE 3

| | Si | Fe | Cu | Mn | Mg | Cr | Zn | Ti |
|---|---|---|---|---|---|---|---|---|
| Aluminum 2-1 | 0.080 | 0.300 | 0.000 | 0.001 | 0.000 | 0.001 | 0.003 | 0.021 |
| Aluminum 2-2 | 0.076 | 0.270 | 0.015 | 0.001 | 0.000 | 0.001 | 0.003 | 0.021 |
| Aluminum 2-3 | 0.076 | 0.270 | 0.023 | 0.001 | 0.000 | 0.001 | 0.003 | 0.021 |
| Aluminum 2-4 | 0.076 | 0.270 | 0.035 | 0.001 | 0.000 | 0.001 | 0.003 | 0.021 |
| Aluminum 2-5 | 0.278 | 0.413 | 0.201 | 0.892 | 0.783 | 0.022 | 0.122 | 0.034 |

The aluminum plate was then subjected to the following treatment.

<Surface Treatment>

Surface treatment was effected by consecutively carrying out the following treatment operations (a) to (j) and (1) on the aluminum plate.

(a) Mechanical Graining Treatment

Mechanical graining was carried out with rotating roller-type nylon brushes while supplying to the surface of the aluminum plate from a spray line an abrasive slurry which was an aqueous suspension (specific gravity, 1.15) of the abrasive shown in Table 4. The ingredients in the silica sand and the ingredients in the pumice used in the respective examples of the invention and the comparative example were measured. The results are shown below.

<Pumice Ingredients>

| | |
|---|---|
| Silica (SiO₂) | 73 wt % |
| Alumina (Al₂O₃) | 14 wt % |
| Iron oxide (Fe₂O₃) | 1 wt % |
| Other ingredients | balance |

<Silica Sand Ingredients>

| | |
|---|---|
| Silica (SiO₂) | 95 wt % |
| Alumina (Al₂O₃) | 2 wt % |
| Iron oxide (Fe₂O₃) | 0.1 wt % |
| Other ingredients | balance |

The nylon brushes were No. 3 brushes in which the bristles were made of nylon 6.10 and had a bristle length (before implantation) of 50 mm and a bristle diameter of 0.295 mm. Each brush was constructed of a 300 mm diameter stainless steel cylinder in which holes had been formed and bristles densely set. Three rotating brushes were used.

Two support rollers (200 mm diameter) were provided below each nylon brush and spaced 300 mm apart. The brushes were made to rotate in the same direction as the direction in which the aluminum plate was moved.

The degree to which the nylon brushes pushed against the plate was adjusted by regulating the load on the motor driving the rotation of the brushes.

This mechanical graining treatment was carried out while suitably adjusting such parameters as the flow rate of the abrasive, the rotational speed of the brushes, and the movement speed of the aluminum plate so as to give the aluminum plate following the treatment a mean surface roughness Rₐ of 0.25 to 0.42 μm. Table 4 gives the mean surface roughness Rₐ of the aluminum plate following mechanical graining treatment.

The mean surface roughness Rₐ of the aluminum plate was measured in the same way as for the first aspect of the invention.

(b) Etching with Aqueous Alkali Solution (First Etching Treatment)

Aside from setting the amount of material removed by etching (etching amount) from the side of the aluminum plate to be subsequently subjected to the first electrochemical graining treatment to the value indicated in Table 4, the first etching treatment was carried out in the same way as for the first aspect of the invention.

Using the same method as for the first aspect of the invention, solution remaining on the plate after etching was removed with nip rollers and the subsequently described rinsing treatment was carried out, following which water remaining on the plate was removed with nip rollers.

(c) Desmutting with Acidic Aqueous Solution (First Desmutting Treatment)

A first desmutting treatment step was carried out in the same way as for the first aspect of the invention, following which solution remaining on the plate was removed with nip rollers.

(d) First Electrochemical Graining Treatment

The aluminum plate was then subjected to the first electrochemical graining treatment using an electrolytic solution having the nitric acid concentration, aluminum ion concentration and solution temperature shown in Table 4. The electrolytic solution was prepared using a 68 wt % aqueous solution of nitric acid and aluminum nitrate nonahydrate in the amounts shown in Table 4. The ratio R of the aluminum ion concentration A to the nitric acid concentration N(R=A/N) for each of the electrolytic solutions is shown in Table 4. The ammonium ion concentration was 70 mg/L.

Electrochemical graining treatment was carried out using a power supply that controlled the current by pulse width modulation using an IBGT device, and thereby generated an alternating current of a given waveform.

A carbon electrode was used as the counterelectrode, and an iridium oxide electrode was used as the auxiliary anode. Two radial electrolytic cells like that shown in FIG. 4 were used.

The waveform and frequency of the alternating current generated, and the time TP until the current reached a peak from zero are shown in Table 4. The duty ratio was 0.5. Table 4 also shows the current density (peak value of alternating current) and the total amount of electricity during the anodic reaction on the aluminum plate, as well as the current ratio r in the main electrolytic cells. The current ratio r was adjusted by the amount of current diverted to the auxiliary anode.

The aluminum plate was fed to the main electrolytic cell at a relative velocity with respect to the electrolytic solution in the main electrolytic cell of 1 to 2 m/s, or an average speed of 1.5 m/s.

The solution was then removed from the plate with nip rollers. In addition, rinsing treatment was carried out using a spray line of the same construction as that used in the rinsing treatment in step (b) above, following which water remaining on the plate was removed with nip rollers.

(e) Etching with Aqueous Alkali Solution (Second Etching Treatment)

Aside from setting the amount of material removed by etching (etching amount) from the side of the aluminum plate to be subsequently subjected to the second electrochemical graining treatment to the value indicated in Table 4, the second etching treatment was carried out in the same way as for the first aspect of the invention.

The solution was then removed from the plate with nip rollers. In addition, rinsing treatment was carried out using a spray line of the same construction as that used in the rinsing treatment in step (b) above, following which water remaining on the plate was removed with nip rollers.

Following the second etching treatment, the mean surface roughness Rₐ of the aluminum plate was measured. The results are shown in Table 4. The mean surface roughness Rₐ was measured by the same method as described in step (a) above.

(f) Desmutting with Acidic Aqueous Solution (Second Desmutting Treatment)

A second desmutting treatment step was carried out in the same way as for the first aspect of the invention.

The solution was then removed from the plate with nip rollers. In addition, rinsing treatment was carried out using a spray line of the same construction as that used in the rinsing treatment in step (b) above, following which water remaining on the plate was removed with nip rollers.

(g) Second Electrochemical Graining Treatment

Use was made of an electrolytic solution having the hydrochloric acid concentration and the aluminum ion concentration shown in Table 4 and having a solution temperature of 35° C. The electrolytic solution was prepared using a 35 wt % aqueous solution of hydrochloric acid and aluminum hydrochloride hexahydrate in the amounts shown in Table 4. The ammonium ion concentration was adjusted using aluminum chloride.

Electrochemical graining treatment was carried out using a power supply that controlled the current by pulse width modulation using an IBGT device, and thereby generated an alternating current of a given waveform.

A carbon electrode was used as the counterelectrode, and an iridium oxide electrode was used as the auxiliary anode. One radial electrolytic cell like that shown in FIG. 4 was used.

The alternating current generated had a trapezoidal waveform. The frequency was 60 Hz, the time TP until the current reached a peak from zero was 0.8 ms, and the duty ratio was 0.5. Table 4 shows the current density (peak value of alternating current) during the anodic reaction on the aluminum plate, the amount of electricity, and the current ratio. The current ratio was adjusted by the amount of current diverted to the auxiliary anode. The aluminum plate was fed to the main electrolytic cell at a relative velocity with respect to the electrolytic solution in the main electrolytic cell of 1 to 2 m/s, or an average speed of 1.5 m/s.

The solution was then removed from the plate with nip rollers. In addition, rinsing treatment was carried out using a spray line of the same construction as that used in the rinsing treatment in step (b) above, following which water remaining on the plate was removed with nip rollers.

(h) Etching with Aqueous Alkali Solution (Third Etching Treatment)

The third etching treatment was carried out in the same way as for the first aspect of the invention. Table 4 shows the amount of material removed by etching from the side of the aluminum plate that has been subjected to the second electrochemical graining treatment.

The solution was then removed from the plate with nip rollers. In addition, rinsing treatment was carried out using a spray line of the same construction as that used in the rinsing treatment in step (b) above, following which water remaining on the plate was removed with nip rollers.

(i) Desmutting with Acidic Aqueous Solution (Third Desmutting Treatment)

The third desmutting treatment was carried out in the same way as for the first aspect of the invention. Solution remaining on the plate was then removed with nip rollers.

(j) Anodizing Treatment

Anodizing treatment was carried out in the same way as for the first aspect of the invention.

The solution was then removed from the plate with nip rollers. In addition, rinsing treatment was carried out using a spray line of the same construction as that used in the rinsing treatment in step (b) above, following which water remaining on the plate was removed with nip rollers.

(l) Hydrophilizing Treatment 2

Hydrophilizing treatment 2 was carried out in the same way as for the first aspect of the invention.

The solution was then removed from the plate with nip rollers. In addition, rinsing treatment was carried out using a spray line of the same construction as that used in the rinsing treatment in step (b) above, after which water remaining on the plate was removed with nip rollers. This was followed by drying in which 90° C. air was blown across the plate for 10 seconds, thereby giving a support for a lithographic printing plate.

### Examples 3-46 to 3-48

Aside from carrying out treatment (k) described below instead of the above treatment (l), supports for lithographic printing plates were obtained by carrying out surface treatment in the same way as in Examples 3-1 to 3-45.

(k) Hydrophilizing Treatment 1

Hydrophilizing treatment 1 was carried out in the same way as for the first aspect of the invention.

The solution was then removed from the plate with nip rollers. In addition, rinsing treatment was carried out using a spray line of the same construction as that used in the rinsing treatment in step (b) above, after which water remaining on the plate was removed with nip rollers. This was followed by drying in which 90° C. air was blown across the plate for 10 seconds, thereby giving a support for a lithographic printing plate.

2-2. Surface Examination of Lithographic Printing Plate Supports

The surface of each of the lithographic printing plate supports obtained in Examples 3-1 to 3-48 was examined under a scanning electron microscope (JSM-5500, manufactured by JEOL Ltd.; the same applies below) at a magnification of 50,000×, whereupon fine asperities having an average opening diameter of 0.05 to 0.3 μm were found to have been uniformly and densely formed.

In addition, examination under a scanning electron microscope at a magnification of 2,000× showed that asperities (honeycombed pits) having an average opening diameter of 1 to 6 μm were uniformly formed on the surfaces of the lithographic printing plate supports in Examples 3-1 to 3-48.

Moreover, examination of each lithographic printing plate support at a 30° inclination revealed that large asperities (undulations) had been formed at a pitch of 5 to 20 μm.

By contrast, similar examination of the surface shape of the lithographic printing plate support obtained in Comparative Example 2 showed that, although asperities had been formed on the surface, they were non-uniform compared with the asperities formed in the examples according to the invention.

2.3. Evaluation of Appearance

The surfaces of the lithographic printing plate supports obtained in Examples 3-1 to 3-48 were visually examined for streaks. The results are shown in Table 4. The meanings of the rating symbols used in Table 4 are as follows.

A: Substantially no observable streaks

A-B: Slight streaking is observable

B: Streaks are observable, but within allowable range

As is apparent from Table 4, the lithographic printing plate supports obtained in Examples 3-12 to 3-17, 3-47 and 3-48 using silica sand as the abrasive were all substantially free of streaks and thus had excellent appearances.

2-4. Fabrication of Presensitized Plates

Presensitized plates for lithographic printing were fabricated by providing a thermal positive-type image recording layer in the manner described below on each of the lithographic printing plate supports obtained above.

Using the same method as that employed on the lithographic printing plate supports obtained in Examples 1-42 to 1-44 and 2-44 to 2-47 according to the first aspect of the invention, an undercoat and Image Recording Layer 2 were formed on the respective lithographic printing plate supports obtained in Examples 3-1 to 3-45 and Comparative Example 2, thereby giving presensitized plates.

Using the same method as that employed on the lithographic printing plate supports obtained in Examples 1-1 to 1-41 and 2-1 to 2-43 according to the first aspect of the invention and Comparative Example 1, an undercoat and Image Recording Layer 1 were formed on the respective lithographic printing plate supports obtained in Examples 3-46 to 3-48, thereby giving presensitized plates.

2-5. Evaluation of Presensitized Plates

The presensitized plates obtained as described above were evaluated as follows for the press life, cleaner resistance (chemical resistance), scumming resistance, scumming resistance in non-image areas between halftone dots, and shininess.

(1) Press Life

The press life was evaluated in the same way as for the first aspect of the invention.

The results are shown in Table 4. The meanings of the rating symbols used in Table 4 are the same as for the first aspect of the invention.

(2) Cleaner Resistance (Chemical Resistance)

The cleaner resistance (chemical resistance) was evaluated in the same way as for the first aspect of the invention.

The results are shown in Table 4. The meanings of the rating symbols used in Table 4 are the same as for the first aspect of the invention.

(3) Scumming Resistance

The scumming resistance was evaluated in the same way as for the first aspect of the invention.

The results are shown in Table 4. The meanings of the rating symbols used in Table 4 are the same as for the first aspect of the invention.

(4) Scumming Resistance in Non-Image Areas between Halftone Dots

The scumming resistance in non-image areas between halftone dots was evaluated in the same way as for the first aspect of the invention.

The results are shown in Table 4. The meanings of the rating symbols used in Table 4 are the same as for the first aspect of the invention.

(5) Shininess

Lithographic printing plates obtained by the same method as that used above to manufacture printing plates for evaluating the press life (1) were mounted on a Lithrone printing press (manufactured by Komori Corporation), and the degree of shine in non-image areas of the plate was visually checked while increasing the amount of dampening water supplied to the plate. The shininess (ease of perceiving the amount of dampening water on the plate surface) was rated based on the amount of dampening water that had been supplied when non-image areas of the plate began to shine.

The results are shown in Table 4. The meanings of the rating symbols used in Table 4 are as follows.
A: Amount of dampening water when non-image areas began to shine was very large
B: Amount of dampening water when non-image areas began to shine was large

As is apparent from Table 4, each of the lithographic printing plates made using the lithographic printing plate supports obtained by the inventive method (Examples 3-1 to 3-48) had a long press life and an excellent scumming resistance, cleaner resistance, scumming resistance in non-image areas between halftone dots, and shininess.

After carrying out Hydrophilizing Treatment 2, Examples 3-1 to 3-45 in which Image Recording Layer 1 was formed had even better scumming resistances in non-image areas between halftone dots.

In Comparative Example 2, the mean surface roughness Rₐ following the second etching treatment was inadequate, resulting in a short press life and an inferior cleaner resistance compared with Examples 3-1 to 3-48.

TABLE 4

| | | | | | First etching | First electrochemical graining treatment | | | | | | | | | | | Second etching |
|---|---|---|---|---|---|---|---|---|---|---|---|---|---|---|---|---|---|
| | | | Average particle | Rₐ after | Am't of | Nitric | | | 68 wt % | Aluminum | | Current | | | | | Am't of |
| | | | size of | mechanical | aluminum | acid | Al³⁺ | | Nitric | nitrate | | rise | | | Amount of | | aluminum |
| | | Type of | abrasive | graining | dissolved | conc. | conc. | | acid | nonahydrate | | time | | Frequency | electricity | Current | dissolved |
| | Al plate | abrasive | (μm) | (μm) | (g/m²) | (g/l) | (g/l) | R | (g/l) | (g/l) | Waveform | (msec) | Duty ratio | (Hz) | (C/dm²) | ratio | (g/m²) |
| Example 3-1 | 2-3 | pumice | 25 | 0.39 | 3.0 | 5.0 | 5.0 | 1.00 | 7 | 69 | trapezoidal | 1.2 | 0.5 | 60 | 160 | 0.95 | 3.0 |
| Example 3-2 | 2-3 | pumice | 25 | 0.39 | 3.0 | 5.0 | 5.0 | 1.00 | 7 | 69 | trapezoidal | 1.2 | 0.5 | 60 | 160 | 0.95 | 5.5 |
| Example 3-3 | 2-3 | pumice | 25 | 0.39 | 3.0 | 5.0 | 5.0 | 1.00 | 7 | 69 | trapezoidal | 1.2 | 0.5 | 60 | 140 | 0.95 | 5.5 |
| Example 3-4 | 2-3 | pumice | 25 | 0.39 | 3.0 | 5.0 | 5.0 | 1.00 | 7 | 69 | trapezoidal | 1.2 | 0.5 | 60 | 180 | 0.95 | 5.5 |
| Example 3-5 | 2-3 | pumice | 25 | 0.39 | 3.0 | 5.0 | 5.0 | 1.00 | 7 | 69 | trapezoidal | 1.2 | 0.5 | 60 | 200 | 0.95 | 5.5 |
| Example 3-6 | 2-3 | pumice | 25 | 0.39 | 5.0 | 5.0 | 5.0 | 1.00 | 7 | 69 | trapezoidal | 1.2 | 0.5 | 60 | 160 | 0.95 | 3.0 |
| Example 3-7 | 2-3 | pumice | 25 | 0.39 | 5.0 | 5.0 | 5.0 | 1.00 | 7 | 69 | trapezoidal | 1.2 | 0.5 | 60 | 160 | 0.95 | 5.5 |
| Example 3-8 | 2-3 | pumice | 25 | 0.39 | 1.0 | 5.0 | 5.0 | 1.00 | 7 | 69 | trapezoidal | 1.2 | 0.5 | 60 | 160 | 0.95 | 3.0 |
| Example 3-9 | 2-3 | pumice | 25 | 0.39 | 3.0 | 5.0 | 7.5 | 1.50 | 7 | 104 | trapezoidal | 1.2 | 0.5 | 60 | 160 | 0.95 | 3.0 |
| Example 3-10 | 2-3 | pumice | 25 | 0.39 | 3.0 | 5.0 | 10.0 | 2.00 | 7 | 139 | trapezoidal | 1.2 | 0.5 | 60 | 160 | 0.95 | 3.0 |
| Example 3-11 | 2-3 | pumice | 25 | 0.39 | 3.0 | 5.0 | 10.0 | 2.00 | 7 | 139 | trapezoidal | 1.2 | 0.5 | 60 | 160 | 0.95 | 4.0 |
| Example 3-12 | 2-3 | silica sand | 20 | 0.38 | 3.0 | 5.0 | 10.0 | 2.00 | 7 | 139 | trapezoidal | 1.2 | 0.5 | 60 | 160 | 0.95 | 4.0 |
| Example 3-13 | 2-3 | silica sand | 20 | 0.38 | 5.0 | 5.0 | 10.0 | 2.00 | 7 | 139 | trapezoidal | 1.2 | 0.5 | 60 | 160 | 0.95 | 4.0 |
| Example 3-14 | 2-3 | silica sand | 20 | 0.38 | 3.0 | 5.0 | 10.0 | 2.00 | 7 | 139 | trapezoidal | 1.2 | 0.5 | 60 | 160 | 0.90 | 4.0 |
| Example 3-15 | 2-3 | silica sand | 20 | 0.38 | 3.0 | 5.0 | 10.0 | 2.00 | 7 | 139 | trapezoidal | 1.2 | 0.5 | 60 | 160 | 0.85 | 4.0 |
| Example 3-16 | 2-3 | silica sand | 8 | 0.30 | 3.0 | 5.0 | 10.0 | 2.00 | 7 | 139 | trapezoidal | 1.2 | 0.5 | 60 | 160 | 0.95 | 4.0 |
| Example 3-17 | 2-3 | silica sand | 8 | 0.30 | 5.0 | 5.0 | 10.0 | 2.00 | 7 | 139 | trapezoidal | 1.2 | 0.5 | 60 | 160 | 0.95 | 4.0 |
| Example 3-18 | 2-1 | pumice | 25 | 0.39 | 3.0 | 5.0 | 10.0 | 2.00 | 7 | 139 | trapezoidal | 1.2 | 0.5 | 60 | 160 | 0.95 | 4.0 |
| Example 3-19 | 2-2 | pumice | 25 | 0.39 | 3.0 | 5.0 | 10.0 | 2.00 | 7 | 139 | trapezoidal | 1.2 | 0.5 | 60 | 160 | 0.95 | 4.0 |
| Example 3-20 | 2-4 | pumice | 25 | 0.39 | 3.0 | 5.0 | 10.0 | 2.00 | 7 | 139 | trapezoidal | 1.2 | 0.5 | 60 | 160 | 0.95 | 4.0 |
| Example 3-21 | 2-5 | pumice | 25 | 0.39 | 3.0 | 5.0 | 10.0 | 2.00 | 7 | 139 | trapezoidal | 1.2 | 0.5 | 60 | 160 | 0.95 | 4.0 |
| Example 3-22 | 2-3 | pumice | 25 | 0.39 | 3.0 | 5.0 | 10.0 | 2.00 | 7 | 139 | trapezoidal | 1.2 | 0.5 | 60 | 160 | 0.95 | 5.5 |
| Example 3-23 | 2-3 | pumice | 25 | 0.39 | 3.0 | 5.0 | 12.5 | 2.50 | 7 | 174 | trapezoidal | 1.2 | 0.5 | 60 | 160 | 0.95 | 3.0 |
| Example 3-24 | 2-3 | pumice | 25 | 0.39 | 3.0 | 7.5 | 5.0 | 0.67 | 11 | 69 | trapezoidal | 1.2 | 0.5 | 60 | 160 | 0.95 | 3.0 |
| Example 3-25 | 2-3 | pumice | 25 | 0.39 | 3.0 | 7.5 | 7.5 | 1.00 | 11 | 104 | trapezoidal | 1.2 | 0.5 | 60 | 160 | 0.95 | 3.0 |
| Example 3-26 | 2-3 | pumice | 25 | 0.39 | 3.0 | 7.5 | 10.0 | 1.33 | 11 | 139 | trapezoidal | 1.2 | 0.5 | 60 | 160 | 0.95 | 3.0 |
| Example 3-27 | 2-3 | pumice | 25 | 0.39 | 3.0 | 10.0 | 7.5 | 0.75 | 15 | 104 | trapezoidal | 1.2 | 0.5 | 60 | 160 | 0.95 | 3.0 |
| Example 3-28 | 2-3 | pumice | 25 | 0.39 | 3.0 | 10.0 | 10.0 | 1.00 | 15 | 139 | trapezoidal | 1.2 | 0.5 | 60 | 160 | 0.95 | 3.0 |
| Example 3-29 | 2-3 | pumice | 25 | 0.39 | 3.0 | 10.0 | 10.0 | 1.00 | 15 | 139 | trapezoidal | 1.2 | 0.5 | 60 | 160 | 0.95 | 4.0 |
| Example 3-30 | 2-3 | pumice | 25 | 0.39 | 3.0 | 10.0 | 10.0 | 1.00 | 15 | 139 | trapezoidal | 1.2 | 0.5 | 60 | 160 | 0.95 | 4.0 |
| Example 3-31 | 2-3 | pumice | 25 | 0.39 | 3.0 | 10.0 | 10.0 | 1.00 | 15 | 139 | trapezoidal | 1.2 | 0.5 | 60 | 160 | 0.95 | 4.0 |
| Example 3-32 | 2-3 | pumice | 25 | 0.39 | 3.0 | 10.0 | 10.0 | 1.00 | 15 | 139 | trapezoidal | 1.2 | 0.5 | 60 | 140 | 0.95 | 4.0 |
| Example 3-33 | 2-3 | pumice | 25 | 0.39 | 3.0 | 10.0 | 10.0 | 1.00 | 15 | 139 | trapezoidal | 1.2 | 0.5 | 60 | 180 | 0.95 | 4.0 |
| Example 3-34 | 2-3 | pumice | 25 | 0.39 | 3.0 | 10.0 | 10.0 | 1.00 | 15 | 139 | trapezoidal | 1.2 | 0.5 | 60 | 200 | 0.95 | 4.0 |
| Example 3-35 | 2-3 | pumice | 25 | 0.39 | 3.0 | 10.0 | 10.0 | 1.00 | 15 | 139 | trapezoidal | 0.8 | 0.5 | 60 | 160 | 0.95 | 4.0 |
| Example 3-36 | 2-3 | pumice | 25 | 0.39 | 3.0 | 10.0 | 10.0 | 1.00 | 15 | 139 | trapezoidal | 2.0 | 0.5 | 60 | 160 | 0.95 | 4.0 |
| Example 3-37 | 2-3 | pumice | 25 | 0.39 | 5.0 | 10.0 | 10.0 | 1.00 | 15 | 139 | trapezoidal | 1.2 | 0.5 | 60 | 160 | 0.95 | 3.0 |
| Example 3-38 | 2-3 | pumice | 25 | 0.39 | 5.0 | 10.0 | 10.0 | 1.00 | 15 | 139 | trapezoidal | 1.2 | 0.5 | 60 | 160 | 0.95 | 4.0 |
| Example 3-39 | 2-3 | pumice | 25 | 0.39 | 1.0 | 10.0 | 10.0 | 1.00 | 15 | 139 | trapezoidal | 1.2 | 0.5 | 60 | 160 | 0.95 | 3.0 |
| Example 3-40 | 2-3 | pumice | 25 | 0.39 | 3.0 | 10.0 | 12.5 | 1.25 | 15 | 174 | trapezoidal | 1.2 | 0.5 | 60 | 160 | 0.95 | 3.0 |
| Example 3-41 | 2-3 | pumice | 25 | 0.39 | 3.0 | 12.5 | 7.5 | 0.60 | 19 | 104 | trapezoidal | 1.2 | 0.5 | 60 | 160 | 0.95 | 3.0 |
| Example 3-42 | 2-3 | pumice | 25 | 0.39 | 3.0 | 12.5 | 10.0 | 0.80 | 19 | 139 | trapezoidal | 1.2 | 0.5 | 60 | 160 | 0.95 | 3.0 |
| Example 3-43 | 2-3 | pumice | 25 | 0.39 | 5.0 | 12.5 | 10.0 | 0.80 | 19 | 139 | trapezoidal | 1.2 | 0.5 | 60 | 160 | 0.95 | 3.0 |
| Example 3-44 | 2-3 | pumice | 25 | 0.39 | 3.0 | 12.5 | 12.5 | 1.00 | 19 | 174 | trapezoidal | 1.2 | 0.5 | 60 | 160 | 0.95 | 3.0 |
| Example 3-45 | 2-3 | pumice | 25 | 0.39 | 3.0 | 15.0 | 10.0 | 0.67 | 22 | 139 | trapezoidal | 1.2 | 0.5 | 60 | 160 | 0.95 | 3.0 |
| Example 3-46 | 2-3 | pumice | 25 | 0.39 | 3.0 | 5.0 | 10.0 | 2.00 | 7 | 139 | trapezoidal | 1.2 | 0.5 | 60 | 160 | 0.95 | 4.0 |
| Example 3-47 | 2-3 | silica sand | 20 | 0.38 | 3.0 | 5.0 | 10.0 | 2.00 | 7 | 139 | trapezoidal | 1.2 | 0.5 | 60 | 160 | 0.95 | 4.0 |
| Example 3-48 | 2-3 | silica sand | 8 | 0.30 | 3.0 | 5.0 | 10.0 | 2.00 | 7 | 139 | trapezoidal | 1.2 | 0.5 | 60 | 160 | 0.95 | 4.0 |
| Comp. Ex. 2 | 2-3 | pumice | 25 | 0.39 | 10.0 | 10.0 | 5.0 | 0.50 | 11 | 69 | trapezoidal | 1.2 | 0.5 | 60 | 160 | 0.95 | 3.0 |

| | | | | | | | | | | | | | | | | Printing performance | | | | |
|---|---|---|---|---|---|---|---|---|---|---|---|---|---|---|---|---|---|---|---|---|
| | | | | | | | | | | | | | | | | | | | Scumming | |
| | Mean | | | | | | | | | | | | | | | | | | resistance | |
| | surface | Second electrochemical graining treatment | | | | | | | | | | Third | | | | | | | in | |
| | roughness | | | | Aluminum | | | | | | | etching | | | | | | | non-image | |
| | after | | Al | 35 | chloride | | Current | | | Am't of | | Am't of | | | Photo- | | | | areas | |
| | second | HCl | ion | wt % | hexa- | | rise | | Fre- | elec- | | aluminum | | Hydro- | sen- | | Cleaner | | between | |
| | etching | conc. | conc. | HCl | hydrate | | time | Duty | quency | tricity | Current | dissolved | Appear- | philizing | sitive | Press | resist- | Scumming | halftone | Shini- |
| | (μm) | (g/l) | (g/l) | (g/l) | (g/l) | Waveform | (msec) | ratio | (Hz) | (C/dm²) | ratio | (g/m²) | ance | treatment | layer | life | ance | resistance | dots | ness |
| Example 3-1 | 0.50 | 7.5 | 4.5 | 21 | 40 | trapezoidal | 0.8 | 0.5 | 60 | 65 | 0.95 | 0.15 | A-B | 2 | 2 | A | A | A | A | A |
| Example 3-2 | 0.50 | 7.5 | 4.5 | 21 | 40 | trapezoidal | 0.8 | 0.5 | 60 | 65 | 0.95 | 0.15 | A-B | 2 | 2 | A | A | A | A | A |
| Example 3-3 | 0.50 | 7.5 | 4.5 | 21 | 40 | trapezoidal | 0.8 | 0.5 | 60 | 65 | 0.95 | 0.15 | A-B | 2 | 2 | A | A | A | A | A |
| Example 3-4 | 0.50 | 7.5 | 4.5 | 21 | 40 | trapezoidal | 0.8 | 0.5 | 60 | 65 | 0.95 | 0.15 | A-B | 2 | 2 | A | A | A | A | A |
| Example 3-5 | 0.50 | 7.5 | 4.5 | 21 | 40 | trapezoidal | 0.8 | 0.5 | 60 | 65 | 0.95 | 0.15 | A-B | 2 | 2 | A | A | A | A | A |
| Example 3-6 | 0.55 | 7.5 | 4.5 | 21 | 40 | trapezoidal | 0.8 | 0.5 | 60 | 65 | 0.95 | 0.15 | A-B | 2 | 2 | A-B | A-B | A | A | A |
| Example 3-7 | 0.55 | 7.5 | 4.5 | 21 | 40 | trapezoidal | 0.8 | 0.5 | 60 | 65 | 0.95 | 0.15 | A-B | 2 | 2 | A-B | A-B | A | A | A |
| Example 3-8 | 0.50 | 7.5 | 4.5 | 21 | 40 | trapezoidal | 0.8 | 0.5 | 60 | 65 | 0.95 | 0.15 | A-B | 2 | 2 | A | A | A | A | A |
| Example 3-9 | 0.50 | 7.5 | 4.5 | 21 | 40 | trapezoidal | 0.8 | 0.5 | 60 | 65 | 0.95 | 0.15 | A-B | 2 | 2 | A | A | A | A | A |
| Example 3-10 | 0.50 | 7.5 | 4.5 | 21 | 40 | trapezoidal | 0.8 | 0.5 | 60 | 65 | 0.95 | 0.15 | A-B | 2 | 2 | A | A | A | A | A |
| Example 3-11 | 0.50 | 7.5 | 4.5 | 21 | 40 | trapezoidal | 0.8 | 0.5 | 60 | 65 | 0.95 | 0.15 | A-B | 2 | 2 | A | A | A | A | A |
| Example 3-12 | 0.50 | 7.5 | 4.5 | 21 | 40 | trapezoidal | 0.8 | 0.5 | 60 | 65 | 0.95 | 0.15 | A | 2 | 2 | A | A | A | A | A |
| Example 3-13 | 0.53 | 7.5 | 4.5 | 21 | 40 | trapezoidal | 0.8 | 0.5 | 60 | 65 | 0.95 | 0.15 | A | 2 | 2 | A-B | A-B | A | A | A |
| Example 3-14 | 0.55 | 7.5 | 4.5 | 21 | 40 | trapezoidal | 0.8 | 0.5 | 60 | 65 | 0.95 | 0.15 | A | 2 | 2 | A | A | A | A | A |
| Example 3-15 | 0.55 | 7.5 | 4.5 | 21 | 40 | trapezoidal | 0.8 | 0.5 | 60 | 65 | 0.95 | 0.15 | A | 2 | 2 | A | A | A-B | A | A |
| Example 3-16 | 0.50 | 7.5 | 4.5 | 21 | 40 | trapezoidal | 0.8 | 0.5 | 60 | 65 | 0.95 | 0.15 | A | 2 | 2 | A | A | A | A | A |
| Example 3-17 | 0.53 | 7.5 | 4.5 | 21 | 40 | trapezoidal | 0.8 | 0.5 | 60 | 65 | 0.95 | 0.15 | A | 2 | 2 | A-B | A-B | A | A | A |
| Example 3-18 | 0.50 | 7.5 | 4.5 | 21 | 40 | trapezoidal | 0.8 | 0.5 | 60 | 65 | 0.95 | 0.15 | A-B | 2 | 2 | A | A | A | A | A |
| Example 3-19 | 0.45 | 7.5 | 4.5 | 21 | 40 | trapezoidal | 0.8 | 0.5 | 60 | 65 | 0.95 | 0.15 | A-B | 2 | 2 | A | A | A | A | A |
| Example 3-20 | 0.45 | 7.5 | 4.5 | 21 | 40 | trapezoidal | 0.8 | 0.5 | 60 | 65 | 0.95 | 0.15 | A-B | 2 | 2 | A | A | A | A | A |
| Example 3-21 | 0.55 | 7.5 | 4.5 | 21 | 40 | trapezoidal | 0.8 | 0.5 | 60 | 65 | 0.95 | 0.15 | A-B | 2 | 2 | A | A | A | A | A |
| Example 3-22 | 0.55 | 7.5 | 4.5 | 21 | 40 | trapezoidal | 0.8 | 0.5 | 60 | 65 | 0.95 | 0.15 | A-B | 2 | 2 | A | A | A | A | A |
| Example 3-23 | 0.50 | 7.5 | 4.5 | 21 | 40 | trapezoidal | 0.8 | 0.5 | 60 | 65 | 0.95 | 0.15 | A-B | 2 | 2 | A | A | A | A | A |
| Example 3-24 | 0.50 | 7.5 | 4.5 | 21 | 40 | trapezoidal | 0.8 | 0.5 | 60 | 65 | 0.95 | 0.15 | A-B | 2 | 2 | A | A | A | A | A |
| Example 3-25 | 0.50 | 7.5 | 4.5 | 21 | 40 | trapezoidal | 0.8 | 0.5 | 60 | 65 | 0.95 | 0.15 | A-B | 2 | 2 | A | A | A | A | A |
| Example 3-26 | 0.50 | 7.5 | 4.5 | 21 | 40 | trapezoidal | 0.8 | 0.5 | 60 | 65 | 0.95 | 0.15 | 2 | A-B | 2 | A | A | A | A | A |
| Example 3-27 | 0.50 | 7.5 | 4.5 | 21 | 40 | trapezoidal | 0.8 | 0.5 | 60 | 65 | 0.95 | 0.15 | 2 | A-B | 2 | A | A | A | A | A |
| Example 3-28 | 0.50 | 7.5 | 4.5 | 21 | 40 | trapezoidal | 0.8 | 0.5 | 60 | 65 | 0.95 | 0.15 | 2 | A-B | 2 | A | A | A | A | A |
| Example 3-29 | 0.50 | 7.5 | 4.5 | 21 | 40 | trapezoidal | 0.8 | 0.5 | 60 | 65 | 0.95 | 0.15 | 2 | A-B | 2 | A | A | A | A | A |
| Example 3-30 | 0.50 | 7.5 | 4.5 | 21 | 40 | trapezoidal | 0.8 | 0.5 | 60 | 65 | 0.95 | 0.05 | 2 | A-B | 2 | A | A | A | A | A |
| Example 3-31 | 0.50 | 7.5 | 4.5 | 21 | 40 | trapezoidal | 0.8 | 0.5 | 60 | 65 | 0.95 | 0.20 | 2 | A-B | 2 | A | A | A | A | A |
| Example 3-32 | 0.50 | 7.5 | 4.5 | 21 | 40 | trapezoidal | 0.8 | 0.5 | 60 | 65 | 0.95 | 0.15 | 2 | A-B | 2 | A | A | A | A | A |
| Example 3-33 | 0.50 | 7.5 | 4.5 | 21 | 40 | trapezoidal | 0.8 | 0.5 | 60 | 65 | 0.95 | 0.15 | 2 | A-B | 2 | A | A | A | A | A |
| Example 3-34 | 0.50 | 7.5 | 4.5 | 21 | 40 | trapezoidal | 0.8 | 0.5 | 60 | 65 | 0.95 | 0.15 | 2 | A-B | 2 | A | A | A | A | A |
| Example 3-35 | 0.50 | 7.5 | 4.5 | 21 | 40 | trapezoidal | 0.8 | 0.5 | 60 | 65 | 0.95 | 0.15 | 2 | A-B | 2 | A | A | A | A | A |
| Example 3-36 | 0.50 | 7.5 | 4.5 | 21 | 40 | trapezoidal | 0.8 | 0.5 | 60 | 65 | 0.95 | 0.15 | 2 | A-B | 2 | A | A | A | A | A |
| Example 3-37 | 0.55 | 7.5 | 4.5 | 21 | 40 | trapezoidal | 0.8 | 0.5 | 60 | 65 | 0.95 | 0.15 | 2 | A-B | 2 | A-B | A-B | A | A | A |
| Example 3-38 | 0.55 | 7.5 | 4.5 | 21 | 40 | trapezoidal | 0.8 | 0.5 | 60 | 65 | 0.95 | 0.15 | 2 | A-B | 2 | A-B | A-B | A | A | A |
| Example 3-39 | 0.50 | 7.5 | 4.5 | 21 | 40 | trapezoidal | 0.8 | 0.5 | 60 | 65 | 0.95 | 0.15 | 2 | A-B | 2 | A | A | A | A | A |
| Example 3-40 | 0.50 | 7.5 | 4.5 | 21 | 40 | trapezoidal | 0.8 | 0.5 | 60 | 65 | 0.95 | 0.15 | 2 | A-B | 2 | A | A | A | A | A |
| Example 3-41 | 0.50 | 7.5 | 4.5 | 21 | 40 | trapezoidal | 0.8 | 0.5 | 60 | 65 | 0.95 | 0.15 | 2 | A-B | 2 | A | A | A | A | A |
| Example 3-42 | 0.50 | 7.5 | 4.5 | 21 | 40 | trapezoidal | 0.8 | 0.5 | 60 | 65 | 0.95 | 0.15 | 2 | A-B | 2 | A | A | A | A | A |
| Example 3-43 | 0.55 | 7.5 | 4.5 | 21 | 40 | trapezoidal | 0.8 | 0.5 | 60 | 65 | 0.95 | 0.15 | 2 | A-B | 2 | A-B | A-B | A | A | A |
| Example 3-44 | 0.50 | 7.5 | 4.5 | 21 | 40 | trapezoidal | 0.8 | 0.5 | 60 | 65 | 0.95 | 0.15 | 2 | A-B | 2 | A | A | A | A | A |
| Example 3-45 | 0.50 | 7.5 | 4.5 | 21 | 40 | trapezoidal | 0.8 | 0.5 | 60 | 65 | 0.95 | 0.15 | 2 | A-B | 2 | A | A | A | A | A |
| Example 3-46 | 0.50 | 7.5 | 4.5 | 21 | 40 | trapezoidal | 0.8 | 0.5 | 60 | 65 | 0.95 | 0.15 | 1 | A-B | 1 | A | A | A | A-B | A |
| Example 3-47 | 0.50 | 7.5 | 4.5 | 21 | 40 | trapezoidal | 0.8 | 0.5 | 60 | 65 | 0.95 | 0.15 | 1 | A | 1 | A | A | A | A-B | A |
| Example 3-48 | 0.50 | 7.5 | 4.5 | 21 | 40 | trapezoidal | 0.8 | 0.5 | 60 | 65 | 0.95 | 0.15 | 1 | A | 1 | A | A | A | A-B | A |
| Comp. Ex. 2 | 0.40 | 7.5 | 4.5 | 21 | 40 | trapezoidal | 0.8 | 0.5 | 60 | 65 | 0.95 | 0.15 | 2 | B | 2 | B | B | A | A | B |

What is claimed is:

1. A method of manufacturing a lithographic printing plate support wherein an aluminum plate is subjected at least to, in order, a mechanical graining treatment in which the aluminum plate is grained to a mean surface roughness Rₐ of 0.25 to 0.40 μm using a brush and a slurry containing an abrasive, an electrochemical graining treatment in which the aluminum plate is grained using an alternating current in an aqueous solution containing nitric acid, and an alkali etching treatment in which the aluminum plate is etched in an aqueous alkali solution, thereby obtaining the lithographic printing plate support having a mean surface roughness Rₐ after the alkali etching treatment of 0.41 to 0.6 μm.

2. The method of manufacturing a lithographic printing plate support according to claim 1, wherein the aluminum plate is subjected between the mechanical graining treatment and the electrochemical graining treatment to an alkali etching treatment in which the aluminum plate is etched in an aqueous alkali solution, and after the alkali etching treatment following the electrochemical graining treatment, the aluminum plate is subjected to, in order, an electrochemical graining treatment in which the aluminum plate is grained using an alternating current in an aqueous solution containing hydrochloric acid, and an anodizing treatment, thereby obtaining the lithographic printing plate support.

3. The method of manufacturing a lithographic printing plate support according to claim 1, wherein the alternating current used in the aqueous solution containing nitric acid has a ratio r of an amount of electricity QR when the aluminum plate acts as a cathode to an amount of electricity QF when the aluminum plate acts as an anode which satisfies a relationship 0.4≦r≦0.8.

4. The method of manufacturing a lithographic printing plate support according to claim 1, wherein the alternating current used in the aqueous solution containing nitric acid has a trapezoidal waveform.

5. The method of manufacturing a lithographic printing plate support according to claim 1, wherein the aqueous solution containing nitric acid has a nitric acid concentration of 15 to 50 g/L.

6. A method of manufacturing a lithographic printing plate support
wherein an aluminum plate is subjected at least to, in order, a mechanical graining treatment in which the aluminum plate is grained to a mean surface roughness Rₐ of 0.25 to 0.42 μm using a brush and a slurry containing an abrasive, an electrochemical graining treatment in which the aluminum plate is grained using an alternating current in an aqueous solution containing nitric acid and aluminum ions, and an alkali etching treatment in which the aluminum plate is etched in an aqueous alkali solution, thereby obtaining the lithographic printing plate support having a mean surface roughness Rₐ after the alkali etching treatment of 0.43 to 0.60 μm, and
wherein the aqueous solution has a ratio R of an aluminum ion concentration A to a nitric acid concentration N of at least 0.6, the alternating current has a ratio r of an amount of electricity QR when the aluminum plate acts as a cathode to an amount of electricity QF when the aluminum plate acts as an anode which satisfies a relationship 0.8≦r≦1.0.

7. The method of manufacturing a lithographic printing plate support according to claim 6, wherein the aqueous solution containing nitric acid and aluminum ions contains 1 to 15 g/L of nitric acid and 1 to 15 g/L of aluminum ions.

8. The method of manufacturing a lithographic printing plate support according to claim 6, wherein the aluminum plate is subjected between the mechanical graining treatment and the electrochemical graining treatment to an alkali etching treatment in which the aluminum plate is etched in an aqueous alkali solution, and after the alkali etching treatment following the electrochemical graining treatment, the aluminum plate is subjected to, in order, an electrochemical graining treatment in which the aluminum plate is grained using an alternating current in an aqueous solution containing hydrochloric acid, and an anodizing treatment, thereby obtaining the lithographic printing plate support.
